(19) United States
(12) Patent Application Publication
(10) Pub. No.: US 2005/0225481 A1
(43) Pub. Date: Oct. 13, 2005

(54) Method and apparatus for automotive radar sensor

(76) Inventor: Andrew J. Bonthron, Los Angeles, CA (US)

Correspondence Address: IRELL & MANELLA LLP, 840 NEWPORT CENTER DRIVE, SUITE 400, NEWPORT BEACH, CA, 92660, US

(21) Appl. No.: 11/102,499

(22) Filed: Apr. 8, 2005

Related U.S. Application Data
(60) Provisional application No. 60/561,765, filed on Apr. 12, 2004.

(51) Int. Cl. G01S 7/28

(52) U.S. Cl. 342/175; 342/70

(57) ABSTRACT

Methods and apparatus are presented which reduce the overall cost and increase the imaging capability for medium and long range automotive radar sensing applications through the combination of a high signal-to-noise ratio and wide dynamic range radar waveform and architecture, antenna arrangement, and a low cost packaging and interconnection method. In accordance with aspects of the present invention, one way a high signal-to-noise ratio and wide dynamic range imaging radar with reduced cost can be achieved is through the combination of a pulsed stepped-frequency-continuous-wave waveform and electrically beam-switched radar architecture, utilizing a planar package containing high-frequency integrated circuits as well as integrated high-frequency waveguide coupling ports, coupled to a multi-beam waveguide-fed twist-reflector narrow beam-width antenna. Other methods and apparatus are presented.

### BACKGROUND OF THE INVENTION

1. Technical Field of the Invention

The subject matter disclosed generally relates to the field of automotive electronic systems and methods. More specifically, the subject matter disclosed relates to radar sensor arrangements that allow cost reduction and increased utility for automotive radar collision avoidance and driver aid applications.

2. Background of Related Art

To facilitate mass deployment of automotive radar sensors, reducing the total system cost per vehicle without compromising the capability, performance, or reliability of the system is desirable. Furthermore, increasing the capability, utility, and applications of the sensor, especially in the area of safety, can enhance the value and promote deployment. Automotive medium to long range sensing applications typically aim to provide information relating to objects in a certain angular area in-front of, or behind of, the equipped vehicle with high resolution object range, velocity, and angular position capability, and the ability to discriminate between multiple objects as required in medium to far distance driving scenarios. FIG. 1 illustrates the typical medium to long range radar sensor mounting positions 76a, 76b on a vehicle 66, and the corresponding typical radar sensor angular detection regions 72a, 72b.

Typical automotive medium to long range radar sensors use angular processing methods such as amplitude monopulse or multi-lateration within a few relatively large transmit/receive beam-widths to determine the point of a maximum return from a target. However, these systems are very limited in their ability to resolve multiple target returns within this beam-width area and thus provide information as target point positions rather than images of distributed target boundaries, severely limiting target identification and classification capability. Also, due to the low gain of the relatively wide transmit/receive beam-width, and relatively low average transmitted power and/or low dynamic range of the typical radar waveform and architecture used, the level of target detection and discrimination for radar imaging applications is poor in typical sensors. Furthermore, the manufacturing cost associated with typical radar sensors is high due to the use of expensive metal hybrid modules and hybrid assembly techniques, mechanically scanned antennas, millimeter-wave packages with high-frequency connections to exotic printed circuit boards, and / or the use of multiple, expensive millimeter-wave components. A radar sensor method and apparatus that could utilize more standard manufacturing assembly processes and materials resulting in a reduced sensor cost would facilitate mass-deployment of this technology. Furthermore, by increasing the sensor's range and angular resolution, signal-to-noise ratio (SNR), and by providing imaging capability rather than point-threat target determination, a more practical and useful radar sensor can be provided with enhanced safety application.

### BRIEF SUMMARY OF THE INVENTION

Methods and apparatus are presented which reduce the overall cost and increase the imaging capability for medium and long range automotive radar sensing applications through the combination of a high signal-to-noise ratio and wide dynamic range radar waveform and architecture, antenna arrangement, and a low-cost packaging and interconnection method. In accordance with aspects of the present invention, one way a high signal-to-noise ratio and wide dynamic range imaging radar with reduced cost can be achieved is through the combination of a pulsed stepped-frequency-continuous-wave waveform and electrically beam-switched radar architecture, utilizing a planar package containing high-frequency integrated circuits as well as integrated high-frequency waveguide coupling ports, coupled to a multi-beam waveguide-fed twist-reflector narrow beam-width antenna. Other methods and apparatus are presented.

Other aspects and advantages of the present invention can be seen upon review of the figures, the detailed description, and the claims which follow.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1 is a diagram illustrating a typical sensor arrangement for automotive sensor applications using radar sensors according to aspects of the present invention.

FIG. 2A is a block diagram illustrating features that enable radar imaging capability with reduced sensor cost according to one embodiment of the present invention.

FIG. 2B is a block diagram illustrating features that enable radar imaging capability with reduced sensor cost according to another embodiment of the present invention.

FIG. 2C is a block diagram illustrating features that enable radar imaging capability with reduced sensor cost according to a further embodiment of the present invention.

FIG. 2D is a block diagram illustrating features that enable radar imaging capability with reduced sensor cost according to a yet further embodiment of the present invention.

FIG. 2E is a block diagram illustrating features that enable radar imaging capability with reduced sensor cost according to another embodiment of the present invention.

FIG. 2F is a block diagram illustrating features that enable radar imaging capability with reduced sensor cost according to a further embodiment of the present invention.

FIG. 2G is a block diagram illustrating features that enable radar imaging capability with reduced sensor cost according to a yet further embodiment of the present invention.

FIG. 2H is a block diagram illustrating features that enable radar imaging capability with reduced sensor cost according to another embodiment of the present invention.

FIG. 3A is a block diagram illustrating features of one embodiment of the Beam Scanning/Switching Radar Means 195 according to aspects of the present invention.

FIG. 3B is a block diagram illustrating features of one embodiment of the Beam Switching Radar Means 196 according to aspects of the present invention.

FIG. 3C is a block diagram illustrating features of one embodiment of the Beam Switching Pulsed Radar with Pulse Compression Means 192 according to aspects of the present invention.

FIG. 4A is an electrical block diagram illustrating features of one embodiment of the Beam Scanning/Switching Means 150 according to aspects of the present invention.

FIG. 4B is an electrical block diagram illustrating features of another embodiment of the Beam Scanning/Switching Means 150 according to aspects of the present invention.

FIG. 5A is an electrical block diagram illustrating features of another embodiment of the Beam Scanning/Switching Means 150 according to aspects of the present invention.

FIG. 5B is an electrical block diagram illustrating features of a further embodiment of the Beam Scanning/Switching Means 150 according to aspects of the present invention.

FIG. 5C is an electrical block diagram illustrating features of a yet further embodiment of the Beam Scanning/Switching Means 150 according to aspects of the present invention.

FIG. 6 is an electrical block diagram illustrating features of another embodiment of the Beam Scanning/Switching Means 150 according to aspects of the present invention.

FIG. 7A is a block diagram illustrating features of one embodiment of the Signal Processor 380 according to aspects of the present invention.

FIG. 7B is a block diagram illustrating features of another embodiment of the Signal Processor 380 according to aspects of the present invention.

FIG. 7C is a block diagram illustrating features of a further embodiment of the Signal Processor 380 according to aspects of the present invention.

FIG. 7D is a block diagram illustrating features of a yet further embodiment of the Signal Processor 380 according to aspects of the present invention.

FIG. 8 shows a receiver antenna arrangement and antenna gain pattern for the amplitude-comparison monopulse direction-finding technique in accordance with one embodiment of the present invention.

FIG. 9 shows a receiver antenna arrangement for the multilateration direction-finding technique in accordance with one embodiment of the present invention.

FIG. 10 shows a receiver antenna arrangement for the phase-comparison monopulse direction-finding technique in accordance with one embodiment of the present invention.

FIG. 11A is an electrical block diagram illustrating features of one embodiment of the radar transmitter-receiver 200 according to aspects of the present invention.

FIG. 11B is an electrical block diagram illustrating features of another embodiment of the radar transmitter-receiver 200 according to aspects of the present invention.

FIG. 11C is an electrical block diagram illustrating features of a further embodiment of the radar transmitter-receiver 200 according to aspects of the present invention.

FIG. 11D is an electrical block diagram illustrating features of a yet further embodiment of the radar transmitter-receiver 200 according to aspects of the present invention.

FIG. 12A is an electrical block diagram illustrating features of one embodiment of the modulation signal generator 230 according to aspects of the present invention.

FIG. 12B is an electrical block diagram illustrating features of another embodiment of the modulation signal generator 230 according to aspects of the present invention.

FIG. 12C is an electrical block diagram illustrating features of a further embodiment of the modulation signal generator 230 according to aspects of the present invention.

FIG. 12D is an electrical block diagram illustrating features of a yet further embodiment of the modulation signal generator 230 according to aspects of the present invention.

FIG. 12E is an electrical block diagram illustrating features of an alternate embodiment of the modulation signal generator 230 according to aspects of the present invention.

FIG. 12F is an electrical block diagram illustrating features of another embodiment of the modulation signal generator 230 according to aspects of the present invention.

FIG. 12G is an electrical block diagram illustrating features of a further embodiment of the modulation signal generator 230 according to aspects of the present invention.

FIG. 13A illustrates an output waveform from the modulation signal generator 230 in accordance with one embodiment of the present invention.

FIG. 13B illustrates an output waveform from the modulation signal generator 230 in accordance with another embodiment of the present invention.

FIG. 13C illustrates an output waveform from the modulation signal generator 230 in accordance with a further embodiment of the present invention.

FIG. 14A illustrates the PRI (pulse repetition interval) timing of the output waveform from the modulation signal generator 230 in accordance with one embodiment of the present invention.

FIG. 14B illustrates the PRI timing of the output waveform from the modulation signal generator 230 in accordance with another embodiment of the present invention.

FIG. 14C illustrates the PRI timing of the output waveform from the modulation signal generator 230 in accordance with a further embodiment of the present invention.

FIG. 14D illustrates the PRI timing of the output waveform from the modulation signal generator 230 in accordance with a yet further embodiment of the present invention.

FIG. 14E illustrates the PRI timing of the output waveform from the modulation signal generator 230 in accordance with an alternate embodiment of the present invention.

FIG. 14F illustrates the PRI timing of the output waveform from the modulation signal generator 230 in accordance with another embodiment of the present invention.

FIG. 14G illustrates the PRI timing of the output waveform from the modulation signal generator 230 in accordance with a further embodiment of the present invention.

FIG. 15A is an electrical block diagram illustrating features of one embodiment of the radar transmitter-receiver 200 according to aspects of the present invention.

FIG. 15B is an electrical block diagram illustrating features of another embodiment of the radar transmitter-receiver 200 according to aspects of the present invention.

FIG. 16A is an electrical block diagram illustrating features of one embodiment of the radar transmitter-receiver 200 according to aspects of the present invention.

FIG. 16B is an electrical block diagram illustrating features of another embodiment of the radar transmitter-receiver 200 according to aspects of the present invention.

FIG. 16C is an electrical block diagram illustrating features of a further embodiment of the radar transmitter-receiver 200 according to aspects of the present invention.

FIG. 16D is an electrical block diagram illustrating features of yet a further embodiment of the radar transmitter-receiver 200 according to aspects of the present invention.

FIG. 17A is an electrical block diagram illustrating features of one embodiment of the radar transmitter-receiver 200 according to aspects of the present invention.

FIG. 17B is an electrical block diagram illustrating features of another embodiment of the radar transmitter-receiver 200 according to aspects of the present invention.

FIG. 18A is an electrical block diagram illustrating features of one embodiment of the radar transmitter-receiver 200 according to aspects of the present invention.

FIG. 18B is an electrical block diagram illustrating features of another embodiment of the radar transmitter-receiver 200 according to aspects of the present invention.

FIG. 18C is an electrical block diagram illustrating features of a further embodiment of the radar transmitter-receiver 200 according to aspects of the present invention.

FIG. 18D is an electrical block diagram illustrating features of a yet further embodiment of the radar transmitter-receiver 200 according to aspects of the present invention.

FIG. 18E is an electrical block diagram illustrating features of another embodiment of the radar transmitter-receiver 200 according to aspects of the present invention.

FIG. 18F is an electrical block diagram illustrating features of a further embodiment of the radar transmitter-receiver 200 according to aspects of the present invention.

FIG. 19A is an electrical block diagram illustrating features of one embodiment of the radar transmitter-receiver 200 according to aspects of the present invention.

FIG. 19B is an electrical block diagram illustrating features of another embodiment of the radar transmitter-receiver 200 according to aspects of the present invention.

FIG. 19C is an electrical block diagram illustrating features of a further embodiment of the radar transmitter-receiver 200 according to aspects of the present invention.

FIG. 19D is an electrical block diagram illustrating features of a yet further embodiment of the radar transmitter-receiver 200 according to aspects of the present invention.

FIG. 19E is an electrical block diagram illustrating features of another embodiment of the radar transmitter-receiver 200 according to aspects of the present invention.

FIG. 19F is an electrical block diagram illustrating features of a further embodiment of the radar transmitter-receiver 200 according to aspects of the present invention.

FIG. 20A is an electrical block diagram illustrating features of one embodiment of the Frequency Hopping Signal Generator 295 according to aspects of the present invention.

FIG. 20B is an electrical block diagram illustrating features of another embodiment of the Frequency Hopping Signal Generator 295 according to aspects of the present invention.

FIG. 20C is an electrical block diagram illustrating features of a further embodiment of the Frequency Hopping Signal Generator 295 according to aspects of the present invention.

FIG. 21A illustrates an output modulation pattern from the Frequency Hopping Signal Generator 295 in accordance with one embodiment of the present invention.

FIG. 21B illustrates an output modulation pattern from the Frequency Hopping Signal Generator 295 in accordance with another embodiment of the present invention.

FIG. 21C illustrates an output modulation pattern from the Frequency Hopping Signal Generator 295 in accordance with a further embodiment of the present invention.

FIG. 21D illustrates an output modulation pattern from the Frequency Hopping Signal Generator 295 in accordance with a yet further embodiment of the present invention.

FIG. 21E illustrates an output modulation pattern from the Frequency Hopping Signal Generator 295 in accordance with another embodiment of the present invention.

FIG. 22A is an electrical block diagram illustrating features of one embodiment of the radar transmitter-receiver 200 according to aspects of the present invention.

FIG. 22B is an electrical block diagram illustrating features of another embodiment of the radar transmitter-receiver 200 according to aspects of the present invention.

FIG. 22C is an electrical block diagram illustrating features of a further embodiment of the radar transmitter-receiver 200 according to aspects of the present invention.

FIG. 22D is an electrical block diagram illustrating features of a yet further embodiment of the radar transmitter-receiver 200 according to aspects of the present invention.

FIG. 23A is an electrical block diagram illustrating features of one embodiment of the radar transmitter-receiver 200 according to aspects of the present invention.

FIG. 23B is an electrical block diagram illustrating features of another embodiment of the radar transmitter-receiver 200 according to aspects of the present invention.

FIG. 23C is a diagram illustrating one example of transmit and receive signal timing for the transmitter-receiver 200 according to aspects of the present invention.

FIG. 24A is a block diagram illustrating features of one embodiment of the IC package with integrated signal radiating means 501 according to aspects of the present invention.

FIG. 24B is a block diagram illustrating features of another embodiment of the IC package with integrated signal radiating means 501 according to aspects of the present invention.

FIG. 24C is a block diagram illustrating features of one embodiment of the IC package with integrated planar antenna means 502 according to aspects of the present invention.

FIG. 24D is a block diagram illustrating features of another embodiment of the IC package with integrated planar antenna means 502 according to aspects of the present invention.

FIG. 24E is a block diagram illustrating features of one embodiment of the IC package with integrated electromagnetic coupling means 503 according to aspects of the present invention.

FIG. 24F is a block diagram illustrating features of another embodiment of the IC package with integrated electromagnetic coupling means 503 according to aspects of the present invention.

FIG. 25A shows the top view of an integrated circuit die to substrate attachment means in accordance with one embodiment of the present invention.

FIG. 25B shows the cross-sectional view of an integrated circuit die to substrate attachment means in accordance with one embodiment of the present invention.

FIG. 25C shows the bottom view of a flip-chip connection means pattern in accordance with one embodiment of the present invention.

FIG. 25D shows the bottom view of a flip-chip connection means pattern in accordance with another embodiment of the present invention.

FIG. 25E shows the bottom view of a flip-chip connection means pattern in accordance with a further embodiment of the present invention.

FIG. 25F shows the top view of a controlled-impedance flip-chip substrate metallization pattern in accordance with one embodiment of the present invention.

FIG. 25G shows the top view of a controlled-impedance flip-chip substrate metallization pattern in accordance with another embodiment of the present invention.

FIG. 25H shows the cross-sectional view of a controlled-impedance flip-chip substrate metallization pattern in accordance with one embodiment of the present invention.

FIG. 251 shows the top views of metallized substrate layers for a controlled-impedance flip-chip transition in accordance with one embodiment of the present invention.

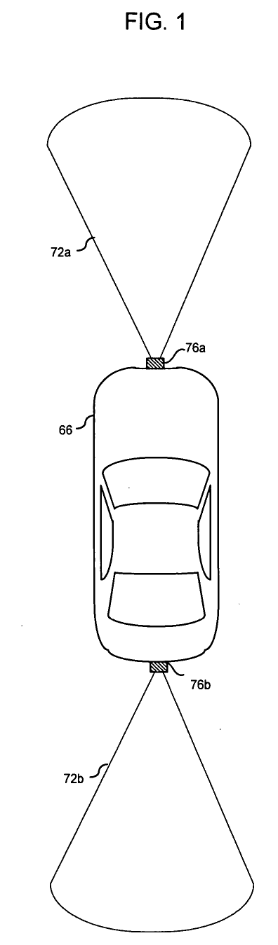

FIG. 26A shows the top view of an integrated circuit die to substrate attachment means in accordance with one embodiment of the present invention.

FIG. 26B shows the cross-sectional view of an integrated circuit die to substrate attachment means in accordance with one embodiment of the present invention.

FIG. 27A shows the top view of a high-frequency substrate means in accordance with one embodiment of the present invention.

FIG. 27B shows the cross-sectional view of a high-frequency substrate means in accordance with one embodiment of the present invention.

FIG. 28A shows the bottom view of an integrated planar antenna radiating element in accordance with one embodiment of the present invention.

FIG. 28B shows the cross-sectional view of an integrated planar antenna radiating element in accordance with one embodiment of the present invention.

FIG. 29A shows the top view of an integrated electromagnetic signal coupling element in accordance with one embodiment of the present invention.

FIG. 29B shows the bottom view of an integrated electromagnetic signal coupling element in accordance with one embodiment of the present invention.

FIG. 29C shows the cross-sectional view of an integrated electromagnetic signal coupling element in accordance with one embodiment of the present invention.

FIG. 29D shows the top view of an integrated electro-magnetic signal coupling element in accordance with another embodiment of the present invention.

FIG. 29E shows the bottom view of an integrated electro-magnetic signal coupling element in accordance with another embodiment of the present invention.

FIG. 29F shows the cross-sectional view of an integrated electromagnetic signal coupling element in accordance with another embodiment of the present invention FIG. 30A shows the bottom view of a variety of integrated planar antenna radiating elements in accordance with one embodiment of the present invention.

FIG. 30B shows the bottom view of a variety of integrated electromagnetic signal coupling elements in accordance with one embodiment of the present invention.

FIG. 30C shows the top view of a variety of integrated planar antenna radiating elements in accordance with one embodiment of the present invention.

FIG. 30D shows the top view of a variety of integrated electromagnetic signal coupling elements in accordance with one embodiment of the present invention.

FIG. 31A shows the top view of a mechanically stress-relieved substrate external interconnection means in accordance with one embodiment of the present invention.

FIG. 31B shows the cross-sectional view of a mechanically stress-relieved substrate external interconnection means in accordance with one embodiment of the present invention.

FIG. 32A shows the top view of a mechanically stress-relieved substrate external interconnection means in accordance with another embodiment of the present invention.

FIG. 32B shows the cross-sectional view of a mechanically stress-relieved substrate external interconnection means in accordance with another embodiment of the present invention.

FIG. 33A shows the top view of a mechanically stress-relieved substrate external interconnection means in accordance with a further embodiment of the present invention.

FIG. 33B shows the cross-sectional view of a mechanically stress-relieved substrate external interconnection means in accordance with a further embodiment of the present invention.

FIG. 34A shows the top view of a mechanically stress-relieved substrate external interconnection means in accordance with a yet further embodiment of the present invention.

FIG. 34B shows the cross-sectional view of a mechanically stress-relieved substrate external interconnection means in accordance with a yet further embodiment of the present invention.

FIG. 35A shows the top view of a mechanically stress-relieved substrate external interconnection means in accordance with another embodiment of the present invention.

FIG. 35B shows the cross-sectional view of a mechanically stress-relieved substrate external interconnection means in accordance with another embodiment of the present invention.

FIG. 36A shows the top view of a mechanically stress-relieved substrate external interconnection means in accordance with a further embodiment of the present invention.

FIG. 36B shows the cross-sectional view of a mechanically stress-relieved substrate external interconnection means in accordance with a further embodiment of the present invention.

FIG. 36C shows the top view of a mechanically stress-relieved substrate external interconnection means in accordance with a yet further embodiment of the present invention.

FIG. 36D shows the cross-sectional view of a mechanically stress-relieved substrate external interconnection means in accordance with a yet further embodiment of the present invention.

FIG. 37A shows the top view of a mechanically stress-relieved package mounting, interconnect, and electromagnetic coupling arrangement in accordance with one embodiment of the present invention.

FIG. 37B shows the cross-sectional view of a mechanically stress-relieved package mounting, interconnect, and electromagnetic coupling arrangement in accordance with one embodiment of the present invention.

FIG. 38A shows the top view of a cover means for a substrate in accordance with one embodiment of the present invention.

FIG. 38B shows the cross-sectional view of a cover means for a substrate in accordance with one embodiment of the present invention.

FIG. 38C shows the top view of a cover means for a substrate in accordance with another embodiment of the present invention.

FIG. 38D shows the cross-sectional view of a cover means for a substrate in accordance with another embodiment of the present invention.

FIG. 38E shows the top view of a cover means for a substrate in accordance with a further embodiment of the present invention.

FIG. 38F shows the cross-sectional view of a cover means for a substrate in accordance with a further embodiment of the present invention.

FIG. 38G shows the top view of a cover means for a substrate in accordance with a yet further embodiment of the present invention.

FIG. 38H shows the cross-sectional view of a cover means for a substrate in accordance with a yet further embodiment of the present invention.

FIG. 38I shows the top view of a cover means for a substrate in accordance with another embodiment of the present invention.

FIG. 38J shows the cross-sectional view of a cover means for a substrate in accordance with another embodiment of the present invention.

FIG. 38K shows the top view of a cover means for a substrate in accordance with a further embodiment of the present invention.

FIG. 38L shows the cross-sectional view of a cover means for a substrate in accordance with a further embodiment of the present invention.

FIG. 39A shows the top view of one example of an integrated circuit packaging and external mounting method in accordance with aspects of the present invention.

FIG. 39B shows the cross-sectional view of one example of an integrated circuit packaging and external mounting method in accordance with aspects of the present invention.

FIG. 40A shows the top view of another example of an integrated circuit packaging and external mounting method in accordance with aspects of the present invention.

FIG. 40B shows the cross-sectional view of another example of an integrated circuit packaging and external mounting method in accordance with aspects of the present invention.

FIG. 40C shows the top view of a further example of an integrated circuit packaging and external mounting method in accordance with aspects of the present invention.

FIG. 40D shows the cross-sectional view of a further example of an integrated circuit packaging and external mounting method in accordance with aspects of the present invention.

FIG. 40E shows the top view of a yet further example of an integrated circuit packaging and external mounting method in accordance with aspects of the present invention.

FIG. 40F shows the cross-sectional view of a yet further example of an integrated circuit packaging and external mounting method in accordance with aspects of the present invention.

FIG. 40G shows the top view of another example of an integrated circuit packaging and external mounting method in accordance with aspects of the present invention.

FIG. 40H shows the cross-sectional view of another example of an integrated circuit packaging and external mounting method in accordance with aspects of the present invention.

FIG. 41A is a block diagram illustrating features of one embodiment of the beam sharpening means 301 according to aspects of the present invention.

FIG. 41B is a block diagram illustrating features of one embodiment of the quasi-optical beam sharpening means 302 according to aspects of the present invention.

FIG. 41C is a block diagram illustrating features of one embodiment of the quasi-optical beam sharpening means with waveguide feeds 303 according to aspects of the present invention.

FIG. 41D is a block diagram illustrating features of one embodiment of the reflector antenna with waveguide feeds 304 according to aspects of the present invention.

FIG. 42A is a diagram illustrating features of one embodiment of the beam sharpening means 301 according to aspects of the present invention.

FIG. 42B is a diagram illustrating features of another embodiment of the beam sharpening means 301 according to aspects of the present invention.

FIG. 42C is a diagram illustrating beam steering features of one embodiment of the beam sharpening means 301 according to aspects of the present invention.

FIG. 43 is a diagram illustrating features of one embodiment of multi-port feed network 407 according to aspects of the present invention.

FIG. 44A shows the top view illustrating features of another embodiment of multi-port feed network 407 according to aspects of the present invention.

FIG. 44B shows the cross-sectional view illustrating features of another embodiment of multi-port feed network 407 according to aspects of the present invention.

FIG. 45A shows the cross-sectional view of one embodiment of transmit/receive beam aperture 412 according to aspects of the present invention.

FIG. 45B shows the cross-sectional view of another embodiment of transmit/receive beam aperture 412 according to aspects of the present invention.

FIG. 45C shows the cross-sectional view of a further embodiment of transmit/receive beam aperture 412 according to aspects of the present invention.

FIG. 45D shows the cross-sectional view of a yet further embodiment of transmit/receive beam aperture 412 according to aspects of the present invention.

FIG. 45E shows the cross-sectional view of another embodiment of transmit/receive beam aperture 412 according to aspects of the present invention.

FIG. 45F shows the cross-sectional view of a further embodiment of transmit/receive beam aperture 412 according to aspects of the present invention.

FIG. 46A shows the cross-sectional view of one embodiment of pre-focusing dielectric lens 415 according to aspects of the present invention.

FIG. 46B shows features of the dielectric lens of FIG. 46A according to aspects of the present invention.

FIG. 47A illustrates the top view of one embodiment of reflector antenna with waveguide feeds 304 according to aspects of the present invention.

FIG. 47B illustrates the cross-sectional view of one embodiment of reflector antenna with waveguide feeds 304 according to aspects of the present invention.

FIG. 47C illustrates the bottom view of one embodiment of reflector antenna with waveguide feeds 304 according to aspects of the present invention.

FIG. 47D shows ray tracing in the cross-sectional view of one embodiment of reflector antenna with waveguide feeds 304 according to aspects of the present invention.

FIG. 48A illustrates the top view of one embodiment of multi-port waveguide feed network 409 according to aspects of the present invention.

FIG. 48B illustrates the cross-sectional view of one embodiment of multi-port waveguide feed network 409 according to aspects of the present invention.

FIG. 48C illustrates the bottom view of one embodiment of multi-port waveguide feed network 409 according to aspects of the present invention.

FIG. 49A illustrates the top view of one embodiment of beam sharpening means 301 according to aspects of the present invention.

FIG. 49B illustrates the top view of another embodiment of beam sharpening means 301 according to aspects of the present invention.

FIG. 50A illustrates the top view of one embodiment of reflector antenna with waveguide feeds 304 according to aspects of the present invention.

FIG. 50B illustrates the cross-sectional view of one embodiment of reflector antenna with waveguide feeds 304 according to aspects of the present invention.

FIG. 51A illustrates the top view of another embodiment of reflector antenna with waveguide feeds 304 according to aspects of the present invention.

FIG. 51B illustrates the cross-sectional view of another embodiment of reflector antenna with waveguide feeds 304 according to aspects of the present invention.

FIG. 52A illustrates the top view of one embodiment of beam sharpening means 301 according to aspects of the present invention.

FIG. 52B illustrates the cross sectional view of one embodiment of beam sharpening means 301 according to aspects of the present invention.

FIG. 52C illustrates the cross sectional view of one embodiment of beam sharpening means 301 according to aspects of the present invention.

FIG. 53A illustrates the top view of another embodiment of beam sharpening means 301 according to aspects of the present invention.

FIG. 53B illustrates the top view of another embodiment of beam sharpening means 301 according to aspects of the present invention.

FIG. 53C illustrates the cross sectional view of another embodiment of beam sharpening means 301 according to aspects of the present invention.

FIG. 53D illustrates the bottom view of another embodiment of beam sharpening means 301 according to aspects of the present invention.

FIG. 54A illustrates the top view of a further embodiment of beam sharpening means 301 according to aspects of the present invention.

FIG. 54B illustrates the top view of a further embodiment of beam sharpening means 301 according to aspects of the present invention.

FIG. 54C illustrates the cross sectional view of a further embodiment of beam sharpening means 301 according to aspects of the present invention.

FIG. 54D illustrates the bottom view of a further embodiment of beam sharpening means 301 according to aspects of the present invention.

FIG. 55A illustrates the bottom view of an arrangement and interconnection method of an IC package, external circuit board, waveguide feed network, and twist reflector antenna as one embodiment of the present invention.

FIG. 55B illustrates the cross-sectional view of an arrangement and interconnection method of an IC package, external circuit board, waveguide feed network, and twist reflector antenna as one embodiment of the present invention.

FIG. 56A illustrates the bottom view of an arrangement and interconnection method of an IC package, external circuit board, waveguide feed network, and twist reflector antenna as another embodiment of the present invention.

FIG. 56B illustrates the cross-sectional view of an arrangement and interconnection method of an IC package, external circuit board, waveguide feed network, and twist reflector antenna as another embodiment of the present invention.

### DETAILED DESCRIPTION

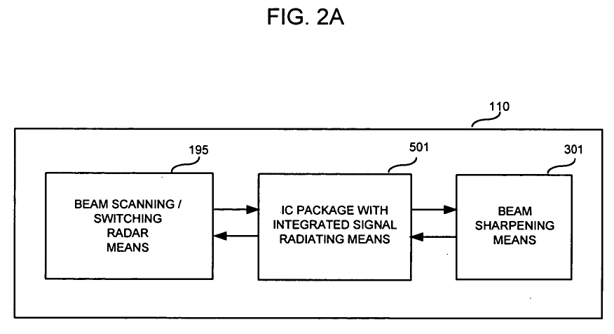

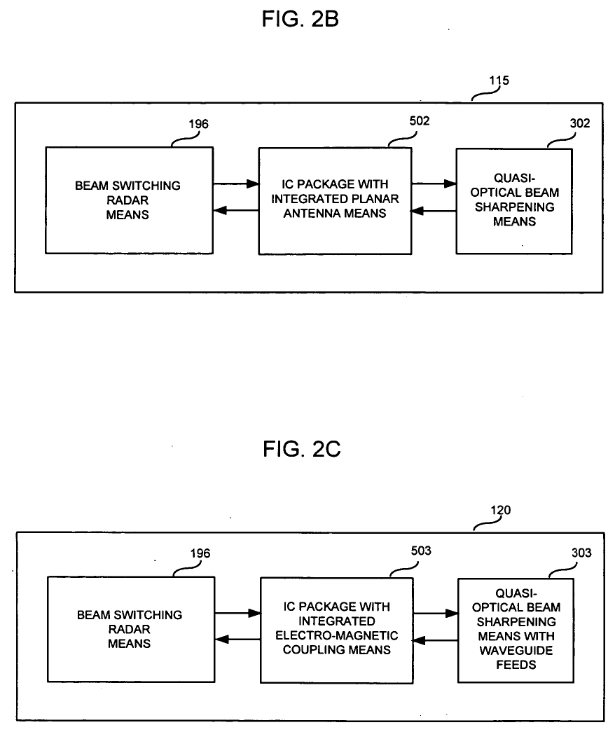

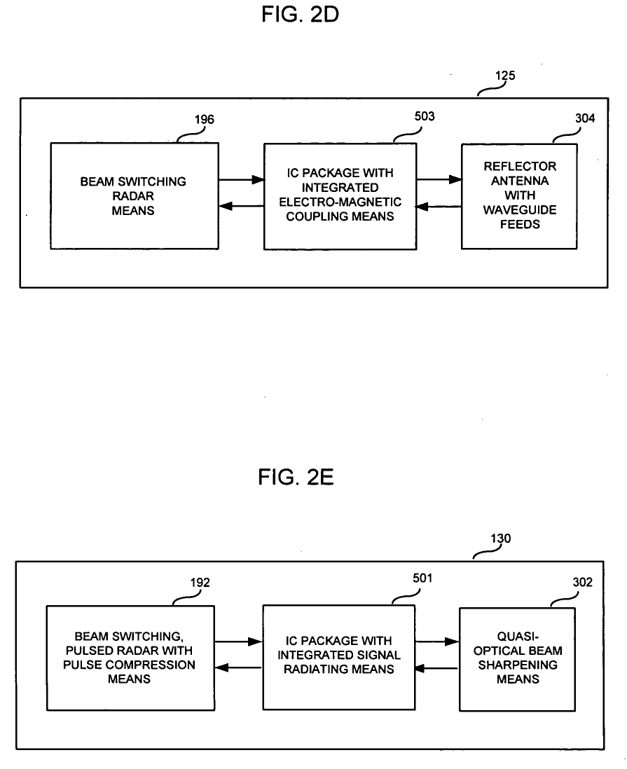

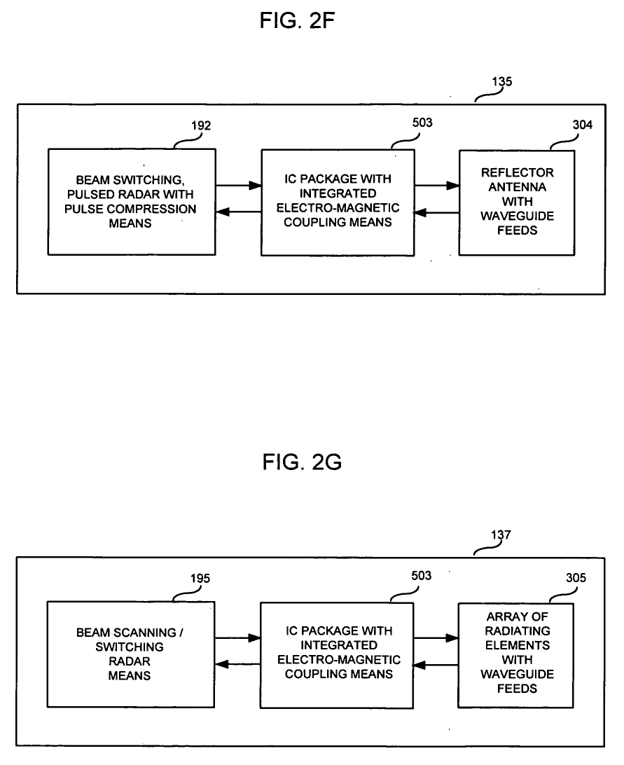

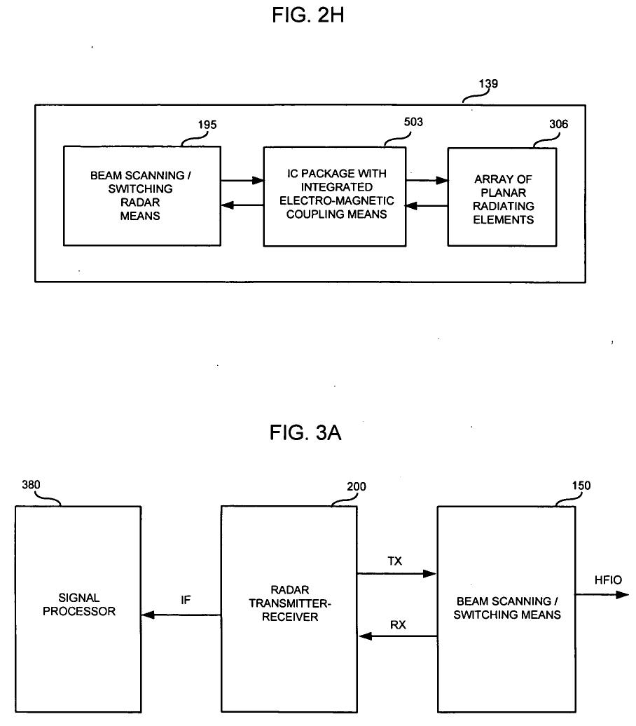

One embodiment of the generalized diagram shown in FIG. 2A illustrates the features of an integrated radar imaging sensor 110 capable of producing high signal-to-noise ratio and wide dynamic range images of distributed targets where high resolution target boundaries, not just single point returns from targets, can be determined in a low-cost, mass-production capable unit, in accordance with aspects of the present invention. A beam scanning, switching radar means 195 is coupled with an integrated circuit (IC) package having integrated signal radiating means 501, which is then coupled to a transmit/receive beam sharpening means 301 for transmission and reception of a narrow electromagnetic signal beam. Signal radiating means are defined as high-frequency structures used to electro-magnetically couple one or a plurality of signals to and/or from the package using a solderless connection. Examples of signal radiating means can be, but are not limited to, patch antennas, slot antennas, planar antennas or arrays, waveguide coupling ports, or coaxial coupling ports. In one arrangement, the signal radiating means can be on the opposite side of the planar package from which the ICs are mounted, thus resulting in an efficient use of package area resulting in lower cost. The beam scanning/switching radar means 195 utilizes an architecture compatible with electrically steering or switching one or a plurality of transmit and/or receive electromagnetic beams across a plurality of angular positions. Examples of beam scanning/switching means, not meant as a limitation, can include the use of multi-position transmit/receive signal beam switches, signal splitters, phase shifters, variable attenuators, or phased antenna arrays. The beam scanning/switching radar means 195 can utilize different radar approaches in order to realize a high SNR and/or wide dynamic range as required by a particular application. Examples of radar approaches, not meant as a limitation, can include pulsed Doppler, pulsed FM-Doppler, pulsed Doppler with pulse compression, pulsed frequency-hopped, pulsed or non-pulsed stepped-frequency-continuous-wave (SFCW), or pulsed or non-pulsed frequency-modulated-continuous-wave (FMCW). The beam sharpening means 301 is electro-magnetically coupled with the IC package signal radiating means and is used to provide a sharpened, narrow beam-width transmit and/or receive antenna pattern compatible with the requirement for the beam to be scanned or switched across a plurality of angular positions. The beam sharpening means 301 can include, but is not limited to, an antenna array or arrays, a planar antenna array or arrays, a lens or plurality of lenses, a reflector antenna, a twist-reflector antenna, a waveguide fed antenna or array, a combination of waveguide feed and a lens antenna, or a combination of any of these.

In one embodiment of the arrangement of FIG.2A, a high SNR, wide dynamic range beam-switched architecture utilizing a pulsed stepped-frequency-continuous-wave (SFCW) radar waveform is used. In this embodiment, all the high-frequency ICs are contained in a single, low cost planar package and attached using a flip-chip method. The package utilizes an array of integrated waveguide coupling ports to transmit and receive high-frequency signals to a multi-beam twist-reflector beam-sharpening antenna with an integrated, multi-port waveguide feed network. The antenna and waveguide feed network can be manufactured using a low cost, metallized injection molding process. All other IC package input/output connections are soldered using a low frequency, stress-relieved wire interconnects enabling highly reliable packaging. In this way, the sensor partitioning in FIG. 2A allows grouping of the radar functions into low cost, high performance, high reliability units for realization of an imaging capable, mass production compatible radar sensor.

One embodiment of the generalized diagram shown in FIG. 2B illustrates the features of a an integrated radar imaging sensor 115 capable of producing high signal-to-noise ratio and wide dynamic range images of distributed targets where high resolution target boundaries, not just single point returns from targets, can be determined in a low-cost, mass-production capable unit, in accordance with aspects of the present invention. This arrangement is similar to the arrangement in FIG. 2A with the exception that radar means 196 specifically uses beam-switching, the IC package means 502 specifically integrates planar antenna means, and beam sharpening means 302 specifically uses quasi-optical means. An example of a quasi-optical beam sharpening means, not meant as a limitation, is a dielectric lens or a plurality of dielectric lenses.

One embodiment of the generalized diagram shown in FIG. 2C illustrates the features of a an integrated radar imaging sensor 120 capable of producing high signal-to-noise ratio and wide dynamic range images of distributed where high resolution target boundaries, not just single point returns from targets, can be determined in a low-cost, mass-production capable unit, in accordance with aspects of the present invention. This arrangement is similar to the arrangement in FIG. 2B with the exception that the IC package means 503 specifically integrates electromagnetic coupling means, and the quasi-optical beam sharpening means 303 includes waveguide feeds. Examples of electromagnetic coupling means can be, but are not limited to, waveguide coupling ports, coaxial coupling ports, patch antennas, slot antennas, planar antennas, or arrays of any of these elements.

One embodiment of the generalized diagram shown in FIG. 2D illustrates the features of a an integrated radar imaging sensor 125 capable of producing high signal-to-noise ratio and wide dynamic range images of distributed targets where high resolution target boundaries, not just single point returns from targets, can be determined in a low-cost, mass-production capable unit, in accordance with aspects of the present invention. This arrangement is similar to the arrangement in FIG. 2C with the exception that the beam sharpening means 304 uses a reflector antenna with waveguide feeds, instead of a quasi-optical antenna arrangement. Examples of a reflector antenna can be, but are not limited to, a parabolic reflector antenna, a plurality of parabolic reflector antennas, a twist-reflector antenna, or a plurality of twist-reflector antennas.

One embodiment of the generalized diagram shown in FIG. 2E illustrates the features of a an integrated radar imaging sensor 130 capable of producing high signal-to-noise ratio and wide dynamic range images of distributed targets where high resolution target boundaries, not just single point returns from targets, can be determined in a low-cost, mass-production capable unit, in accordance with aspects of the present invention. This arrangement is similar to the arrangement in FIG. 2B with the exception that the beam switching radar means has been replaced by a beam switching pulsed radar with pulse compression means 192. Pulsed radar methods using pulse compression techniques can improve the SNR and/or dynamic range of the sensor while simultaneously achieving high range resolution. Examples of pulsed radar methods with pulse compression means, not meant as a limitation, are pulsed-frequency modulated (FM) Doppler, pulsed Doppler using sub-pulse coding such as Barker codes, pulsed SFCW, pulsed FMCW, or pulsed frequency-hopped methods.

One embodiment of the generalized diagram shown in FIG. 2F illustrates the features of a an integrated radar imaging sensor 135 capable of producing high signal-to-noise ratio and wide dynamic range images of distributed targets where high resolution target boundaries, not just single point returns from targets, can be determined in a low-cost, mass-production capable unit, in accordance with aspects of the present invention. This arrangement is similar to the arrangement in FIG. 2D with the exception that the beam switching radar means has been replaced by a beam switching pulsed radar with pulse compression means 192. Pulsed radar methods using pulse compression techniques can improve the SNR and/or dynamic range of the sensor while simultaneously achieving high range resolution. Examples of pulsed radar methods with pulse compression means, not meant as a limitation, are pulsed-frequency modulated (FM) Doppler, pulsed Doppler using sub-pulse coding such as Barker codes, pulsed SFCW, pulsed FMCW, or pulsed frequency-hopped methods.

One embodiment of the generalized diagram shown in FIG. 2G illustrates the features of a an integrated radar imaging sensor 137 capable of producing high signal-to-noise ratio and wide dynamic range images of distributed targets where high resolution target boundaries, not just single point returns from targets, can be determined in a low-cost, mass-production capable unit, in accordance with aspects of the present invention. This arrangement is similar to the arrangement in FIG. 2D with the exception that a beam switching/scanning radar means 195 and an array of radiating elements with waveguide feeds 305 are used instead of beam switching radar means 196 and reflector antenna with waveguide feeds 304. This configuration is particularly well suited for phased-array electrical beam scanning radar applications. Examples of an array of radiating elements with waveguide feeds 305 can be, but are not limited to, a plurality of waveguide radiating elements, a plurality of radiating slots coupled to waveguide feeds, a plurality of planar antenna structures coupled to waveguide feeds, a plurality of parabolic reflector antennas fed by waveguide feeds, a plurality of twist-reflector antennas fed by waveguide feeds, or a combination of these technologies.

One embodiment of the generalized diagram shown in FIG. 2H illustrates the features of a an integrated radar imaging sensor 139 capable of producing high signal-to-noise ratio and wide dynamic range images of distributed targets where high resolution target boundaries, not just single point returns from targets, can be determined in a low-cost, mass-production capable unit, in accordance with aspects of the present invention. This arrangement is similar to the arrangement in FIG. 2G with the exception that an array of planar radiating elements 306 are used instead of an array of radiating elements with waveguide feeds 305. This configuration is particularly well suited for phased-array electrical beam scanning radar applications. Examples of an array of planar radiating elements 306 can be, but are not limited to, a plurality of planar antenna elements, a plurality of planar antenna element arrays, a plurality of planar antenna structures coupled to waveguide feeds, or a combination of these technologies.

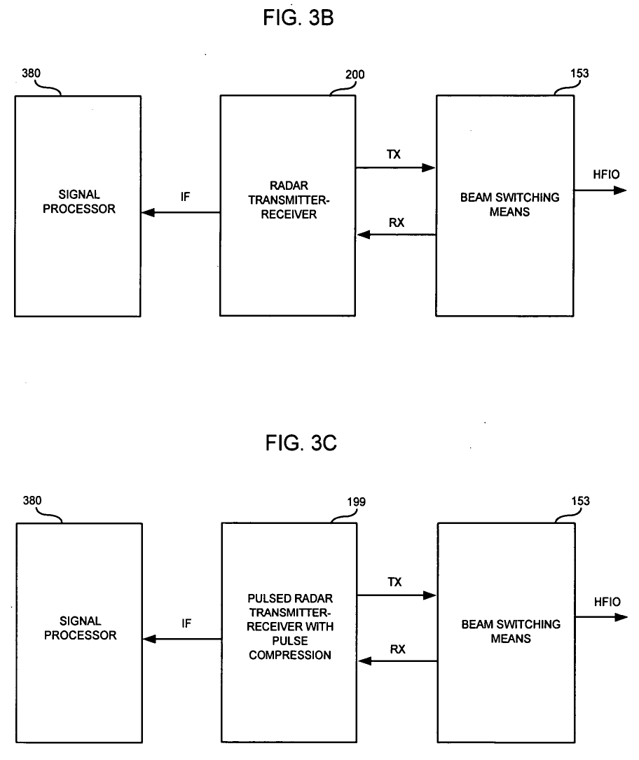

FIG. 3A illustrates one embodiment of the beam scanning/switching radar means 195. A radar transmitter-receiver 200 is connected to a beam scanning/switching means 150 such that one or a plurality of signals for transmission are provided from the radar transmitter-receiver 200 to the beam scanning/switching means 150, and one or a plurality of received signals are provided from the beam scanning/switching means 150 to the radar transmitter-receiver 200. The radar transmitter-receiver 200 is connected to a signal processor 380 such that one or a plurality of intermediate frequency signals are provided from the radar transmitter-receiver 200 to the signal processor 380. The output of the beam scanning/switching means 150 is one or a plurality of high-frequency input/output (HFIO) signals which are provided to a transmit/receive beam sharpening means for electromagnetic transmission towards, or reception from, a radar imaging region.

FIG. 3B illustrates one embodiment of the beam switching radar means 196. A radar transmitter-receiver 200 is connected to a beam switching means 153 such that one or a plurality of signals for transmission are provided from the radar transmitter-receiver 200 to the beam switching means 153, and one or a plurality of received signals are provided from the beam switching means 153 to the radar transmitter-receiver 200. The radar transmitter-receiver 200 is connected to a signal processor 380 such that one or a plurality of intermediate frequency signals are provided from the radar transmitter-receiver 200 to the signal processor 380. The output of the beam switching means 153 is one or a plurality of high-frequency input/output (HFIO) signals which are provided to a transmit/receive beam sharpening means for electromagnetic transmission towards, or reception from, a radar imaging region.

FIG. 3C illustrates one embodiment of the beam switching pulsed radar means with pulse compression 192. A pulsed radar transmitter-receiver with pulse compression 199 is connected to a beam switching means 153 such that one or a plurality of signals for transmission are provided from the radar transmitter-receiver 199 to the beam switching means 153, and one or a plurality of received signals are provided from the beam switching means 153 to the radar transmitter-receiver 199. The radar transmitter-receiver 199 is connected to a signal processor 380 such that one or a plurality of intermediate frequency signals are provided from the radar transmitter-receiver 199 to the signal processor 380. The output of the beam switching means 153 is one or a plurality of high-frequency input/output (HFIO) signals which are provided to a transmit/receive beam sharpening means for electromagnetic transmission towards, or reception from, a radar imaging region.

The configurations shown in FIGS. 3A-C do not preclude the use of an additional processor exterior to the radar sensor unit for the purpose of data processing, processing or fusion of data from multiple sensor units, processing or data fusion with additional dissimilar sensor technologies, or coordination across multiple sensor units. Furthermore, if signal processor 380 utilizes a plurality of individual processors, one or more of the individual processors may be mounted remotely from the sensor unit without departing from the spirit of the present invention. Furthermore, for the case where signal processing may be performed remotely, the analog to digital (A/D) converter portion of the signal processor block 380 may be located within the sensor unit, and a portion or the entirety of the processing located remotely.

Another embodiment of the present invention is the use of a plurality of transmit channels which transmit a plurality of simultaneous transmit signals toward a target. The diagrams shown in FIGS. 3A-C can be modified to accommodate multiple transmit channels in accordance with aspects of the present invention. One benefit of the use of a plurality of transmit signals is the reduction of the measurement time necessary for data collection for range-velocity ambiguity resolution, and an increased update rate or decreased response time for the radar system, which can be beneficial for short range automotive collision avoidance applications. For example, not meant in any way to limit the scope or extension of the present invention, let the radar sensor described in FIG. 3A have two TX channels, and let the transmitter-receiver 200 use a linear frequency modulated continuous wave (FMCW) radar technique. Let one of the two TX channels transmit an up-chirp linearly frequency modulated radar wave, while the other TX channel simultaneously transmits a down-chirp linearly frequency modulated radar wave of the same or different center frequency. After down-conversion, the processor 380 samples the IF signals using A/D conversion and collects this data during one coherent measurement period, and signal processes this data to resolve the range-velocity ambiguity. When compared to a similar radar which uses only one TX channel and transmits the up-chirp and down-chirp FMCW radar waveform sequentially over two consecutive coherent measurement periods, the data used for range-velocity ambiguity resolution can be collected in only one coherent measurement period, or half the time.

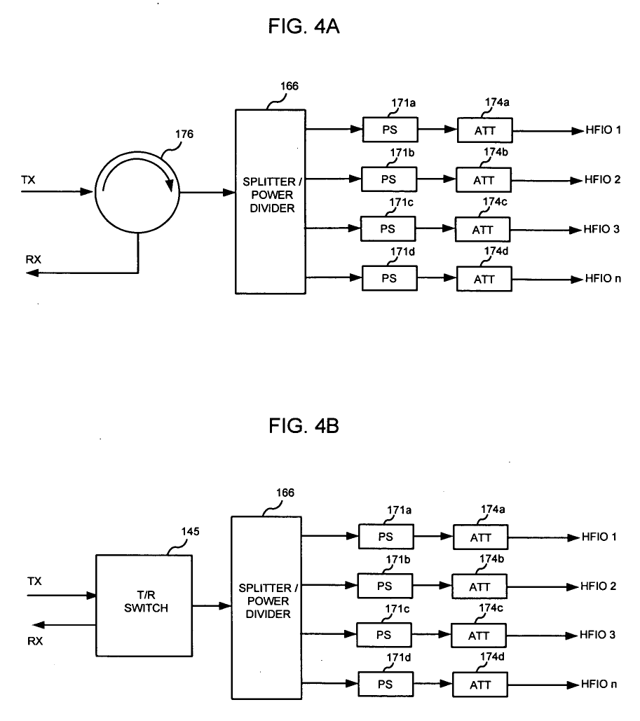

FIG. 4A illustrates one embodiment of the beam scanning/switching means 150 and one embodiment of beam switching means 153 according to aspects of the present invention. The transmit and receive signals from the radar transmitter-receiver 200 are connected to a circulator 176, such that the transmit and receive signals can share one input to a splitter/power divider 166 which splits the transmit/receive signal into a plurality of signals. The plurality of transmit/receive signals are then fed into phase shifters 171a-d and variable attenuators 174a-d where each signal path has independent signal phase and amplitude control. The order in which the phase shifter and variable attenuator operations are performed on the signals can be interchanged without departing from the present invention. One way to reduce size and/or cost is to utilize monolithic microwave integrated circuit (MMIC) or micro-electro-mechanical systems (MEMS) technology for the phase shifters 171a-d and/or variable attenuators 174a-d. The outputs from the variable attenuators 174a-d are a plurality of high-frequency input/output (HFIO) signals which are provided to a plurality of transmit/receive antenna elements in a phased array configuration for electromagnetic transmission towards, or reception from, a radar imaging region. The independent control of the signal phase and amplitude to and from each antenna element in the array allows control of the transmit/receive beam-width, such as to create a sharpened or narrow beam, and allows control of the transmit/receive beam direction, which can be electrically steered across a plurality of angles. Variations of the ideas presented can be implemented by one skilled in the art without departing from the spirit of the present invention.

FIG. 4B illustrates another embodiment of the beam scanning/switching means 150 and one embodiment of beam switching means 153 according to aspects of the present invention. The transmit and receive signals from the radar transmitter-receiver 200 are connected to a transmit/receive switch 145, such that the transmit and receive signals can share one input to a splitter/power divider 166 which splits the transmit/receive signal into a plurality of signals. The plurality of transmit/receive signals are then fed into phase shifters 171 a-d and variable attenuators 174a-d where each signal path has independent signal phase and amplitude control. The order in which the phase shifter and variable attenuator operations are performed on the signals can be interchanged without departing from the present invention. One way to reduce size and/or cost is to utilize monolithic microwave integrated circuit (MMIC) or micro-electro-mechanical system (MEMS) technology for the phase shifters 171a-d and/or variable attenuators 174a-d. The outputs from the variable attenuators 174a-d are a plurality of high-frequency input/output (HFIO) signals which are provided to a plurality of transmit/receive antenna elements in a phased array configuration for electromagnetic transmission towards, or reception from, a radar imaging region. The independent control of the signal phase and amplitude to and from each antenna element in the array allows control of the transmit/receive beam-width, such as to create a sharpened or narrow beam, and allows control of the transmit/receive beam direction, which can be electrically steered across a plurality of angles. Variations of the ideas presented can be implemented by one skilled in the art without departing from the spirit of the present invention.

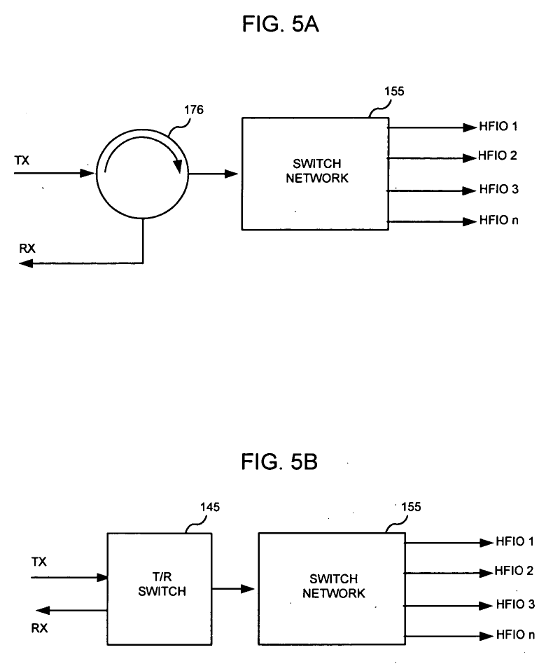

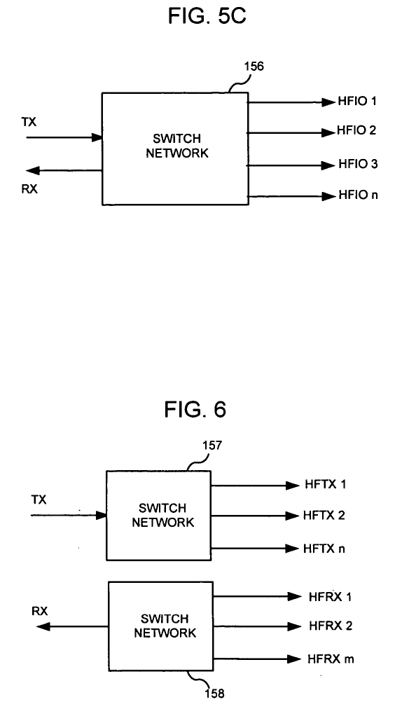

FIG. 5A illustrates another embodiment of the beam scanning/switching means 150 and another embodiment of beam switching means 153 according to aspects of the present invention. The transmit and receive signals from the radar transmitter-receiver 200 or pulsed radar transmitter-receiver with pulse compression 199 are connected to a circulator 176, such that the transmit and receive signals can share one input to a switch network 155 which switches the transmit/receive signal across n different HFIO positions, where n is an integer greater than or equal to 2. One implementation of the switch network 155, not meant in any way as a limitation, is a single-pole-n-throw switch (SPnT). One way to reduce size and/or cost is to utilize monolithic microwave integrated circuit (MMIC) or micro-electro-mechanical system (MEMS) technology for the switch network 155. The plurality of HFIO signals are provided to a beam-sharpening antenna means for electromagnetic transmission towards, or reception from, a radar imaging region. One embodiment of the beam-sharpening antenna means provides a separate antenna feed for each HFIO signal, and each feed coupled with an antenna beam pointing at a different angle with respect to each other. In that configuration, the n HFIO signals are coupled to n antenna beams each of which can be pointing at a different angle and can be, for example, positioned such that adjacent antenna beams intersect at their −3 dB power points. In this example, the n antenna beams can be sequentially selected and de-selected, providing electrical scanning of an angular region. For higher numbers of channels n and narrower beam-widths per channel, higher resolution radar images can be formed, and the higher gain associated with narrower beam-widths can result in higher sensor SNR. Variations of the ideas presented can be implemented by one skilled in the art without departing from the spirit of the present invention.

FIG. 5B illustrates a further embodiment of the beam scanning/switching means 150 and a further embodiment of beam switching means 153 according to aspects of the present invention. The transmit and receive signals from the radar transmitter-receiver 200 or pulsed radar transmitter-receiver with pulse compression 199 are connected to a transmit/receive (T/R) switch 145, such that the transmit and receive signals can share one input to a switch network 155 which switches the transmit/receive signal across n different HFIO positions, where n is an integer greater than or equal to 2. One implementation of the switch network 155, not meant in any way as a limitation, is a single-pole-n-throw switch (SPnT). One way to reduce size and/or cost is to utilize monolithic microwave integrated circuit (MMIC) or micro-electro-mechanical system (MEMS) technology for the switch network 155 and/or the transmit/receive switch 145. The plurality of HFIO signals are provided to a beam-sharpening antenna means for electro-magnetic transmission towards, or reception from, a radar imaging region. One embodiment of the beam-sharpening antenna means provides a separate antenna feed for each HFIO signal, and each feed coupled with an antenna beam pointing at a different angle with respect to each other. In that configuration, the n HFIO signals are coupled to n antenna beams each of which can be pointing at a different angle and can be, for example, positioned such that adjacent antenna beams intersect at their −3 dB power points. The n antenna beams can be sequentially selected and de-selected, providing electrical scanning of an angular region. For higher numbers of channels n, and narrower beam-widths per channel, higher resolution radar images can be formed, and the higher gain associated with narrower beam-widths can result in higher sensor SNR. Variations of the ideas presented can be implemented by one skilled in the art without departing from the spirit of the present invention.

FIG. 5C illustrates a yet further embodiment of the beam scanning/switching means 150 and a yet further embodiment of beam switching means 153 according to aspects of the present invention. The transmit and receive signals from the radar transmitter-receiver 200 or pulsed radar transmitter-receiver with pulse compression 199 are connected to a switch network 156, such that the transmit and receive signals are switched across n different HFIO positions, where n is an integer greater than or equal to 2. The plurality of HFIO signals are provided to a beam-sharpening antenna means for electromagnetic transmission towards, or reception from, a radar imaging region. One way to reduce size and/or cost is to utilize monolithic microwave integrated circuit (MMIC) or micro-electro-mechanical system (MEMS) technology for the switch network 156. One embodiment of the beam-sharpening antenna means provides a separate antenna feed for each HFIO signal, and each feed coupled with an antenna beam pointing at a different angle with respect to each other. In that configuration, the n HFIO signals are coupled to n antenna beams each of which can be pointing at a different angle and can be, for example, positioned such that adjacent antenna beams intersect at their −3 dB power points. The n antenna beams can be sequentially selected and de-selected, providing electrical scanning of an angular region. For higher numbers of channels n and narrower beam-widths per channel, higher resolution radar images can be formed, and the higher gain associated with narrower beam-widths can result in higher sensor SNR. Variations of the ideas presented can be implemented by one skilled in the art without departing from the spirit of the present invention.

FIG. 6 illustrates another embodiment of the beam scanning/switching means 150 and another embodiment of beam switching means 153 according to aspects of the present invention. The transmit signal from the radar transmitter-receiver 200 or pulsed radar transmitter-receiver with pulse compression 199 is connected to a switch 157 such that the transmit signal is switched across n different high-frequency transmit (HFTX) positions, where n is an integer greater than or equal to 2. The receive signal from the radar transmitter-receiver 200 or pulsed radar transmitter-receiver with pulse compression 199 is connected to a switch 158 such that the receive signal is switched across m different high-frequency receive (HFRX) positions, where m is an integer greater than or equal to 2. In this way, the transmit and receive signals can be switched across independent antenna beams where the beams can be pointed in independent directions, can be physically or spatially separated from one another, or a combination of both. One way to reduce size and/or cost is to utilize monolithic microwave integrated circuit (MMIC) or micro-electro-mechanical system (MEMS) technology for the switches 157, 158. One example where this arrangement may be advantageous is in a radar system which utilizes phase comparison monopulse techniques or multi-lateration techniques to aid in target direction finding, where spatial separation of the phase center of antennas or physical separation of antennas is used. Variations of the ideas presented can be implemented by one skilled in the art without departing from the spirit of the present invention.

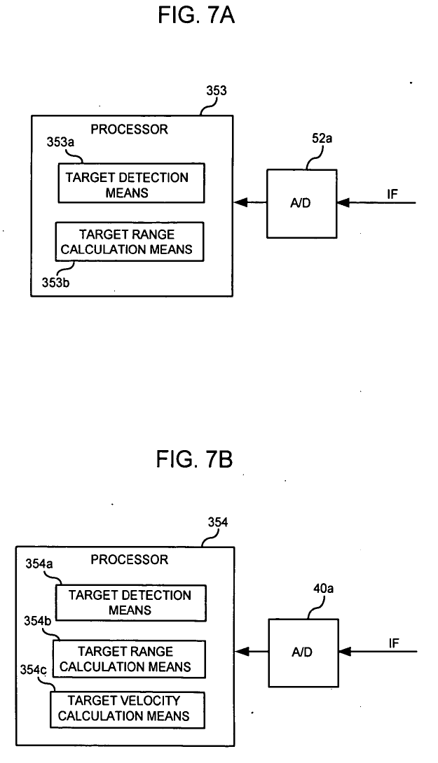

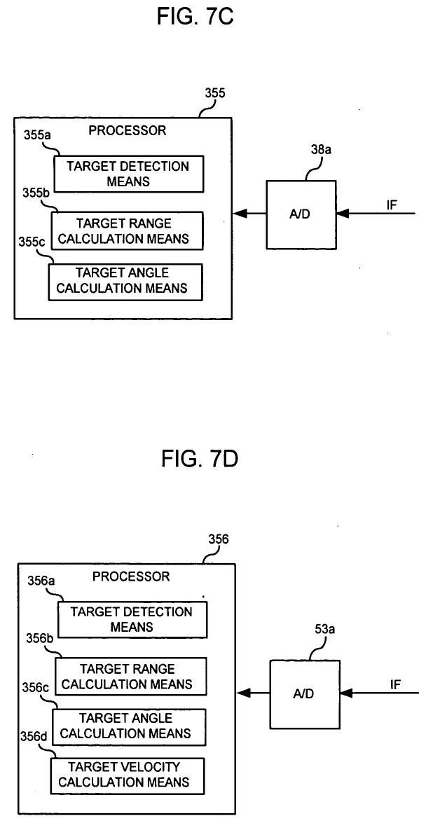

One embodiment of the signal processor 380 is illustrated in FIG. 7A. Analog-to-digital (A/D) converter means 52a digitizes one or a plurality of analog IF channels. The digitized IF signal is then input to processor means 353. Processor means 353 may comprise a single or plurality of individual processors. Processor means 353 performs target detection through target detection means 353a, and target range determination through target range calculation means 353b. The processing techniques used by the processor 353 may include, but are not limited to, windowing, a real or complex DFT or FFT, digital filtering, Hilbert transform, spectral peak detection, CFAR threshold detection, spectral peak frequency measurement, spectral peak phase measurement, signal phase measurement, signal frequency measurement, or signal envelope amplitude measurement. The processor means 353 may include, but is not limited to, a digital signal processor (DSP), microprocessor, microcontroller, electrical control unit, or other suitable processor block.

Another embodiment of the signal processor 380 is illustrated in FIG. 7B. Analog-to-digital (AID) converter means 40a digitizes one or a plurality of analog IF channels. The digitized IF signal is then input to processor means 354. Processor means 354 may comprise a single or plurality of individual processors. Processor means 354 performs target detection through target detection means 354a, target range determination through target range calculation means 354b, and target velocity determination through target velocity calculation means 354c. The processing techniques used by the processor 354 may include, but are not limited to, windowing, a real or complex DFT or FFT, digital filtering, Hilbert transform, spectral peak detection, CFAR threshold detection, spectral peak frequency measurement, spectral peak phase measurement, signal phase measurement, signal frequency measurement, signal envelope amplitude measurement, Doppler processing, or velocity derivation through successive time target measured positions. Target velocity derived from Doppler processing can also be used as a target discrimination means to aid in target separation and processing, especially in the situation where multiple target returns are from the same range, or within the same range bin of the radar. The processor means 354 may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

A further embodiment of the signal processor 380 is shown in FIG. 7C. In this arrangement, analog to digital converter means 38a digitizes one or a plurality of analog IF channels. The digitized IF signal is then input to processor means 355. Processor means 355 may comprise a single or plurality of individual processors. Processor means 355 performs target detection through target detection means 355a, target range determination through target range calculation means 355b, and target angle determination through target angle calculation means 355c. The processing techniques used by processor 355 may include, but are not limited to, windowing, a real or complex DFT or FFT, digital filtering, Hilbert transform, spectral peak detection, CFAR threshold detection, spectral peak frequency measurement, spectral peak phase measurement, signal phase measurement, signal frequency measurement, signal envelope amplitude measurement, least squares algorithms, non-linear least squares algorithms, digital beam-forming, or super-resolution algorithms such as multiple signal classification (MUSIC). The target angle determination methods utilized by the target angle calculation means 355c may include, but are not limited to, beam switch or scan position, amplitude-comparison monopulse direction-finding method, multilateration direction-finding method, phase-comparison monopulse direction-finding method, amplitude comparison, or a combination of any of these methods. The processor means 355 may include, but is not limited to, a digital signal processor (DSP), microprocessor, microcontroller, electrical control unit, or other suitable processor block.

A yet further embodiment of the signal processor 380 is shown in FIG. 7D. In this arrangement, analog-to-digital (A/D) converter means 53a digitizes one or a plurality of analog IF channels. The digitized IF signal is then input to processor means 356. Processor means 356 may comprise a single or plurality of individual processors. Processor means 356 performs target detection through target detection means 356a, target range determination through target range calculation means 356b, target angle determination through target angle calculation means 356c and target velocity determination through target velocity calculation means 356d. The processing techniques used by processor 356 may include, but are not limited to, a real or complex DFT or FFT, windowing, digital filtering, Hilbert transform, spectral peak detection, CFAR threshold detection, spectral peak frequency measurement, spectral peak phase measurement, signal phase measurement, signal frequency measurement, signal envelope amplitude measurement, least squares algorithms, non-linear least squares algorithms, digital beam-forming, super-resolution algorithms such as multiple signal classification (MUSIC), Doppler processing, or velocity derivation through successive time target measured positions. Target velocity derived from Doppler processing can also be used as a target discrimination means to aid in target separation and processing, especially in the situation where multiple target returns are from the same range or within the same range bin of the radar. The target angle determination methods utilized by the target angle calculation means 356c may include, but are not limited to, beam switch or scan position, amplitude-comparison monopulse direction-finding method, multilateration direction-finding method, phase-comparison monopulse direction-finding method, amplitude comparison, or a combination of any of these methods. The processor means 356 may include, but is not limited to, a digital signal processor (DSP), microprocessor, microcontroller, electrical control unit, or other suitable processor block. Furthermore, target velocity can be determined externally from the radar sensor unit, such as in an external processor or on the radar system level, without departing from the spirit of the present invention.

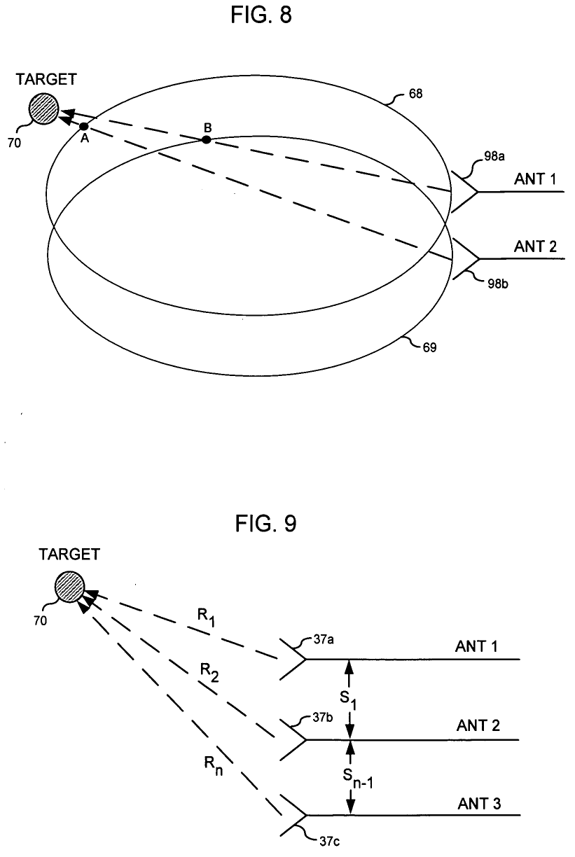

FIG. 8 shows the amplitude-comparison monopulse direction-finding technique as one embodiment of the angle calculation means within signal processor 380. Two antenna means 98a, 98b are spatially separated or have different beam directions such that their corresponding antenna gain patterns 68, 69 are offset from each other. When a target 70 is detected, the amplitudes of the signals detected in receiver channels 1 and 2 will be different, since the antenna gain patterns will be different corresponding to where the target is located, shown by antenna gain intercept points A and B. The resulting IF signal amplitudes are measured, and compared to determine the target direction angle. One way to determine the target angle is to use a 180-degree hybrid coupler to create sum and difference signals from the signals received in the two channels. The target angle is calculated by taking the ratio of the difference/sum. Another way to determine the target angle is to pass the signals from receiver channels 1 and 2 through logarithmic amplifiers then subtract one from the other. This output can be used to determine the target angle. A third method compares the amplitudes of received signals across a plurality of receiver channels to determine the target angle. The use of these methods does not require simultaneous measurement with two receive antennas. The receiver antenna measurements can be made sequentially, such as to be compatible with beam-switched or beam-scanned antenna arrangements. The signal from the first receive antenna can be stored, then compared with the signal from the second receive antenna at a later time.

FIG. 9 illustrates the multilateration direction-finding technique as another embodiment of the angle calculation means within signal processor 380. A plurality of antenna means 37a, 37b, 37c are spatially separated by a distances S₁, Sₙ₋₁. The target ranges R₁, R₂, Rₙ to the target 70 are independently determined at each receiver antenna means locations. The differences in target ranges determined at each spatially separated receiver antenna means 37a, 37b, 37c locations are used to calculate the target direction angle □. This can be accomplished using, but not limited to, a least squares method, a non-linear least squares method, or a super-resolution algorithm such as multiple signal classification (MUSIC). A variety of other methods or algorithms known to those skilled in the art can be used to determine a target direction angle using the technique described in the abovementioned arrangement without changing the basic form or spirit of the invention. While FIG. 9 illustrates this technique for a 3-receive antenna means arrangement, this method is applicable to an arrangement containing n receive antenna means, where n is an integer greater than or equal to 2. Furthermore, the multilateration technique can use difference-of-time-of-arrival (DTOA) measurements of signals across a plurality of receiver channels in pulsed radar arrangements instead of target range measurements to calculate a target's direction, since the time-of-arrival of signals in pulsed radar arrangements is used to determine target range. The use of this method does not require simultaneous measurement with two receive antennas. The receiver antenna measurements can be made sequentially, such as to be compatible with beam-switched or beam-scanned antenna arrangements. The signal or range from the first receive antenna can be stored, then compared with the signal from the second receive antenna at a later time.

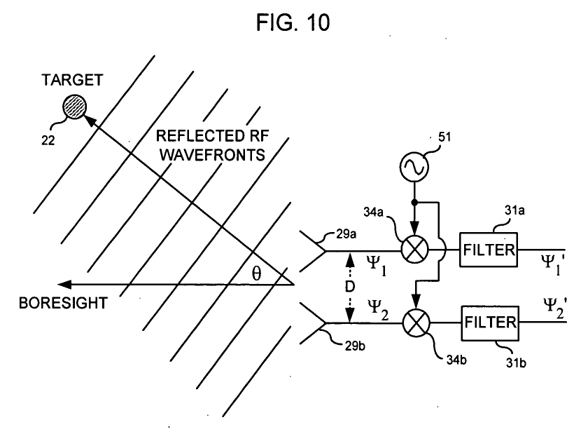

FIG. 10 illustrates the phase-monopulse direction-finding technique as a further embodiment of the angle calculation means within signal processor 380. An electromagnetic signal is reflected from a target 22 with a wavelength □, and the signal is received by two antenna means 29a and 29b. It is assumed that the reflected electromagnetic wavefronts are generally planar. The antenna elements 29a, 29b are separated by a distance D, and the target direction angle from boresight is □. The received electromagnetic signal must travel a longer distance to reach antenna means 29b than to reach antenna means 29a for a positive value of □. This difference in travel distance causes a measured phase difference □□□□₂□₁ between antenna means 29a and 29b. The phase can be measured and compared between the two receiver channels at the RF frequency, or more conveniently can be measured and compared after down-conversion at the IF frequency, since phase is preserved after down-conversion. A simple down-conversion circuit is illustrated in which a local oscillator 51 feeds mixers 34a, 34b which mix down the received RF signals. Filters 31a, 31b then pass the down-converted IF signals. The phase difference between the IF signals □□□□₂′□₁′ is equivalent to the phase difference □□ The equation relating the calculated target angle □ to the measured phase difference □□, wavelength □, and antenna separation distance D is:

$$θ = arcsin [ \frac{ΔΨ \cdot λ}{2 π \cdot D} ] \qquad ( 1 )$$

where □ is the average received wavelength of the modulated radar signal during a coherent measurement interval. A coherent measurement interval Tₚ is a period of time during which a signal such as an IF signal is measured, processed, or time-sampled and stored as a signal segment. One example of this is when during a coherent measurement interval, an IF signal is time-sampled, and the time-samples are associated as part of a signal segment which is then processed or measured as a unified, discrete-time signal segment. The receiver antenna measurements can be made sequentially, such as to be compatible with beam-switched or beam-scanned antenna arrangements. The signal or range from the first receive antenna can be stored, then compared with the signal from the second receive antenna at a later time. The phase-monopulse equation (1) is only valid for antenna separation distances D that are short enough not to allow any target return received within the sensor angular field of view to cause the absolute value of quantity |□□| to be greater than or equal to 180 degrees.

For the case where a phase-monopulse antenna separation distance D is large enough such that a target return received within the sensor field of view causes the absolute value of quantity

|□□| to be greater than or equal to 180 degrees, the calculated target direction angle 0 will have ambiguous results. This ambiguity can be resolved by combining the phase-monopulse direction-finding method with an additional direction-finding method such as amplitude-comparison monopulse, multilateration using range data or difference-of-time-of-arrival (DTOA) data, or by combining with additional switched-beam detection zones. The additional direction-finding method in this combination will allow a coarse estimate of the target direction angle such that a higher precision target direction angle □ can be chosen from the ambiguous calculated set as the value closest to the value of the coarse estimate, while the longer phase-monopulse separation distance D will provide higher target angle estimate accuracy than for an unambiguous separation distance.

The aforementioned angle direction-finding techniques may be used individually or in combination within a single sensor, or within signal processor 380, in order to improve performance. The performance improvements may include, but are not limited to, an increase in range or angle calculation accuracy, an improvement in multiple target determination or discrimination, a reduction of false alarm rate, or a reduction of processing load.

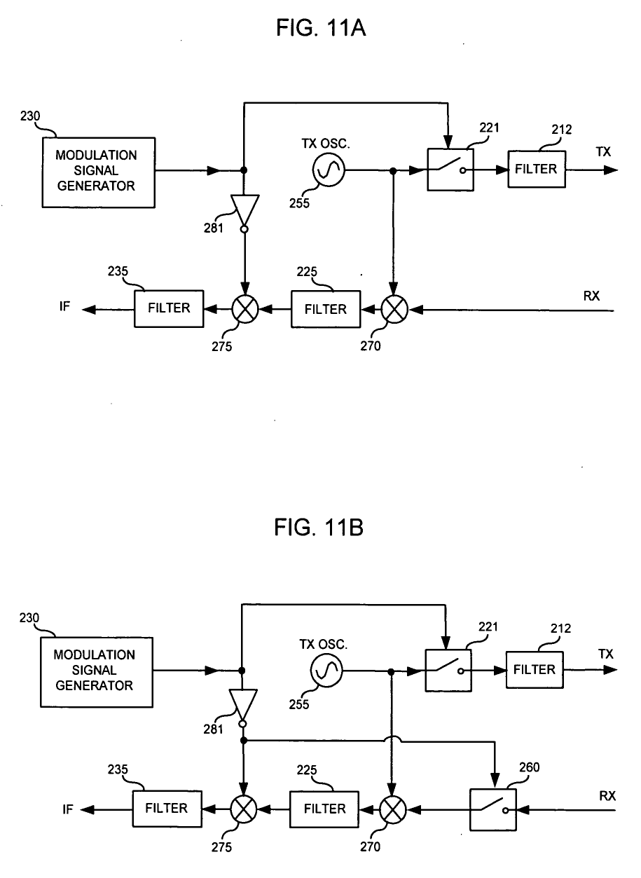

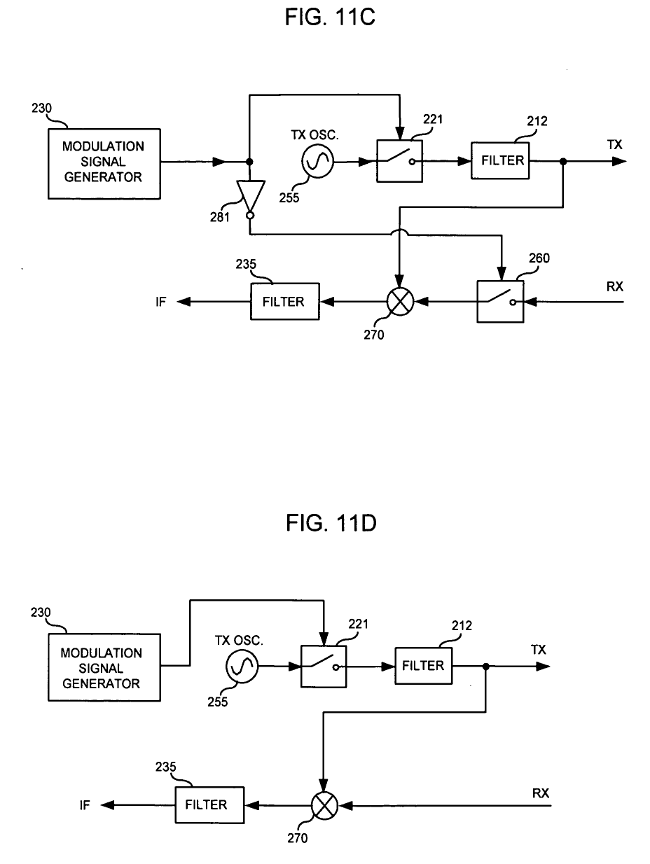

FIG. 11A illustrates a pulsed radar transmitter-receiver arrangement as one embodiment of radar transmitter-receiver 200 and as one embodiment of pulsed radar transmitter-receiver with pulse compression 199 according to aspects of the present invention. In this arrangement, modulation signal generator 230 outputs a modulation signal which is connected to the control input of the modulator 221. In one arrangement of modulation signal generator 230, the modulation signal is a pulse train where the pulse repetition interval (PRI) is continuously linearly increased or decreased over a predetermined time interval. The modulator 221 can be implemented by, but is not limited to, a pulse modulator, amplitude modulator, bi-phase shift keyed modulator, phase modulator, switch, mixer, or AND gate. The output of transmit oscillator 255 is connected to the modulator 221 where it is modulated by the modulation signal from 230. An output filter 212 selects one of the modulation sidebands, either the upper or lower sideband, to pass for transmission. The output signal from filter 212 then proceeds to an antenna means for transmission of the signal towards a target. The reflected signal from a target will be received by antenna means and connected to down-converting mixer 270 where the signal is mixed with the output of transmit oscillator 255, and the resulting signal is filtered by filter 225. After filtering by 225 the signal is then connected to mixer 275 where it is mixed with the inverted output of modulation signal generator 230, and the resulting signal is filtered by filter 235. The inverter 281 can be removed so that the output of modulation signal generator 230 is connected directly to the mixer 275 without departing from the spirit of the present invention. Furthermore, the signal feeding mixer 275 can be additionally filtered prior to being connected to mixer 275 without departing from the spirit of the present invention. Mixers 270, 275 can be implemented by, but are not limited to, mixers, multipliers, or switches without changing the basic functionality of the arrangement. Filter 212 can be implemented by, but is not limited to, a band-pass filter. Filter 225 can be implemented by, but is not limited to, a band-pass filter. Filter 235 can be implemented by, but is not limited to, a low-pass filter. After filtering by 235 the resulting signal is an intermediate frequency (IF) signal containing target information. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

The pulsed radar transmitter-receiver arrangement described in FIG. 11B is presented as another embodiment of radar transmitter-receiver 200 and as another embodiment of pulsed radar transmitter-receiver with pulse compression 199 according to aspects of the present invention. The arrangement in FIG. 11B is similar to the arrangement in FIG. 11A except for the addition of modulator 260. The same components are denoted by the same reference numerals, and will not be explained again. The modulator 260 modulates the received signal prior to the down-converter mixer 270. The signal from inverter 281 feeding mixer 275 can be additionally re-inverted or filtered prior to being connected to mixer 275 without departing from the spirit of the present invention. Modulator 260 can be implemented by, but is not limited to, a switch which gates the receiver channels, effectively blanking the receiver when the transmit signal pulse is on, and passing energy to the receiver when the transmit signal pulse is off. This can help to reduce transmit signal leakage to the receiver and increase the dynamic range of the receiver.

The pulsed radar transmitter-receiver arrangement described in FIG. 11C is presented as a further embodiment of radar transmitter-receiver 200 and as one embodiment of pulsed radar transmitter-receiver with pulse compression 199 according to aspects of the present invention. The arrangement in FIG. 11C is similar to the arrangement in FIG. 11B, except for removal of filter 225 and mixer 275, and that the signal feeding mixer 270 is taken from the output of filter 212. The same components are denoted by the same reference numerals, and will not be explained again. This arrangement is essentially a receiver-gated homodyne architecture, with simplified structure as compared to the arrangement in 11B.

FIG. 11D illustrates a pulsed transmitter-receiver arrangement as a yet further embodiment of radar transmitter-receiver 200 and as a yet further embodiment of pulsed radar transmitter-receiver with pulse compression 199 according to aspects of the present invention. The arrangement in FIG. 11D is similar to the arrangement in FIG. 11C except for removal of modulator 260. The same components are denoted by the same reference numerals, and will not be explained again. This arrangement is a simpler structure compared to that of FIG. 11C. The removal of receiver gating makes the arrangement more compact and potentially lower cost.

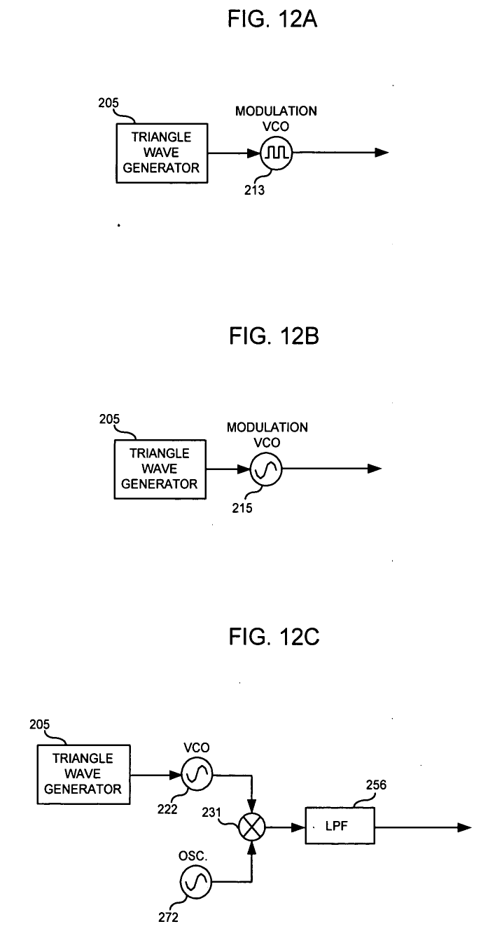

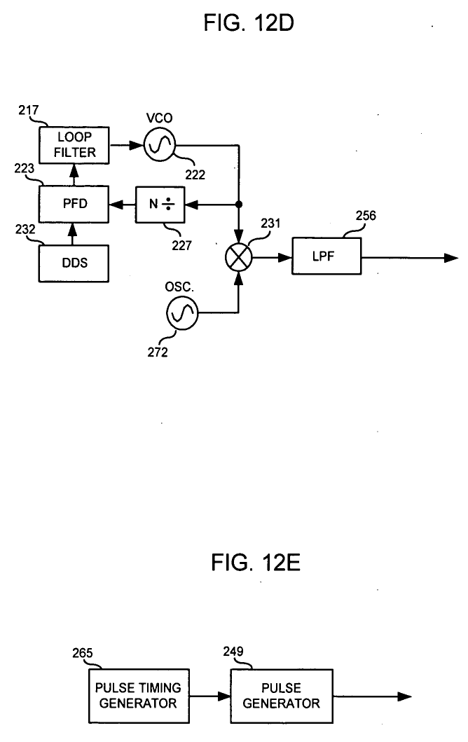

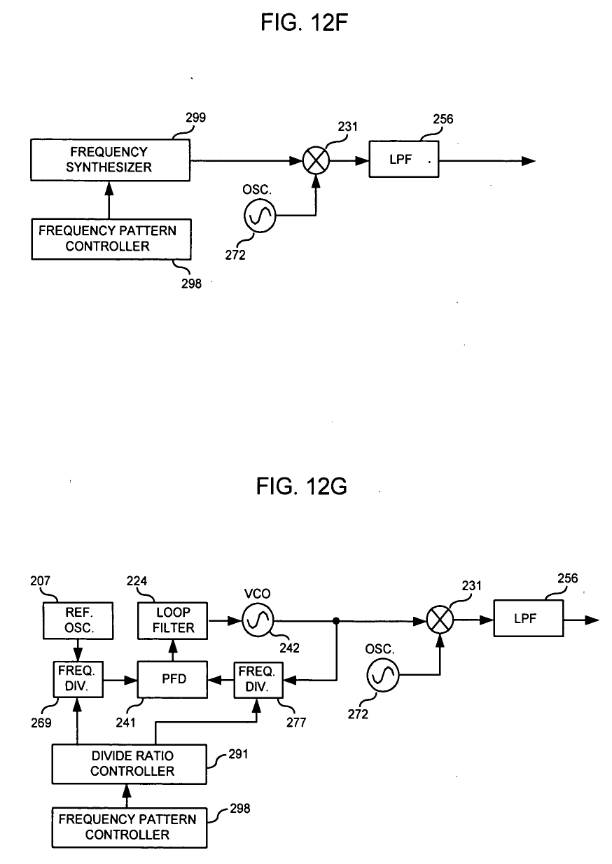

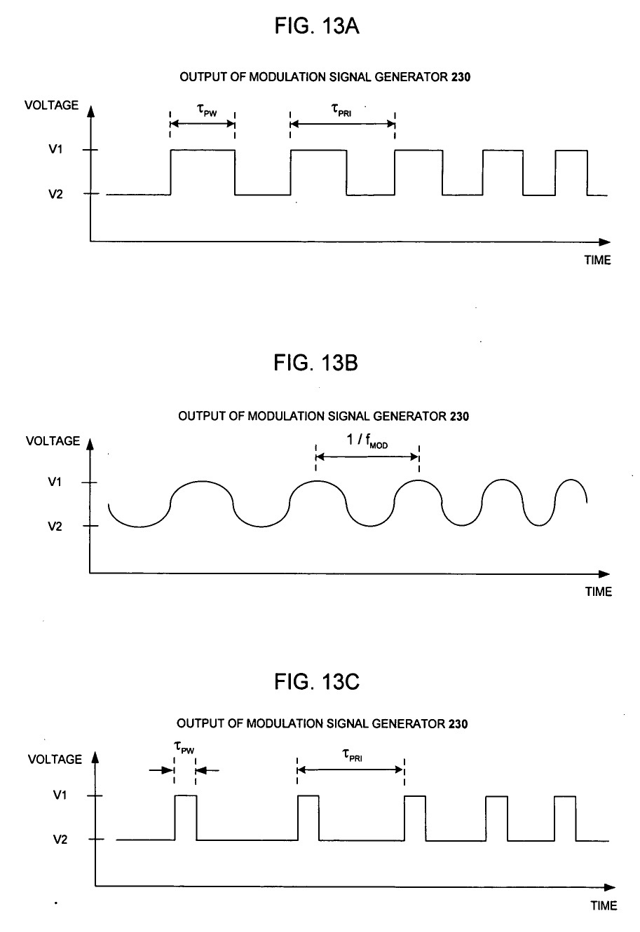

One embodiment of modulation signal generator 230 is shown in FIG. 12A. A triangle wave generator 205 outputs a triangle wave signal with linear or monotonic up, down, or up-and-down slope regions. The output of triangle wave generator 205 modulates the frequency of square wave modulation VCO 213. The output signal of square wave VCO 213 is a pulse train with a constant duty cycle and a pulse repetition interval (PRI) that is linearly or monotonically changed with respect to time, from one PRI value to another PRI value over a pre-determined time interval. The output waveform of this embodiment of modulation signal generator 230 is shown in FIG. 13A. As can be seen, the output signal is a pulse train with the pulse repetition interval □_{PRI} changed with respect to time. The pulse width □_{PW} does not remain constant during the PRI modulation, but the duty cycle of the pulse train remains constant.

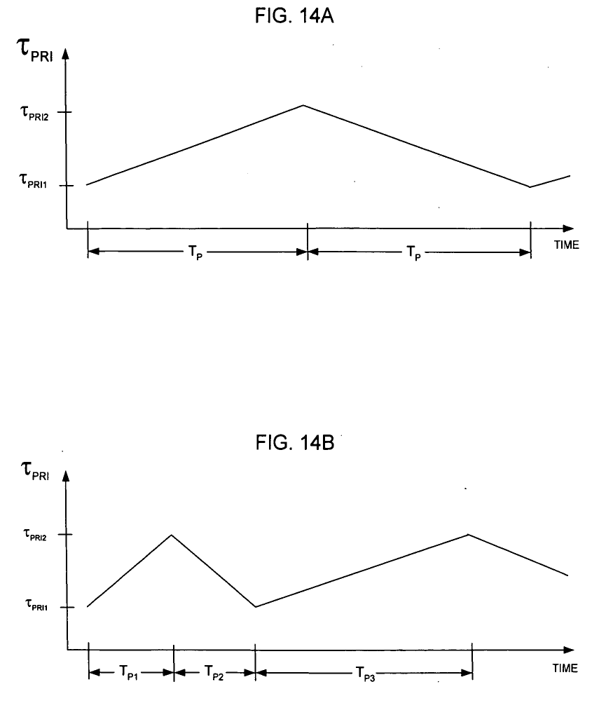

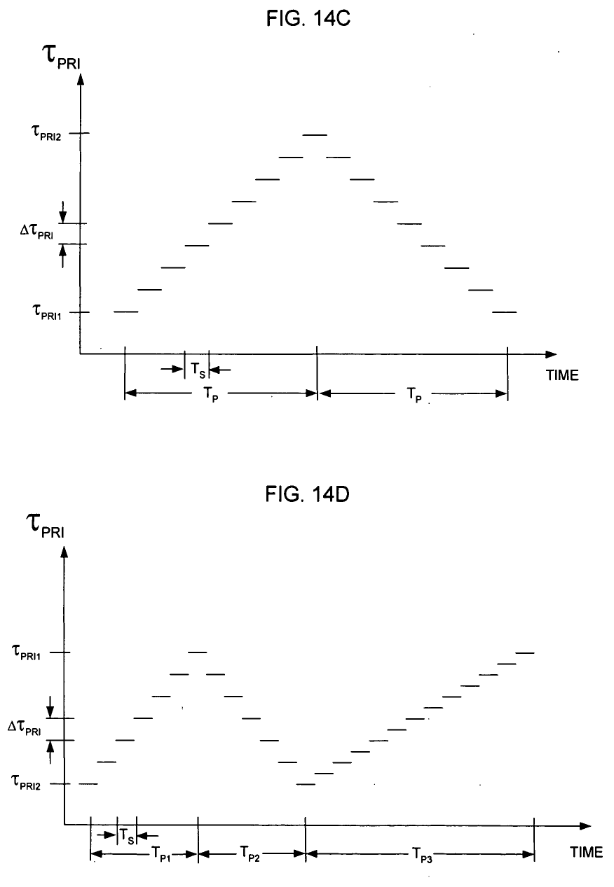

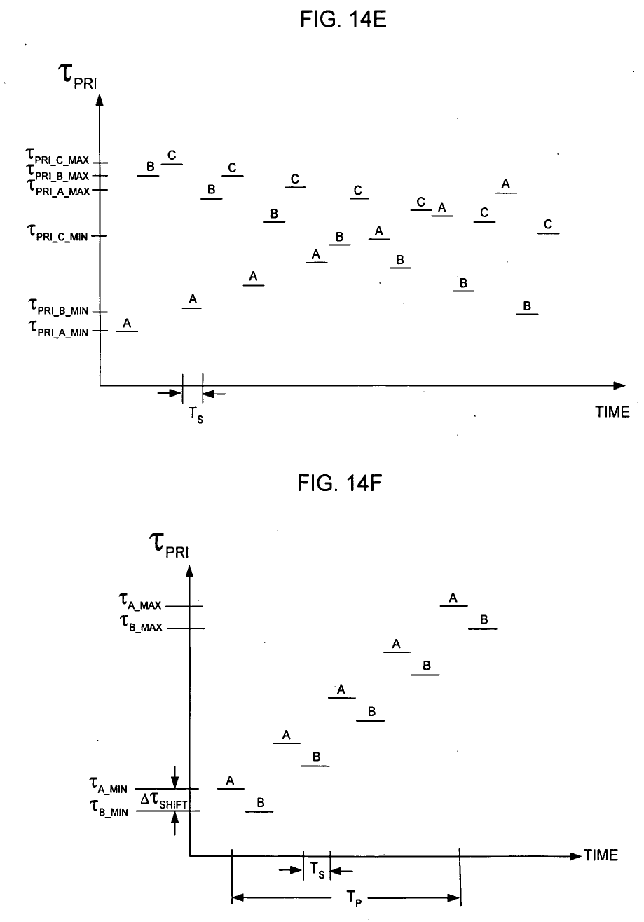

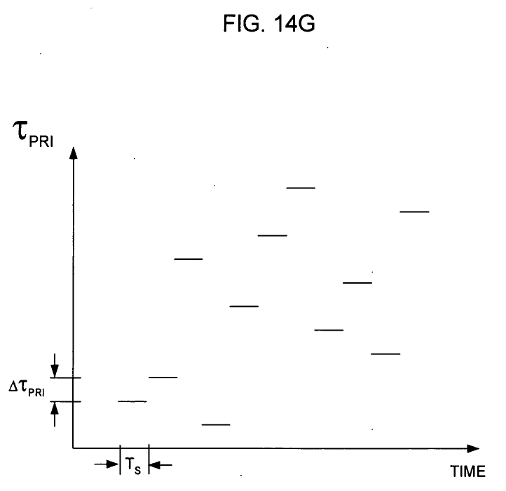

Another embodiment of modulation signal generator 230 is shown in FIG. 12B. A triangle wave generator 205 outputs a triangle wave signal with linear or monotonic up, down, or up-and-down slope regions. The output of triangle wave generator 205 modulates the frequency of sine wave modulation VCO 215 creating a linear or monotonic up, down, or up-and-down frequency modulated signal, whose frequency is linearly or monotonically changed with respect to time. The output waveform of this embodiment of modulation signal generator 230 is shown in FIG. 13B. As can be seen, the output signal is a sine wave with its frequency f_{MOD} changed with respect to time. In another embodiment of the present invention, let f_{MOD}=1/□_{PRI} for use with the PRI modulation waveforms as described in FIGS. 14A-G.

A further embodiment of modulation signal generator 230 is shown in FIG. 12C. A triangle wave generator 205 outputs a triangle wave signal with linear or monotonic up, down, or up-and-down slope regions. The output of triangle wave generator modulates the frequency of sine wave modulation VCO 222 creating a linear or monotonic up, down, or up-and-down chirp signal, whose frequency is linearly or monotonically changed with respect to time. The output signal of VCO 222 is-mixed with the output signal of oscillator 272 by mixer 231. The down-converted signal output of mixer 231 is filtered by low-pass filter 256 and output. The advantage of this arrangement is that using a higher frequency VCO for modulation can achieve a wider absolute modulation bandwidth as a smaller fractional bandwidth of the VCO center frequency, which can be easier to realize in a practical VCO. After down-conversion, the absolute modulation bandwidth is preserved in the output signal.

A yet further embodiment of modulation signal generator 230 is shown in FIG. 12D. In this arrangement, a direct digital synthesizer (DDS) 232 is used as a reference signal to create the up/down linear or monotonic frequency modulation signal. This signal is then up-converted to a higher frequency range through the use of VCO 222, phase-frequency detector (PFD) 223, loop filter 217, and frequency divider 227. The output of VCO 222 will be a frequency-multiplied version of the output of the direct digital synthesizer 232. The remaining components have the same function and reference numerals as in FIG. 12C, and will not be described again.

FIG. 12E illustrates an alternate embodiment of modulation signal generator 230. In this arrangement, a pulse timing generator 265 is output to a pulse generator 249. The pulse generator 249 creates fixed pulse width pulses, with the pulse to pulse timing controlled by the pulse timing generator 265. The output waveform of this embodiment of modulation signal generator 230 is shown in FIG. 13C. As can be seen, the output signal is a pulse train with the pulse repetition interval □_{PRI} changed linearly or monotonically with respect to time. The pulse width □_{PW} remains constant during the PRI modulation.

Another embodiment of modulation signal generator 230 is shown in FIG. 12F. In this arrangement, a frequency pattern controller 298 controls a frequency synthesizer 299. The output of frequency synthesizer 299 will be a signal whose frequency hops or steps according to the pattern and timing dictated by the frequency pattern controller 298. The output of frequency synthesizer 299 is input to mixer 231 where it is mixed with an oscillator 272. The output of mixer 231 is filtered by low-pass filter 256. The result is a modulation signal output that can be used to create PRI stepped or hopped waveforms, such as those illustrated by FIGS. 14C-G. A further embodiment of modulation signal generator 230 is shown in FIG. 12G. In this arrangement, a frequency pattern controller 298 is input to a divide ratio controller 291 which controls the divide ratios of frequency dividers 277, 269. The frequency dividers 277, 269 can be implemented by counters without departing from the scope or spirit of the present invention. A reference oscillator 207 provides a reference signal of a predetermined frequency to the input of frequency divider 269. The output of VCO 242 is split and one of the split signals is input to frequency divider 277. The output of frequency divider 277 and the output of frequency divider 269 are both input to phase-frequency detector 241. The output of phase frequency detector 241 is filtered by loop filter 224 and is input to the frequency control port of VCO 242. The output of VCO 242 will be a signal whose frequency hops or steps according to the pattern and timing dictated by the frequency pattern controller 298. The output of VCO 242 is input to mixer 231 where it is mixed with an oscillator 272. The output of mixer 231 is filtered by low-pass filter 256. The result is a modulation signal output that can be used to create PRI stepped or hopped waveforms, such as those illustrated by FIGS. 14C-G.

FIG. 14A illustrates one PRI modulation waveform for use in the modulation signal generator 230 according to aspects of the present invention. This waveform shows a linear up slope PRI modulation during a first time period T_{P}, and a linear down slope PRI modulation during a second time period T_{P}. This waveform shown is an example of PRI modulation, and is not meant as a restriction. The PRI modulation can also consist of, but is not limited to, a repeating pattern of linear up slope modulation, a repeating pattern of linear down slope modulation, an alternating pattern of up and down slope modulation, a monotonically increasing PRI over a time period, a monotonically decreasing PRI over a time period, an alternating pattern of monotonically increasing and decreasing PRI modulation. Furthermore, one or more blanking periods where the PRI is constant may be inserted within or between the up or down slope periods.

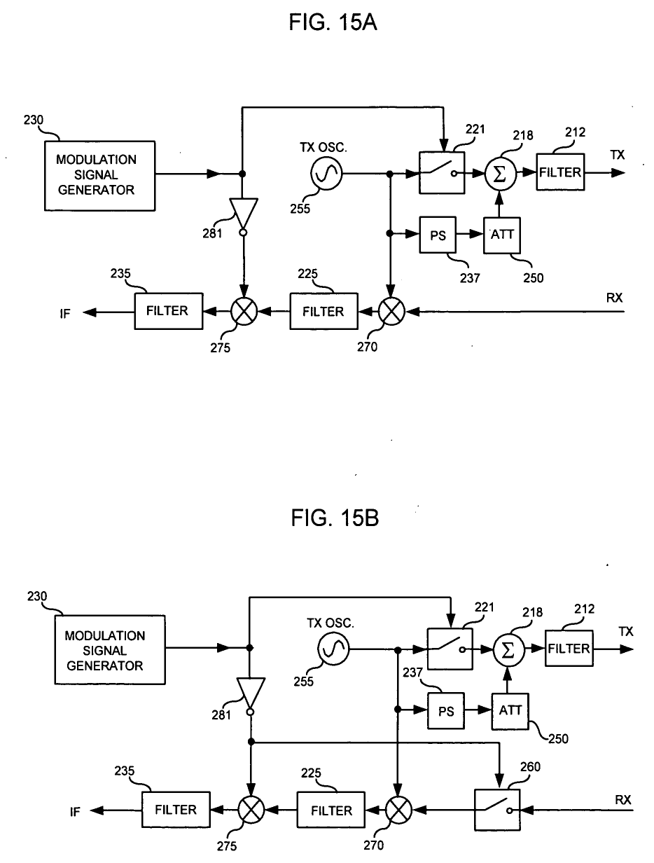

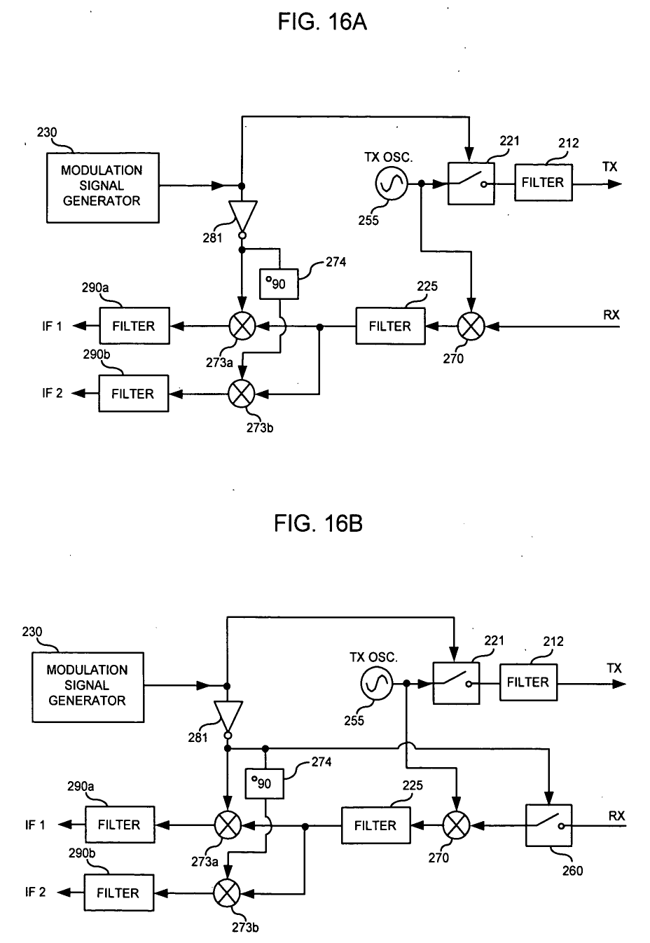

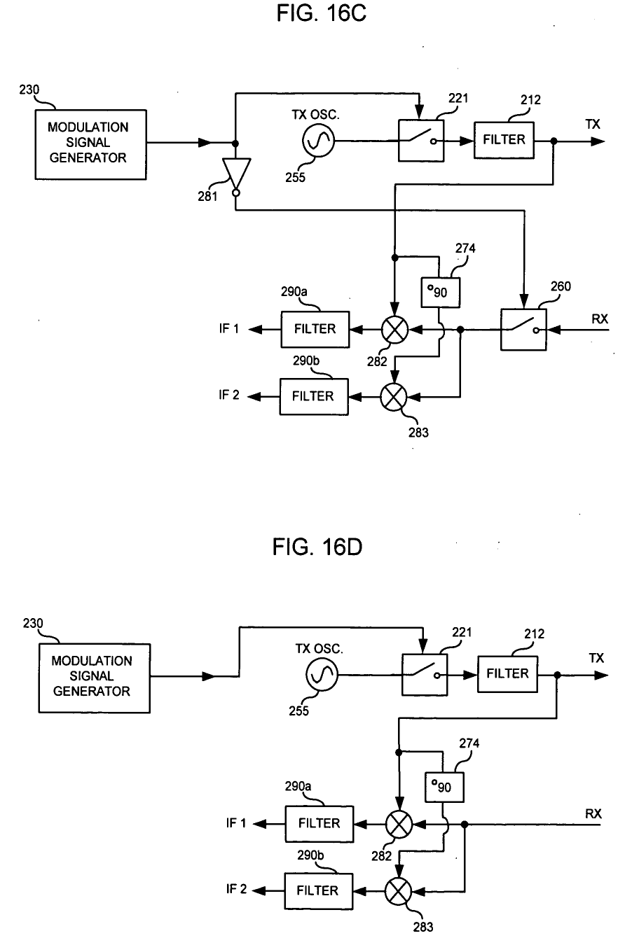

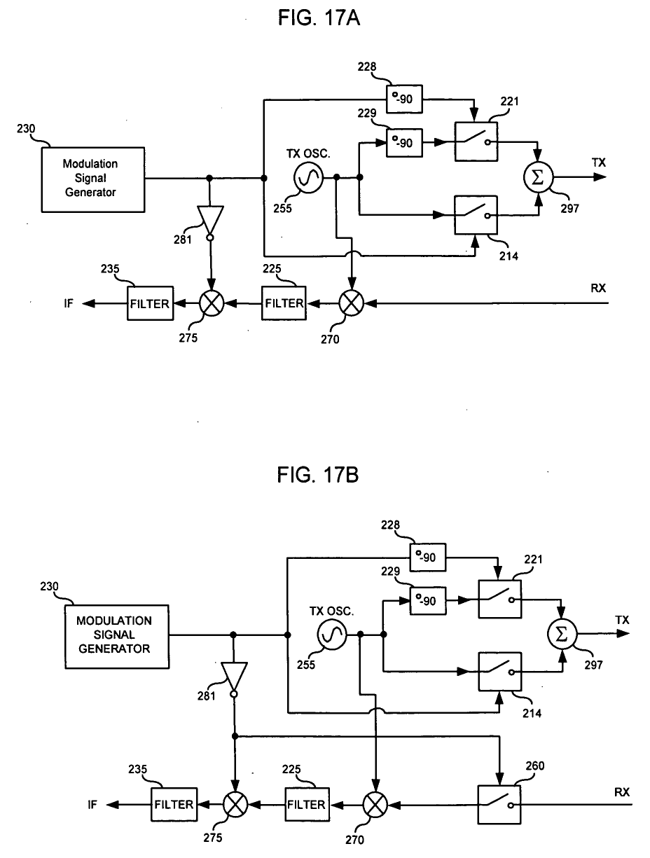

Using the PRI timing modulation waveform described in FIG. 14A, target information may be calculated from the IF signals shown in FIGS. 11A-D, FIGS. 15A-B, FIGS. 16A-D, and FIGS. 17A-B, in the following way: Peaks in the IF signal spectrum represent target returns. The frequency of the target peaks is proportional to target range, and is used to calculate target range. As an example, not meant in any way as a limitation, let the radar arrangement of FIG. 11A transmit a single-sideband, upper-sideband radar signal and utilize a PRI modulation according to FIG. 14A. Let the IF signal be measured during each coherent measurement interval T_{P}, which also corresponds in this example to the PRI up ramp and down ramp periods. Under these conditions, target range can be calculated by the following equation:

$$R = \frac{c \cdot {T}_{P}}{4 \cdot ( 1 / {τ}_{PR11} - 1 / {τ}_{PR12} )} \cdot ( {f}_{PU} + {f}_{PD} ) \qquad ( 2 )$$

where R is the calculated target range, c is the speed of light in a vacuum, Tₚ is the period of the up ramp or down ramp of the PRI modulation, □_{PRI1} and □_{PRI2} are the minimum and maximum PRI values respectively during the coherent measurement interval T_{P}, and f_{PU} and f_{PD} are the beat frequencies in the IF signal corresponding to measurements during the PRI up ramp and PRI down ramp periods T_{P} respectively.

The Doppler frequency shift of the target frequency peaks is used to calculate target relative velocity. As an example, not meant in any way as a limitation, let the radar arrangement of FIG. 11A transmit a single-sideband, upper-sideband radar signal and utilize a PRI modulation according to FIG. 14A. Let the IF signals be measured during each coherent measurement interval T_{P}, which also corresponds in this example to the PRI up ramp and down ramp periods. Under these conditions, target relative velocity can be calculated by the following equation:

$$V = \frac{c}{4 {f}_{C} + 2 / {τ}_{PR11} + 2 / {τ}_{PR12}} \cdot ( {f}_{PU} - {f}_{PD} ) \qquad ( 3 )$$

where V is the calculated target relative velocity defined as positive for an approaching target, c is the speed of light in a vacuum, f_{PU} and f_{PD} are the beat frequencies in the IF signal corresponding to measurements during the PRI up ramp and PRI down ramp modulation intervals T_{P} respectively, f_{C} is the frequency of the transmit oscillator 255, and □_{PRI1} and □_{PRI2} are the minimum and maximum PRI values during the coherent measurement interval T_{P}.

If a plurality of receiver channels are used, or sequentially switched between and IF signals measured, then amplitude of the target peaks can be measured across the corresponding IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse method.

FIG. 14B illustrates a multiple slope PRI modulation waveform for use in the modulation signal generator 230 according to aspects of the present invention. This waveform shows a linear up slope PRI modulation during a time period T_{P1}, a linear down slope PRI modulation during another period of time T_{P2}, and another linear PRI modulation with a different slope during a period of time T_{P3}. This waveform shown is an example of PRI modulation, and is not meant as a restriction. The PRI modulation can also consist of, but is not limited to, a plurality of linearly increasing and decreasing PRI modulations of various slopes with each modulation occurring over a predetermined period of time, or a plurality of monotonically increasing and decreasing PRI modulations of various slopes with each modulation occurring over a predetermined period of time. Furthermore, one or more blanking periods where the PRI is constant may be inserted within or between the up or down slope periods.

Using the type of frequency-hopping pattern described in FIG. 14B, target information may be calculated from the IF signals shown in FIGS. 11A-D, FIGS. 15A-B, FIGS. 16A-D, and FIGS. 17A-B in a way similar to that described for use with the waveform of FIG. 14A. Peaks in the IF signal spectrum represent target returns. The frequency of the target peaks is proportional to target range and is used to calculate target range. The Doppler frequency shift of the target frequency peaks is used to calculate target relative velocity. One benefit of the use of multiple slopes of PRI waveforms is that this assists in the removal of false or ghost targets in the processing, and aids in the resolution of the range-velocity ambiguity.

FIG. 14C illustrates a stepped PRI modulation waveform for use in the modulation signal generator 230 according to aspects of the present invention. This waveform shows a linearly stepped PRI pattern during a time period T_{P}. This waveform shown is an example of linearly stepped PRI modulation, and is not meant as a restriction. The waveform can also comprise, but is not limited to, a repeating pattern of linearly increasing PRI steps, a repeating pattern of linearly decreasing PRI steps, alternating periods of linearly increasing and decreasing PRI step patterns, a repeating pattern of monotonically increasing PRI steps, a repeating pattern of monotonically decreasing PRI steps, or alternating periods of monotonically increasing and decreasing PRI step patterns. Also, periods where the stepped PRI modulation pattern is stopped may be inserted into the abovementioned patterns.

Using the type of PRI modulation waveform described in FIG. 14C, target information may be calculated from the IF signals shown in FIGS. 11A-D, FIGS. 15A-B, FIGS. 16A-D, and FIGS. 17A-B, in the following way. Peaks in the IF signal spectrum represent target returns. The frequency of the target peaks is proportional to target range and is used to calculate target range. As an example, not meant in any way as a limitation, let the radar arrangement of FIG. 11A transmit a single sideband, upper sideband radar signal and utilize a linearly increasing PRI step sequence and linearly decreasing PRI step sequence as shown in FIG. 14C. Let the IF signal be measured during each coherent measurement interval T_{P}, which for this example also corresponds to the PRI increasing step sequence period and decreasing step sequence period. Under these conditions, target range can be calculated by the following equation:

$$R = \frac{c \cdot {T}_{S} \cdot {Δτ}_{PRI}}{4} \cdot ( {f}_{PU} + {f}_{PD} ) \qquad ( 4 )$$

where R is the calculated target range, c is the speed of light in a vacuum, T_{S} is dwell time of each PRI step, □□_{PRI} is the difference between adjacent PRI step values in the linear step sequence, and f_{PU} and f_{PD} are the beat frequencies in the IF signal corresponding to measurements during the PRI increasing sequence and PRI decreasing sequence periods T_{P} respectively.

The Doppler frequency shift of the target frequency peaks is used to calculate target velocity. As an example, not meant in any way as a limitation, let the radar arrangement of FIG. 11A transmit a single sideband, upper sideband radar signal and utilize a linearly increasing PRI step sequence and linearly decreasing PRI step sequence as shown in FIG. 14C. Let the IF signal be measured during each coherent measurement interval T_{P}, which for this example also corresponds to the PRI increasing step sequence period and decreasing step sequence period. Under these conditions, target relative velocity can be calculated by the following equation:

$$V = \frac{c}{4 {f}_{C} + 2 / {τ}_{PR11} + 2 / {τ}_{PR12}} \cdot ( {f}_{PU} - {f}_{PD} ) \qquad ( 5 )$$

where V is the calculated target relative velocity defined as positive for an approaching target, c is the speed of light in a vacuum, f_{C} is the frequency of the transmit oscillator 255, □_{PRI1} and □_{PRI2} are the minimum and maximum PRI values in the linear sequence during a coherent measurement period T_{P}, and f_{PU} and f_{PD} are the beat frequencies in the IF signal corresponding to the measurements during the PRI up step sequence and down step sequence periods T_{P} respectively.

If a plurality of receiver channels are used, or sequentially switched between and IF signals measured, then amplitude of the target peaks can be measured across the corresponding IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse method.

An alternate approach to calculating target range is to use an inverse FFT or inverse DFT, after sampling the IF signal using an A/D converter, to build a target range profile. The peaks in the IFFT or IDFT profile represent target returns with range proportional to the peak's associated time bin.

FIG. 14D illustrates a stepped PRI modulation waveform for use in the modulation signal generator 230 according to aspects of the present invention. This waveform comprises multiple linearly stepped PRI patterns of varying slopes □□_{PR1}/T_{S}. The waveform shown is an example of linearly stepped PRI modulation, and is not meant as a restriction. The waveform can also consist of, but is not limited to, a repeating combination of multiple monotonically increasing or decreasing PRI step sequences of various slopes. Also, periods where the stepped PRI modulation pattern is stopped may be inserted into the abovementioned patterns.

Using the type of PRI modulation waveform described in FIG. 14D, target information may be calculated from the IF signals shown in FIGS. 11A-D, FIGS. 15A-B, FIGS. 16A-D, and FIGS. 17A-B in a way similar to that described for use with the waveform of FIG. 14C. Peaks in the IF signal spectrum represent target returns. The frequency of the target peaks is proportional to target range and is used to calculate target range. The Doppler frequency shift of the target frequency peaks is used to calculate target relative velocity. One benefit of the use of multiple slopes of stepped PRI waveforms is that this assists in the removal of false or ghost targets in the processing, and aids in the resolution of the range-velocity ambiguity.

An alternate approach to calculating target range is to use an inverse FFT or inverse DFT, after sampling the IF signal using an AID converter, to build a target range profile. The peaks in the IFFT or IDFT profile represent target returns with range proportional to the peak's associated time bin.

FIG. 14E illustrates a stepped PRI modulation waveform for use in the modulation signal generator 230 according to aspects of the present-invention. This waveform is comprised of multiple linearly stepped PRI patterns intertwined. The individual stepped PRI patterns can have multiple slopes □□_{PR1}/T_{S} as described in FIG. 14D, be increasing, or decreasing. The intertwined waveform can also comprise, but is not limited to, an intertwined pattern of monotonically increasing or decreasing PRI stepped patterns of various slopes □□_{PR1}/T_{S}. Also, periods where the stepped PRI modulation pattern is stopped may be inserted into the abovementioned patterns. Furthermore, the intertwined waveform may consist of one or a plurality of linearly stepped PRI patterns where the order of each pattern's PRI steps is randomized according to a predetermined order. Then after reception, the A/D samples of the IF signals are correctly associated with their corresponding transmit pattern and re-ordered to be linear prior to being subjected to a Fourier transform or inverse Fourier transform processing, such as an FFT, DFT, IFFT, or IDFT.

Using the type of stepped PRI pattern described in FIG. 14E, target information may be calculated from the IF signals shown in FIGS. 11A-D, FIGS. 15A-B, FIGS. 16A-D, and FIGS. 17A-B in a manner similar to that as described for the frequency-hopping pattern of FIG. 14C, with the exception that A/D samples of the IF signal must be correctly associated with their corresponding pattern A, B, or C and de-intertwined before spectral processing such as, but not limited to, a Fourier transform or inverse Fourier transform. Techniques for accomplishing this are well known to persons skilled in the art.

FIG. 14F illustrates a stepped PRI modulation waveform for use in the modulation signal generator 230 according to aspects of the present invention. This waveform comprises two linearly stepped PRI patterns A and B, in which both patterns have an equal number of PRI steps and the same slope □□_{PR1}/T_{S}, but pattern B has a fixed PRI shift with respect to pattern A. That PRI shift is shown as □□_{SHIFT}. This waveform may repeat after a pre-determined number of steps in patterns A and B have been completed. Also, periods where the stepped PRI pattern is stopped may be inserted into the abovementioned patterns. Furthermore, the waveform shown in FIG. 14F is meant as an example, and is not meant as a restriction. One skilled in the art can modify the abovementioned waveform in a way such as using non-equal PRI step sizes, using more than two patterns, or using patterns that have different step sizes from each other, in order to obtain advantageous results for an application.

Using the type of stepped PRI pattern described in FIG. 14F, target information may be calculated from the IF signals shown in FIGS. 11A-D, FIGS. 15A-B, FIGS. 16A-D, and FIGS. 17A-B in the following manner. As an example, not meant in any way as a limitation, let the IF signal be sampled once per each PRI step dwell time Ts for each sequence A and B separately, and let the IF samples be associated with each sequence A and B separately for processing. Peaks in the IF signal spectrum represent target returns. The frequency of the target peaks is ambiguous in target range and velocity, as shown in the following equation:

$$K = \frac{2 \cdot V \cdot {T}_{P}}{λ} - \frac{2 \cdot R \cdot ( 1 / {τ}_{A MIN} - 1 / {τ}_{A MAX} )}{c} \qquad ( 6 )$$

where K is the frequency bin index integer of the Fourier transform spectrum normalized with respect to frequency, V is the target relative velocity, □ is the wavelength, T_{P} is the coherent measurement period during which the IF signal is sampled for one Fourier transform, R is the target range, c is the speed of light in a vacuum, and □_{A}_{_{—}}_{MIN} and □_{A}_{_{—}}_{MAX} are the minimum and maximum values of PRI of pattern A during a coherent measurement period T_{P}. The phase of the target frequency peaks in the complex spectrum of the IF signals for sequence A and sequence B, denoted by □_{A} and □_{B} respectively, can be measured and this phase difference □□□□_{B}□_{A} can be used to resolve the range and velocity ambiguity, using in the following equation in combination with equation (6):

$$ΔΨ = \frac{2 π \cdot V \cdot {T}_{P}}{λ \cdot ( N - 1 )} - \frac{4 π \cdot R}{c \cdot {Δτ}_{SHIFT}} \qquad ( 7 )$$

where K is the frequency bin index integer of the Fourier transform spectrum normalized with respect to frequency, V is the target relative velocity, □ is the wavelength, T_{P} is the measurement period over which the IF is sampled for one Fourier transform, R is the target range, c is the speed of light in a vacuum, N is the number of frequency steps in each pattern A and B, and □□_{SHIFT} is the PRI shift between sequence A and B. The above equations (6) and (7) can be used together to resolve the range-velocity ambiguity.

If a plurality of receiver channels are used, or sequentially switched between and IF signals measured, then amplitude of the target peaks can be measured across the corresponding IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse method.

FIG. 14G illustrates a stepped PRI modulation waveform for use in the modulation signal generator 230 according to aspects of the present invention. This waveform comprises a randomized, pseudo-random, or pseudo-noise pattern containing a plurality of PRI value steps. In one embodiment, the phase of the down-converted IF signal is used for range calculation. The phase of the target frequency peaks in the complex spectrum of the IF signals for adjacent PRI steps can be compared and this phase difference □□□□_{FIRST}□_{SECOND} can be calculated, where □_{SECOND} refers to the phase measurement of the second or later of the two PRI steps and □_{FIRST} refers to the phase measurement of the first of the two PRI steps. Under these conditions, the target range can be determined as shown by the following equation:

$$R = \frac{c \cdot ΔΨ \cdot {Δτ}_{PRI}}{4 π} \qquad ( 8 )$$

where R is the target range, c is the speed of light in a vacuum, □□ is the measured phase difference of the target spectral peaks of the IF signal sampled and Fourier transformed during each frequency step dwell time T_{S}, and □□_{PRI} is the PRI time difference between adjacent PRI steps used for the range measurement. In another embodiment, the waveform of FIG. 14G consists of one or more linearly or monotonically stepped PRI patterns where the order of the PRI steps of each pattern is randomized according to a predetermined order. Then after reception, the A/D samples of the IF signal are correctly associated with each pattern and re-ordered to be in the original linear or monotonic sequence prior to the application of at least one signal processing function such as, but not limited to, a Fourier transform or inverse Fourier transform. Under these conditions, the range and relative velocity can be calculated using equations (4) and (5), with T_{S}, a □□_{PRI}, f_{PU}, f_{PD}, □_{PRI1}, □_{PRI2} relating to the re-ordered sequence and measurements made on the re-ordered sequence.

FIG. 15A illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 15A is similar to the arrangement in FIG. 11A except for the addition of phase shifter 237, attenuator 250, and summing block 218. The same components are denoted by the same reference numerals, and will not be explained again. The output of transmit oscillator 255 is input to phase shifter 237, which then feeds attenuator 250, and then sums the resulting signal with the modulated signal to be transmitted. One purpose of this arrangement is to reduce or suppress the residual CW carrier that can be present after modulation by modulator 221. As an alternate embodiment of the present invention, the quadrature down-conversion receiver method shown in FIG. 16A can be applied to this arrangement to create quadrature IF signals.

FIG. 15B illustrates a pulsed radar transmitter-receiver arrangement as another embodiment of radar transmitter-receiver 200 and as another embodiment of pulsed radar transmitter-receiver with pulse compression 199 according to aspects of the present invention. The arrangement in FIG. 15B is similar to the arrangement in FIG. 11B, except for the addition of phase shifter 237, attenuator 250, and summing block 218. The same components are denoted by the same reference numerals, and will not be explained again. The output of transmit oscillator 255 is input to phase shifter 237, which then feeds attenuator 250, and then sums the resulting signal with the modulated signal to be transmitted. One purpose of this arrangement is to reduce or suppress the residual CW carrier that can be present after modulation by modulator 221. As an alternate embodiment of the present invention, the quadrature down-conversion receiver method shown in FIG. 16B can be applied to this arrangement to create quadrature IF signals.

FIG. 16A illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 16A is similar to the arrangement in FIG. 11A except that the receiver channel uses quadrature down-conversion to create quadrature IF signals. The same components are denoted by the same reference numerals, and will not be explained again. The output signal of filter 225 is split and feeds mixers 273a and 273b. The output signal of inverter 281 feeds mixer 273a, and also feeds the 90 degree phase shifter 274. The output of the 90 degree phase shifter 274 feeds mixer 273b. The outputs of mixers 273a, 273b feed filters 290a, 290b and the resulting signals are intermediate frequency (IF) quadrature signals containing target range, velocity, and phase information. Mixers 273a-b can be implemented by, but are not limited to, mixers, multipliers, or switches. Filters 290a-b may be implemented by, but are not limited to, low-pass filters. Filter 212 can be used to pass only an upper or lower sideband signal for transmission, or filter 212 can be removed resulting in a double sideband transmitted signal. The inverter 281 can be removed, resulting in a direct connection from modulation signal generator 230 to the inputs of the 90 degree phase shifter 274, and mixer 273a without departing from the present invention. Furthermore, the signal feeding the input of the 90 degree phase shifter 274 and mixer 273a can be filtered prior to those input connections without departing from the present invention.

FIG. 16B illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 16B is similar to the arrangement in FIG. 16A except for the addition of modulator 260. The same components are denoted by the same reference numerals, and will not be explained again. The modulator 260 modulates the received signal prior to the down-converter mixer 270. Modulator 260 can be implemented by, but is not limited to, a switch which gates the receiver channel, effectively blanking the receiver when the transmit signal pulse is on, and passing energy to the receiver when the transmit signal pulse is off. This can help to reduce transmit signal leakage to the receiver and increase the dynamic range of the receiver.

FIG. 16C illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 16C is similar to the arrangement in FIG. 11C except for use of quadrature down-conversion mixers 282, 283, the 90 degree phase shifter 274, and filters 290a, 290b. The same components are denoted by the same reference numerals, and will not be explained again. This arrangement outputs quadrature IF signals from the output of the filters 290a, 290b. Filters 290a, 290b can be implemented by, but are not limited to, low-pass filters or band-pass filters. Mixers 282,283 can be implemented by, but are not limited to, mixers or multipliers. Filter 212 can be used to pass only an upper or lower sideband signal for transmission, or filter 212 can be removed resulting in a double sideband transmitted signal. The inverter 281 can be removed, resulting in a direct connection from modulation signal generator 230 to the inputs of the 90 degree phase shifter 274, mixer 282, and modulator 260 without departing from the present invention. Furthermore, the signal feeding the input of the 90 degree phase shifter 274 and mixer 282 can be filtered prior to those input connections without departing from the present invention.

FIG. 16D illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 16D is similar to the arrangement in FIG. 16C except for the removal of modulator 260. The same components are denoted by the same reference numerals, and will not be explained again. This arrangement is a simpler structure compared to that of FIG. 16C. The removal of receiver gating makes the arrangement more compact and potentially lower cost.

FIG. 17A illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 17A is similar to the arrangement in FIG. 11A except for the removal of filter 212, and the addition of 90-degree phase shifters 228, 229, modulator 214, and summation block 297. The same components are denoted by the same reference numerals, and will not be explained again. The output signal of transmit oscillator 255 is fed to 90-degree phase shifter 229 and modulator 214. The output of 90-degree phase shifter 229 is fed to modulator 221. The output of modulation signal generator 230 is fed to the input of 90-degree phase shifter 228 and to the modulator 214 control port. The output of 90-degree phase shifter 228 feeds the control port of modulator 221. The outputs of modulators 221 and 214 are fed into the summation block 297, which then outputs the single sideband signal for transmission. The circuit modifications noted above constitute a methodology to transmit a single-sideband, lower-sideband signal. The circuitry can easily be modified by one skilled in the art to transmit single-sideband, upper-sideband, but remains still within the scope of this invention. Also, a filter can be added to the output of this arrangement without departing from the spirit of the present invention. Furthermore, the quadrature down-conversion receiver method shown in FIG. 16A can be applied to this arrangement to create quadrature IF signals as an alternate embodiment of the present invention.

FIG. 17B illustrates a pulsed radar transmitter-receiver arrangement as one embodiment of radar transmitter-receiver 200 and as one embodiment of pulsed radar transmitter-receiver with pulse compression 199 according to aspects of the present invention. The arrangement in FIG. 17B is similar to the arrangement in FIG. 17A except for the addition of modulator 260. The same components are denoted by the same reference numerals and will not be explained again. The modulator 260 modulates the received signal prior to the down-converter mixer 270. Modulator 260 may be implemented by, but is not limited to, a switch which gates the receiver channel, effectively blanking the receiver when the transmit signal pulse is on, and passing energy to the receiver when the transmit signal pulse is off. This can help to reduce transmit signal leakage to the receiver and increase the dynamic range of the receiver. As an alternate embodiment of the present invention, the quadrature down-conversion receiver method shown in FIG. 16B can be applied to this arrangement to create quadrature IF signals.

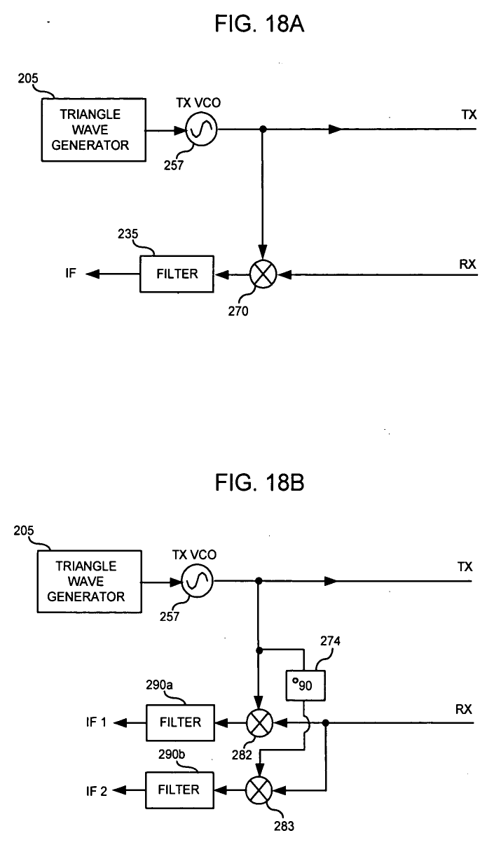

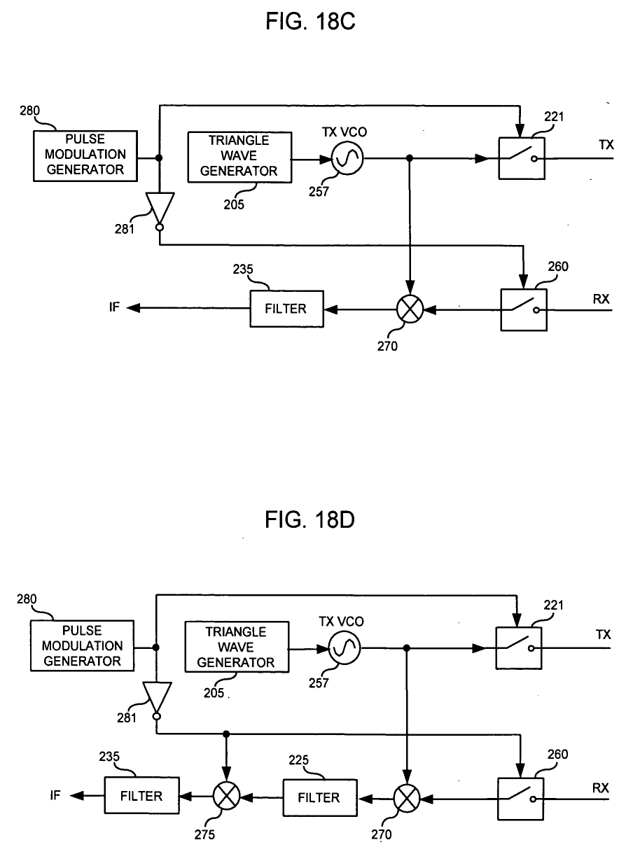

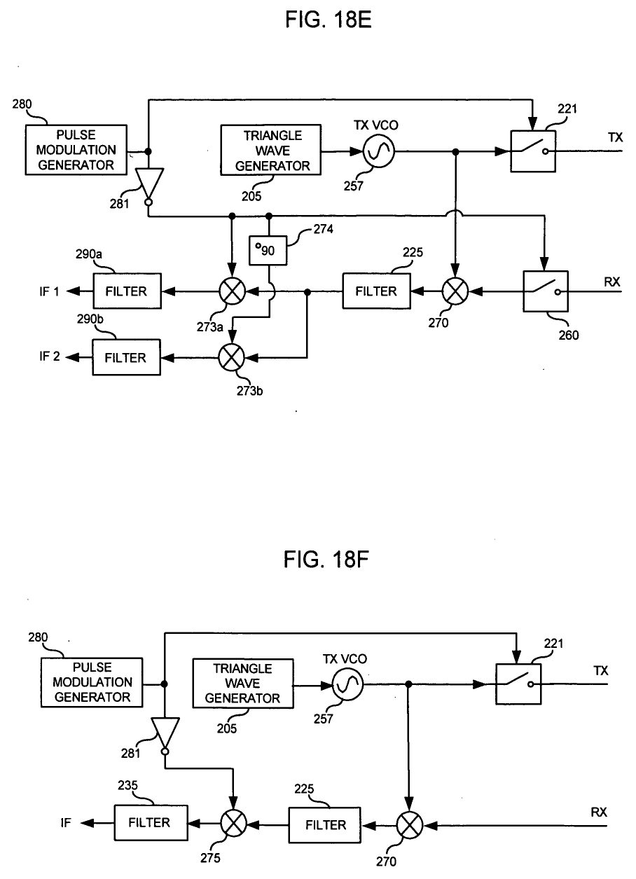

An FMCW transmitter-receiver arrangement is illustrated in FIG. 18A as one embodiment of radar transmitter-receiver 200. In this arrangement, triangle wave generator 205 outputs a modulation signal modulates the frequency of transmit VCO 257. The modulation signal output from triangle wave generator 205 is such that the frequency output of transmit VCO 257 is continuously linearly or monotonically increased or decreased over predetermined time intervals, can contain multiple slopes of □ frequency versus □ time, and can contain blanking periods where the frequency modulation is stopped. The triangle wave generator may contain circuitry such as a phase-locked loop, phase-frequency locked loop, direct digital synthesizer, linearization circuitry, frequency dividers, or frequency multipliers. Furthermore, the output of VCO 257 can additionally be split, and one of the split signals can be fed back to the triangle wave generator block for the purposes of linearizing or increasing the modulation accuracy of the frequency output of VCO 257. The output signal from the transmit VCO 257 is then sent for transmission. The received signal is fed to down-converting 270, where the signal is mixed with the output of transmit VCO 257. The output from mixer 270 is then filtered by filter 235 and the resulting signal is an intermediate frequency (IF) signal containing target information. Filter 235 can be implemented by, but is not limited to, a low-pass filter or band-pass filter. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

Peaks in the IF signal spectrum represent target returns. The frequency of the target peaks is proportional to target range, and is used to calculate target range. As an example, not meant in any way as a limitation, let the radar arrangement of FIG. 18A utilize a linear up chirp and down chirp frequency modulation waveform with the frequency up ramp time equal to the down ramp time equal to the IF signal coherent measurement period T_{P}. Under these conditions, the target range can be calculated by the following equation:

$$R = \frac{c \cdot {T}_{P}}{4 \cdot Δ {f}_{BW}} \cdot ( {f}_{U} + {f}_{D} ) \qquad ( 9 )$$

where R is the calculated target range, c is the speed of light in a vacuum, □f_{BW} is the total frequency modulation excursion of the chirp waveform during the ramp time T, and f_{U} and f_{D} are the beat frequencies in the IF signal corresponding to the measurements during the up chirp period T_{P} and down chirp period T_{P} respectively.

The Doppler frequency shift of the target frequency peaks is used to calculate target velocity. As an example, not meant in any way as a limitation, let the radar arrangement of FIG. 18A utilize a linear up chirp and down chirp frequency modulation with the frequency up ramp time equal to the down ramp time equal to the IF signal coherent measurement period T_{P}. Under these conditions, the target relative velocity can be calculated by the following equation:

$$V = \frac{c \cdot ( {f}_{D} - {f}_{U} )}{4 \cdot {f}_{0}} \qquad ( 10 )$$

where V is the calculated target relative velocity defined as positive for an approaching target, c is the speed of light in a vacuum, f₀ is the average frequency of the transmitted modulated radar wave during a coherent measurement period T_{P}, and f_{U} and f_{D} are the beat frequencies in the IF signal corresponding to the measurements during the up chirp period T_{P} and down chirp period T_{P} respectively.

If a plurality of receiver channels are used, or sequentially switched between and the IF signals measured, the target peaks can be measured across the IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse direction-finding method.

FIG. 18B illustrates a pulsed FMCW radar transmitter-receiver arrangement as another embodiment of radar transmitter-receiver 200 and as another embodiment of pulsed radar transmitter-receiver with pulse compression 199 according to aspects of the present invention. The arrangement in FIG. 18B is similar to the arrangement in FIG. 18A except for the implementation of a quadrature receiver down-converter by replacing mixer 270 and filter 225, with mixers 282, 283 and filters 290a, 290b as well as the addition of a 90 degree phase shifter 274. The same components are denoted by the same reference numerals, and will not be explained again. In this arrangement, the output of transmit VCO 257 feeds the 90 degree phase shifter 274 as well as mixer 282. The output of the 90 degree phase shifter 274 feeds mixer 283. The receiver channel is split and feeds mixers 282 and 283 as shown. The output signals from mixers 282, 283 are then filtered by filters 290a, 290b and the resulting signals are quadrature intermediate frequency (IF) signals containing target information. Target information may be calculated from the IF signals in a manner similar to that as described for the FMCW arrangement of FIG. 18A.

FIG. 18C illustrates a pulsed FMCW radar transmitter-receiver arrangement as a further embodiment of radar transmitter-receiver 200 and as a further embodiment of pulsed radar transmitter-receiver with pulse compression 199 according to aspects of the present invention. The arrangement in FIG. 18C is similar to the arrangement in FIG. 18A except for the addition of pulse modulation generator 280, modulators 221, 260 and inverter 281. The same components are denoted by the same reference numerals and will not be explained again. In this arrangement, pulse modulation generator 280 outputs a modulation signal which is fed to the modulation port of modulator 221 and to the input of inverter 281. The modulator 221 modulates the signal from the transmit oscillator 257 according to the modulation pattern from pulse modulation generator 280. The output signal from the modulator 221 is then sent for transmission. The received signal is fed to modulator 260. The output signal from modulator 260 is fed to down-converting mixer 270, where the signal is mixed with the output of transmit VCO 257. The output signals from mixer 270 is then filtered by filter 235 and the resulting signal is an intermediate frequency (IF) signal containing target information. The inverter 281 can be removed and replaced with a direct connection as an option. The modulator 221 can be implemented by, but is not limited to, a pulse modulator, amplitude modulator, bi-phase shift keyed modulator, phase modulator, switch, mixer, or AND gate. Modulator 260 may be implemented by, but is not limited to, a switch which gates the receiver channel, effectively blanking the receiver when the transmit signal pulse is on, and passing energy to the receiver when the transmit signal pulse is off. This can help to reduce transmit signal leakage to the receiver and increase the dynamic range of the receiver. Target information may be calculated from the IF signal in a manner similar to that as described for the FMCW arrangement of FIG. 18A.

FIG. 18D illustrates a pulsed FMCW radar transmitter-receiver arrangement as a yet further embodiment of radar transmitter-receiver 200 and as a yet further embodiment of pulsed radar transmitter-receiver with pulse compression 199 according to aspects of the present invention. The arrangement in FIG. 18D is similar to the arrangement in FIG. 18C except for the addition of filter 225 and mixer 275. The same components are denoted by the same reference numerals and will not be explained again. In this arrangement, the output signal from mixer 270 is fed to filter 225, and the resulting signal is fed to mixer 275, where it is mixed with the output signal from inverter 281. The signal from inverter 281 feeding mixer 275 can be additionally filtered or re-inverted prior to being connected to mixer 275 without departing from the spirit of the present invention. Target information may be calculated from the IF signal in a manner similar to that as described for the FMCW arrangement of FIG. 18A.

FIG. 18E illustrates a pulsed FMCW radar transmitter-receiver arrangement as another embodiment of radar transmitter-receiver 200 and as another embodiment of pulsed radar transmitter-receiver with pulse compression 199 according to aspects of the present invention. The arrangement in FIG. 18E is similar to the arrangement in FIG. 18D except for the implementation of a quadrature receiver down-converter by replacing mixer 275 and filter 235 with mixers 273a, 273b and filters 290a, 290b, as well as the addition of a 90 degree phase shifter 274. The same components are denoted by the same reference numerals and will not be explained again. In this arrangement, the output of inverter 281 feeds the 90 degree phase shifter 274 as well as mixer 273a. The output of the 90 degree phase shifter 274 feeds mixer 273b. The output from filter 225 is split. The output from filter 225 feeds mixers 273a and 273b as shown. The output signals from mixers 273a, 273b are then filtered by filters 290a, 290b and the resulting signals are quadrature intermediate frequency (IF) signals containing target information. The signal from inverter 281 feeding mixer 273a and 90 degree phase shifter 274 can be additionally filtered or re-inverted prior to being connected to those inputs without departing from the spirit of the present invention. Target information may be calculated from the IF signals in a manner similar to that as described for the FMCW arrangement of FIG. 18A.

FIG. 18F illustrates a pulsed FMCW radar transmitter-receiver arrangement as a further embodiment of radar transmitter-receiver 200 and as a further embodiment of pulsed radar transmitter-receiver with pulse compression 199 according to aspects of the present invention. The arrangement in FIG. 18F is similar to the arrangement in FIG. 18D except for the removal of modulator 260. Furthermore, the quadrature down-conversion receiver method shown in FIG. 18E can be applied to this arrangement to create quadrature IF signals as an alternate embodiment of the present invention. Target information may be calculated from the IF signals in a manner similar to that as described for the FMCW arrangement of FIG. 18A.

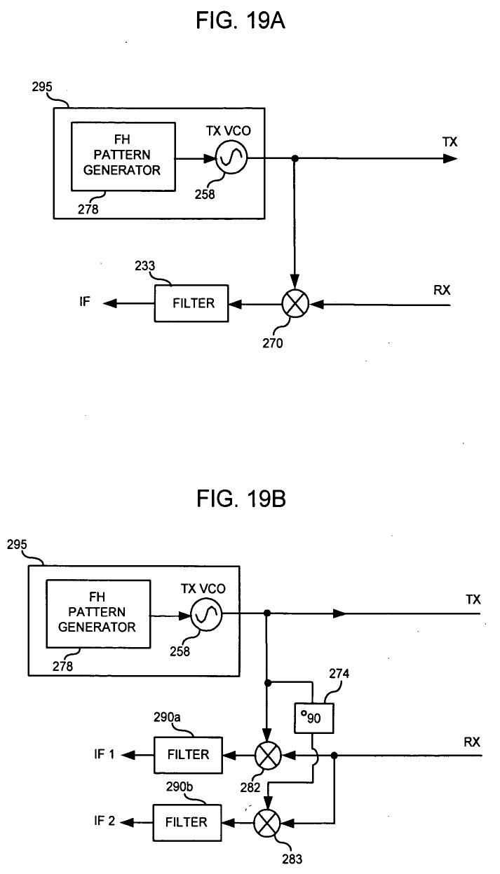

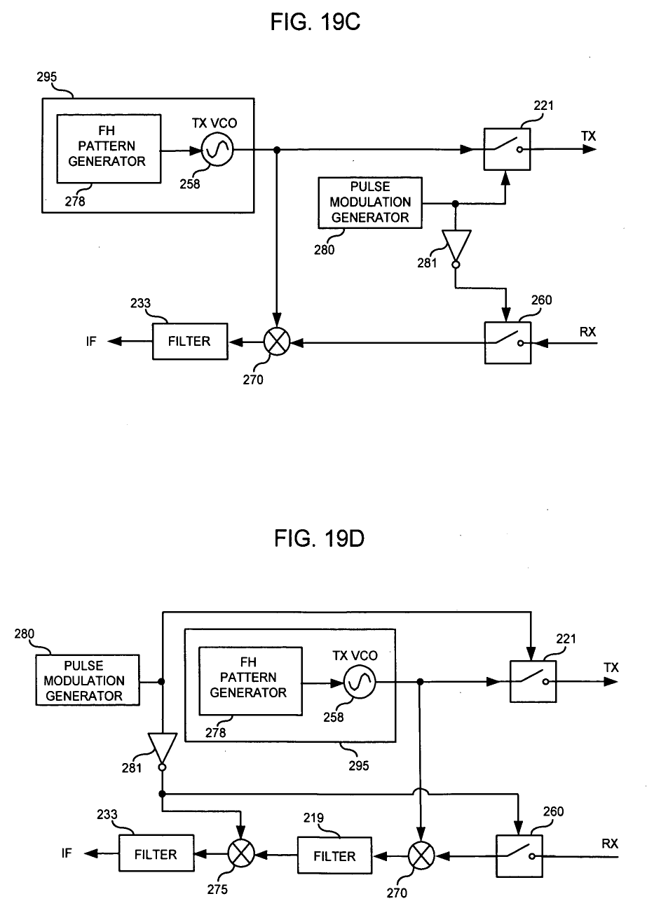

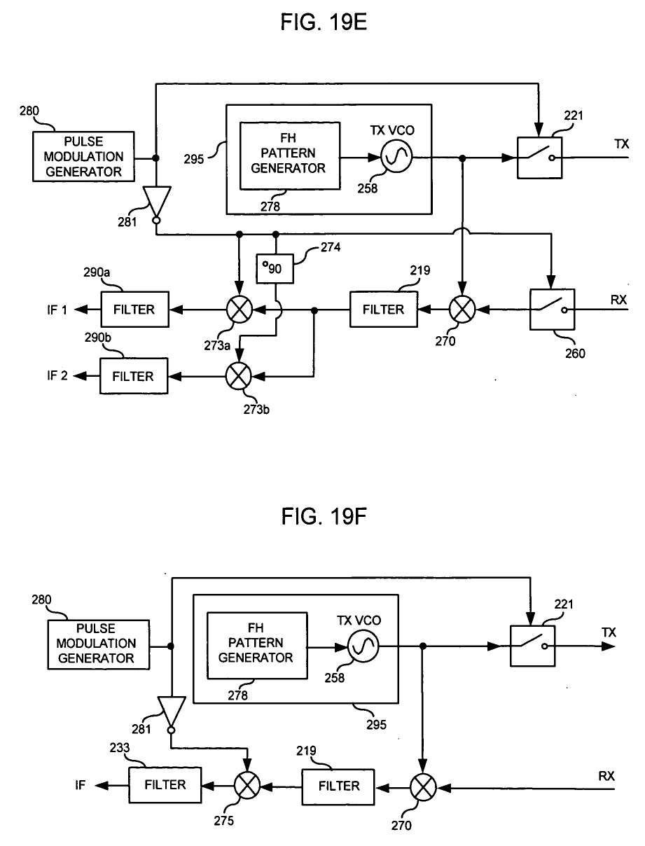

A frequency-hopping transmitter-receiver arrangement is illustrated in FIG. 19A as one embodiment of radar transmitter-receiver 200. In this arrangement, a frequency-hopping signal generator 295 outputs a signal for transmission. One embodiment of frequency-hopping signal generator 295 consists of a frequency-hopping pattern generator 278 which controls the output frequency of a transmit VCO 258. The output signal from the frequency-hopping signal generator 295 is such that its frequency hops or steps across a predetermined pattern of frequencies, each frequency hop or step remaining static for a predetermined period of time. The received signal is fed to down-converting mixer 270, where the signal is mixed with the output signal of frequency-hopping signal generator 295. The output signal from mixer 270 is then filtered by filter 233 and the resulting signal is an intermediate frequency (IF) signal containing target information. Filter 233 may be implemented by, but is not limited to, a low-pass filter. The frequency-hopping pattern of frequency-hopping signal generator 295 can include, but is not limited to, a pseudo-random pattern such as with a PRBS, a pseudo-noise pattern, a randomized pattern, a linearly or monotonically stepped pattern, an intertwined pattern consisting of a plurality of linearly or monotonically stepped patterns, an intertwined pattern consisting of a plurality of the abovementioned patterns, or any combination of the abovementioned patterns. Mixer 270 may be implemented by, but is not limited to, a mixer, multiplier, or switch. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

FIG. 19B shows a frequency-hopping transmitter-receiver arrangement as another embodiment of radar transmitter-receiver 200. The arrangement in FIG. 19B is similar to the arrangement in FIG. 19A except for the implementation of quadrature receiver down-converter by replacing mixer 270 and filter 233 with mixers 282, 283 and filters 290a, 290b, as well as the addition of a 90 degree phase shifter 274. The same components are denoted by the same reference numerals and will not be explained again. In this arrangement, the output of frequency-hopping signal generator 295 feeds the 90 degree phase shifter 274 as well as mixer 282. The output of the 90 degree phase shifter 274 feeds mixer 283. The receiver channel is split. The receiver channel feeds mixers 282 and 283 as shown. The output signals from mixers 282, 283 are then filtered by filters 290a, 290b and the resulting signals are quadrature intermediate frequency (IF) signals containing target information.

FIG. 19C illustrates a pulsed frequency-hopping radar transmitter-receiver arrangement as a further embodiment of radar transmitter-receiver 200 and as a further embodiment of pulsed radar transmitter-receiver with pulse compression 199 according to aspects of the present invention. The arrangement in FIG. 19C is similar to the arrangement in FIG. 19A except for the addition of pulse modulation generator 280, modulators 221, 260, and inverter 281. The same components are denoted by the same reference numerals, and will not be explained again. In this arrangement, pulse modulation generator 280 outputs a modulation signal which is fed to the modulation port of modulator 221 and to the input of inverter 281. The modulator 221 modulates the signal from the frequency-hopping signal generator 295 according to the modulation pattern from pulse modulation generator 280. The output signal from the modulator 221 is then sent for transmission. The received signal is fed to modulator 260. The output signal from modulator 260 is fed to down-converting mixer 270, where the signal is mixed with the output of frequency-hopping signal generator 295. The output signal from mixer 270 is then filtered by filter 233 and the resulting signal is an intermediate frequency (IF) signal containing target information. The inverter 281 can be removed and replaced with a direct connection as an option. The modulator 221 can be implemented by, but is not limited to, a pulse modulator, amplitude modulator, bi-phase shift keyed modulator, phase modulator, switch, mixer, or AND gate. Modulator 260 may be implemented by, but is not limited to, a switch which gates the receiver channel, effectively blanking the receiver when the transmit signal pulse is on, and passing energy to the receiver when the transmit signal pulse is off. This can help to reduce transmit signal leakage to the receiver and increase the dynamic range of the receiver. As an alternate embodiment of the present invention, the modulator 260 can be removed from the arrangement shown in FIG. 19C such that the received signal is input directly to mixer 270.

FIG. 19D illustrates a pulsed frequency-hopping radar transmitter-receiver arrangement as a yet further embodiment of radar transmitter-receiver 200 and as a yet further embodiment of pulsed radar transmitter-receiver with pulse compression 199 according to aspects of the present invention. The arrangement in FIG. 19D is similar to the arrangement in FIG. 19C except for the addition of filter 219 and mixer 275. The same components are denoted by the same reference numerals, and will not be explained again. In this arrangement, the output signal from mixer 270 is fed to filter 219, and the resulting signal is fed to mixer 275, where it is mixed with the output signal from inverter 281. The signal from inverter 281 feeding mixer 275 can be additionally filtered or re-inverted prior to being connected to mixer 275 without departing from the spirit of the present invention.

FIG. 19E illustrates a pulsed frequency-hopping radar transmitter-receiver arrangement as another embodiment of radar transmitter-receiver 200 and as another embodiment of pulsed radar transmitter-receiver with pulse compression 199 according to aspects of the present invention. The arrangement in FIG. 19E is similar to the arrangement in FIG. 19D except for the implementation of quadrature receiver down-converter by replacing mixer 275 and filters 233 with mixers 273a, 273b and filters 290a, 290b, as well as the addition of a 90 degree phase shifter 274. The same components are denoted by the same reference numerals and will not be explained again. In this arrangement, the output of inverter 281 feeds the 90 degree phase shifter 274 as well as mixer 273a. The output of the 90 degree phase shifter feeds mixer 273b. The outputs from filter 219 is split. The output from filter 219 feeds mixers 273a and 273b as shown. The output signals from mixers 273a, 273b are then filtered by filters 290a, 290b and the resulting signals are quadrature intermediate frequency (IF) signals containing target information. The signal from inverter 281 feeding mixer 273a and 90 degree phase shifter 274 can be additionally filtered or re-inverted prior to being connected to those inputs without departing from the spirit of the present invention.

FIG. 19F illustrates a pulsed frequency-hopping radar transmitter-receiver arrangement as a further embodiment of radar transmitter-receiver 200 and as a further embodiment of pulsed radar transmitter-receiver with pulse compression 199 according to aspects of the present invention. The arrangement in FIG. 19F is similar to the arrangement in FIG. 19D except for the removal of modulator 260. Furthermore, the quadrature down-conversion receiver method shown in FIG. 19E can be applied to this arrangement to create quadrature IF signals as an alternate embodiment of the present invention.

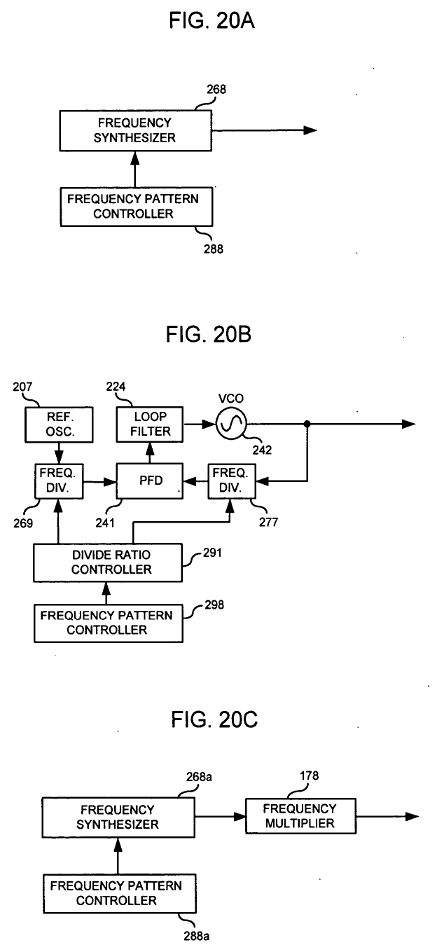

One embodiment of the frequency-hopping signal generator 295 is shown in FIG. 20A. This arrangement can also be used a one embodiment of modulation signal generator 230. A frequency pattern controller 288 controls a frequency synthesizer 268. The output of frequency synthesizer 268 will be a signal whose frequency hops or steps according to the pattern and timing dictated by the frequency pattern controller 288.

Another embodiment of the frequency-hopping signal generator 295 is shown in FIG. 20B. This arrangement can also be used as another embodiment of modulation signal generator 230. A frequency pattern controller 298 is input to a divide ratio controller 291 which controls the divide ratios of frequency dividers 277, 269. The frequency dividers 277, 269 can be implemented by counters without departing from the scope or spirit of the present invention. A reference oscillator 207 provides a reference signal of a predetermined frequency to the input of frequency divider 269. The output of VCO 242 is split and one of the split signals is input to frequency divider 277. The output of frequency divider 277 and the output of frequency divider 269 are both input to phase-frequency detector 241. The output of phase frequency detector 241 is filtered by loop filter 224 and is input to the frequency control port of VCO 242. The output of VCO 242 will be a signal whose frequency hops or steps according to the pattern and timing dictated by the frequency pattern controller 298.

A further embodiment of the frequency-hopping signal generator 295 is shown in FIG. 20C. This arrangement can also be used as a further embodiment of modulation signal generator 230. A frequency pattern controller 288a controls a frequency synthesizer 268a. The output of frequency synthesizer 268a will be a signal whose frequency hops or steps according to the pattern and timing dictated by the frequency pattern controller 288a. The output of the frequency synthesizer 268a is input to a frequency multiplier 178, which multiplies the frequency of the signal accordingly. The frequency multiplier can be, but is not limited to, a doubler, a tripler, or a quadrupler.

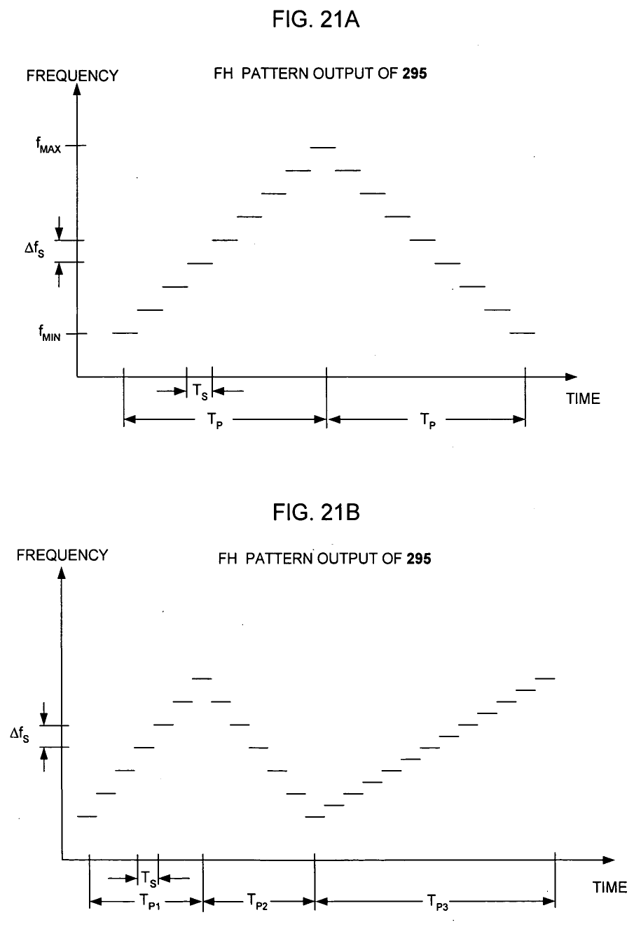

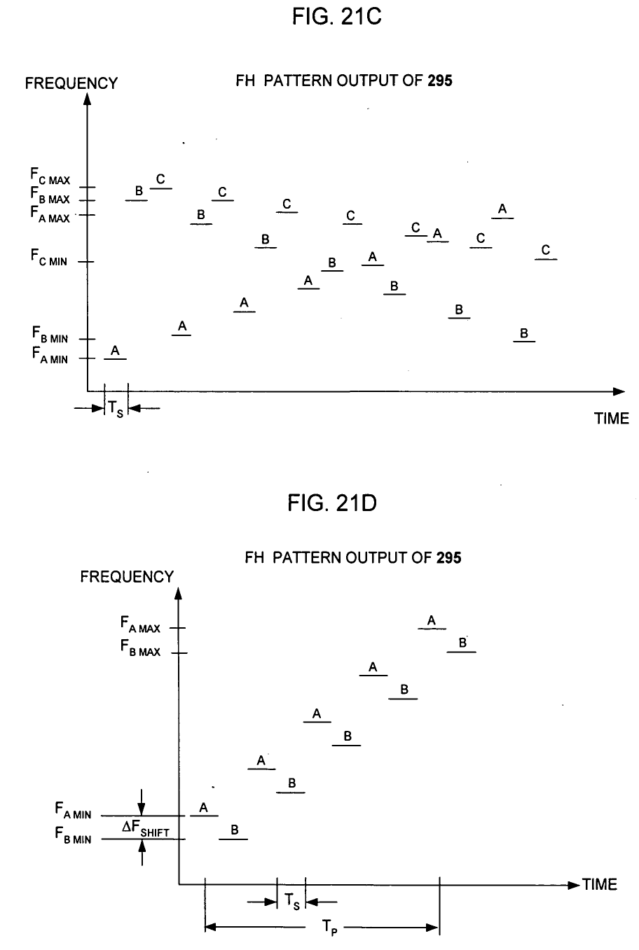

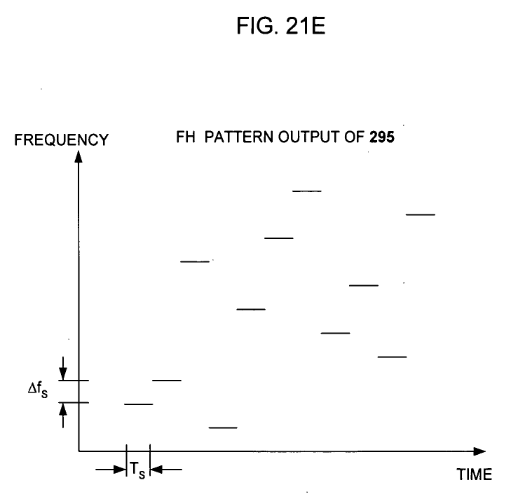

FIG. 21A illustrates one frequency-hopping pattern for use in the frequency-hopping signal generator 295 according to aspects of the present invention. This waveform shows a linear frequency-stepped pattern during a time period T_{P}. This waveform shown is an example of linear frequency-stepped modulation, and is not meant as a restriction. The waveform can also comprise, but is not limited to, a repeating pattern of linearly increasing frequency steps, a repeating pattern of linearly decreasing frequency steps, alternating periods of linearly increasing and decreasing frequency step patterns, a repeating pattern of monotonically increasing frequency steps, a repeating pattern of monotonically decreasing frequency steps, or alternating periods of monotonically increasing and decreasing frequency step patterns. Also, periods where the stepped frequency modulation pattern is stopped may be inserted into the abovementioned patterns.

Using the type of frequency-hopping pattern described in FIG. 21A, target information may be calculated from the IF signals shown in FIGS. 19A-F, in the following way. Peaks in the IF signal spectrum represent target returns. The frequency of the target peaks is proportional to target range and is used to calculate target range. As an example, not meant in any way as a limitation, let the radar arrangement of FIG. 19A utilize a linear up frequency step sequence and down frequency step sequence as shown in FIG. 21A, and let the IF signal be measured during each coherent measurement period T_{P}. Under these conditions, the target range can be calculated using the following equation:

$$R = \frac{c \cdot {T}_{S}}{4 \cdot Δ {f}_{S}} \cdot ( {f}_{U} + {f}_{D} ) \qquad ( 11 )$$

where R is the calculated target range, c is the speed of light in a vacuum, T_{S} is dwell time of each frequency step, □f_{S} is the frequency difference between adjacent steps in the linear frequency step sequence, and f_{U} and f_{D} are the beat frequencies in the IF signal corresponding to the measurements during the up step sequence period T_{P} and down step sequence period T_{P} respectively.

The Doppler frequency shift of the target frequency peaks is used to calculate target velocity. As an example, not meant in any way as a limitation, let the radar arrangement of FIG. 19A utilize a linear up frequency step sequence and down frequency step sequence as shown in FIG. 21A, and let the IF signal be measured during each coherent measurement period T_{P}. Under these conditions, the target relative velocity can be calculated by the following equation:

$$V = \frac{c}{2 \cdot ( {f}_{MIN} + {f}_{MAX} )} \cdot ( {f}_{D} - {f}_{U} ) \qquad ( 12 )$$

where V is the calculated target relative velocity defined as positive for an approaching target, c is the speed of light in a vacuum, f_{MIN} and f_{MAX} are the minimum and maximum frequency steps in the linear sequence during a coherent measurement period T_{P}, and f_{U} and f_{D} are the beat frequencies in the IF signal corresponding to the measurements during the up step sequence period T_{P} and down step sequence period T_{P} respectively.

If a plurality of receiver channels are used, or sequentially switched between and the IF signals measured, the target peaks can be measured across the IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse direction-finding method.

An alternate approach to calculating target range is to use an inverse FFT or inverse DFT, after sampling the IF signals using an A/D converter, to build a target range profile. The peaks in the IFFT or IDFT profile represent target returns with range proportional to the peak's associated time bin.

FIG. 21B shows a frequency-hopping pattern for use in the frequency-hopping signal generator 295 according to aspects of the present invention. This waveform comprises multiple linear-frequency stepped patterns of varying slopes □frequency/□time. The waveform shown is an example of linear frequency-stepped modulation, and is not meant as a restriction. The waveform can also consist of, but is not limited to, a repeating combination of multiple monotonically increasing or decreasing frequency step patterns of various slopes. Also, periods where the stepped frequency modulation pattern is stopped may be inserted into the abovementioned patterns.

Using the type of frequency-hopping pattern described in FIG. 21B, target information may be calculated from the IF signals shown in FIGS. 19A-F, in a way similar to that described for use with the waveform of FIG. 21A. Peaks in the IF signal spectrum represent target returns. The frequency of the target peaks is proportional to target range and is used to calculate target range. The Doppler frequency shift of the target frequency peaks is used to calculate target velocity. The use of multiple slopes of stepped patterns assists in the removal of false or ghost targets in the processing, and aids in the resolution of the range-velocity ambiguity. If a plurality of receiver channels are used, or sequentially switched between and the IF signals measured, the target peaks can be measured across the IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse direction-finding method.

An alternate approach to calculating target range is to use an inverse FFT or inverse DFT, after sampling the IF signals using an A/D converter, to build a target range profile. The peaks in the IFFT or IDFT profile represent target returns with range proportional to the peak's associated time bin.

FIG. 21C shows a frequency-hopping pattern for use in the frequency-hopping signal generator 295 according to aspects of the present invention. This waveform is comprised of multiple linear frequency-stepped patterns intertwined. The individual frequency-stepped patterns can have multiple slopes, be increasing, or decreasing. The intertwined waveform can also comprise, but is not limited to, an intertwined pattern of monotonically increasing or decreasing frequency step patterns of various slopes. Also, periods where the stepped frequency modulation pattern is stopped may be inserted into the abovementioned patterns. Furthermore, the intertwined waveform may consist of one or a plurality of linear frequency stepped patterns where the order of each pattern's steps is randomized according to a predetermined order. Then after reception, the A/D samples of the IF signals are correctly associated with their corresponding transmit pattern and re-ordered to be linear prior to being subjected to a Fourier transform or inverse Fourier transform processing, such as an FFT, DFT, IFFT, or IDFT.

Using the type of frequency-hopping pattern described in FIG. 21C, target information may be calculated from the IF signals shown in FIGS. 19A-F, in a manner similar to that as described for the frequency-hopping pattern of FIG. 21A, with the exception that A/D samples of the IF signals must be correctly associated with their corresponding pattern A, B, or C and de-intertwined before spectral processing such as, but not limited to, a Fourier transform or inverse Fourier transform. Techniques for accomplishing this are well known to persons skilled in the art.

FIG. 21D shows a frequency-hopping pattern for use in the frequency-hopping signal generator 295 as a yet further embodiment of the present invention. This waveform comprises two linear frequency-stepped patterns A and B, in which both patterns have an equal number of frequency steps and the same slope □f_{S}/T_{S}, but pattern B has a fixed frequency shift offset with respect to pattern A. That frequency shift offset is shown as □F_{SHIFT}. This waveform may repeat after a pre-determined number of steps in patterns A and B have been completed. Also, periods where the stepped frequency modulation pattern is stopped may be inserted into the abovementioned patterns. Furthermore, the waveform shown in FIG. 21D is meant as an example, and is not meant as a restriction. One skilled in the art can modify the abovementioned waveform in a way such as using non-equal frequency step sizes, using more than two patterns, or using patterns that have different step sizes from each other, in order to obtain advantageous results for an application.

Using the type of frequency-hopping pattern described in FIG. 21D, target information may be calculated from the IF signals shown in FIGS. 19A-F, in the following manner. As an example, not meant in any way as a limitation, let the IF signal be sampled once per each frequency step dwell time Ts for each sequence A and B separately, and let the IF samples be associated with each sequence A and B separately for processing. Peaks in the IF signal spectrum represent target returns. The frequency of the target peaks is ambiguous in target range and relative velocity, as shown in the following equation:

$$K = \frac{2 \cdot V \cdot {T}_{P}}{λ} - \frac{2 \cdot R \cdot ( {F}_{A MAX} - {F}_{A MIN} )}{c} \qquad ( 13 )$$

where K is the frequency bin index integer of the Fourier transform spectrum normalized with respect to frequency, V is the target relative velocity, □ is the wavelength, T_{P} is the coherent measurement period during which the IF signal is sampled for one Fourier transform, R is the target range, c is the speed of light in a vacuum, and F_{A MAX}−F_{A MIN} is the total frequency excursion of pattern A. The phase of the target frequency peaks in the complex spectrum of the IF signals for sequence A and sequence B, denoted by □_{A} and □_{B} respectively, can be measured and this phase difference □□□□_{B}□_{A} can be used to resolve the range and velocity ambiguity, using in the following equation in combination with equation (13):

$$ΔΨ = \frac{2 π \cdot V \cdot {T}_{P}}{λ \cdot ( N - 1 )} - \frac{4 π \cdot R \cdot Δ {F}_{SHIFT}}{c} \qquad ( 14 )$$

where K is the frequency bin index integer of the Fourier transform spectrum normalized with respect to frequency, V is the target relative velocity, □ is the wavelength, T_{P} is the measurement period over which the IF is sampled for one Fourier transform, R is the target range, c is the speed of light in a vacuum, N is the number of frequency steps in each pattern A and B, and □F_{SHIFT} is the frequency shift offset between sequence A and B. The above equations (13) and (14) can be used together to resolve the range-velocity ambiguity.

If a plurality of receiver channels are used, or sequentially switched between and the IF signals measured, the target peaks can be measured across the IF signals and used to calculate target direction angle using the amplitude-comparison monopulse direction-finding method. The frequency of the target peaks, containing fine range information, can be measured across the IF signals and used to calculate target direction angle using the multilateration direction-finding method. The phase of the target frequency peaks in the spectrum can be compared across the IF signals and used to calculate target direction angle using the phase-comparison monopulse direction-finding method.

FIG. 21E shows a frequency-hopping pattern for use in the frequency-hopping signal generator 295 as a yet further embodiment of the present invention. This waveform comprises a randomized, pseudo-random, or pseudo-noise pattern containing a plurality of frequency value steps. In one embodiment, the phase of the down-converted IF signal is used for range calculation. The phase of the target frequency peaks in the complex spectrum of the IF signal is measured and Fourier transformed during each step dwell time Ts for adjacent frequency steps can be compared and this phase difference □□□□_{FIRST}□_{SECOND} can be calculated, where □_{SECOND} refers to the phase measurement corresponding to the second or later of the two frequency steps and □_{FIRST} refers to the phase measurement corresponding to the first of the two frequency steps. Under these conditions, the target range can be determined as shown by the following equation:

$$R = \frac{c \cdot ΔΨ}{4 \cdot π \cdot Δ f} \qquad ( 15 )$$

where R is the target range, c is the speed of light in a vacuum, and □f is the frequency difference between adjacent frequency steps used for the range measurement, defined as □f=f_{SECOND}−f_{FIRST} where f_{SECOND} corresponds to the second or later frequency step of the pair and f_{FIRST} corresponds to the first frequency step of the pair.

In another embodiment, the waveform of FIG. 21E consists of one or more linearly or monotonically frequency stepped patterns where the order of the frequency steps of each pattern is randomized according to a predetermined order. Then after reception, the A/D samples of the IF signal are correctly associated with each pattern and re-ordered to be in a linear or monotonic sequence prior to the application of at least one signal processing function such as, but not, limited to, a Fourier transform or inverse Fourier transform. The range and relative velocity can then be calculated using equations (11) and (12), with T_{S}, □f_{S}, f_{U}, f_{D}, f_{MIN} and f_{MAX} relating to the re-ordered sequence and measurements made on the re-ordered sequence.

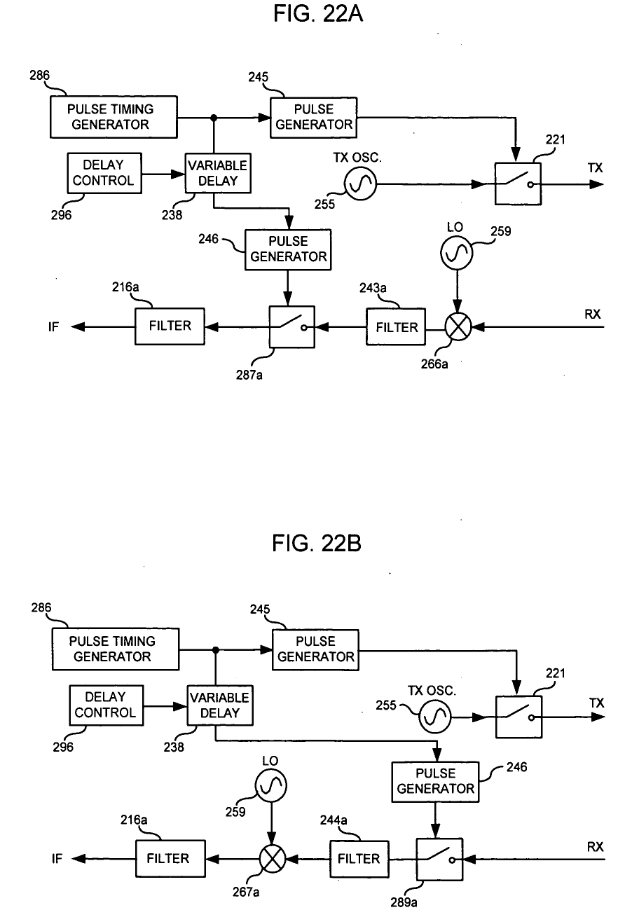

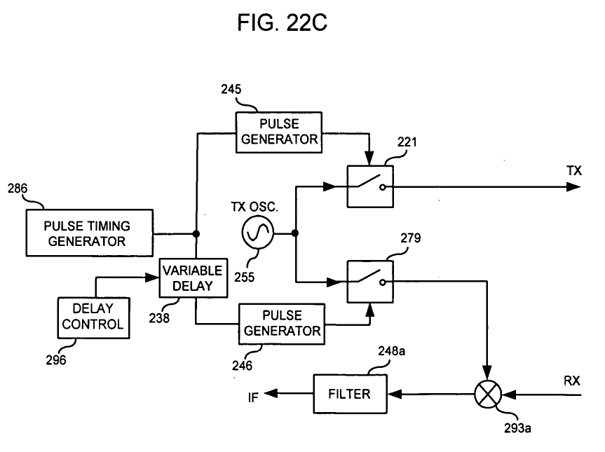

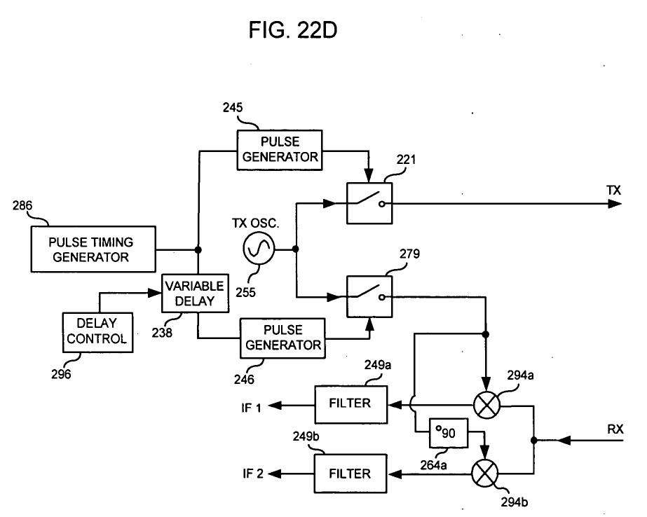

A pulsed radar transmitter-receiver arrangement is illustrated in FIG. 22A as one embodiment of radar transmitter-receiver 200. In this arrangement, a pulse timing generator 286 outputs a timing signal to a pulse generator 245 and variable delay 238. The delay value of variable delay 238 is controlled by delay control 296. The output of the variable delay 238 is input to a pulse generator 246. The output of pulse generators 245, 246 can comprise, but is not limited to, a pseudo-random pulse pattern, a pulse-position modulated pattern, a PRBS pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 245. The output signal from pulse modulator 221 is then sent for transmission. A local oscillator 259 inputs a CW signal to mixer 266a where it is mixed with the received signal. The outputs from mixer 266a is filtered by filter 243a then input to range gate 287a. After range gating, the signal is then filtered by filter 216a and the resulting signal is an intermediate frequency (IF) signal containing target information. The modulator 221 can be implemented by, but is not limited to, a pulse modulator, amplitude modulator, bi-phase shift keyed modulator, phase modulator, switch, mixer, or AND gate. Filter 243a can be implemented by, but is not limited to, a band-pass filter. Filter 216a can be implemented by, but is not limited to, a low-pass filter. Mixer 266a can be implemented by, but is not limited to, a mixer, multiplier, or switch without changing the basic functionality of the arrangement. Range gate 287a can be implemented by, but is not limited to, a switch, sampler, detector, mixer, or multiplier without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention. Furthermore, the arrangement shown in FIG. 22A can be modified by one skilled in the art such that the receiver channel is down-convert in quadrature, outputting quadrature IF signals, without changing the basic form or spirit of the invention.

Using the radar arrangement illustrated in FIG. 22A, one method for determining target range, not meant in any way as a limitation, is to vary or sweep the time delay of variable delay 238, and to threshold detect the IF signal during this process. Peaks in the detected power or envelope of the IF signal that exceed a predetermined threshold represent target returns. When a target peak in the IF is detected, the corresponding value of the time delay of variable delay 238 is proportional to the target's range, and is used to calculate target range using the following equation:

$$R = \frac{c \cdot {T}_{D}}{2} \qquad ( 16 )$$

where R is the calculated target range, c is the speed of light in a vacuum, and T_{D} is the value of the time delay of variable delay 238 at the time a target peak in the IF is detected. One way the target's relative velocity can be determined is through calculation from successive target range measurements over predetermined time intervals. The difference in range measured over a time interval can give an estimation of the target's relative velocity.

A pulsed radar transmitter-receiver arrangement is illustrated in FIG. 22B as another embodiment of radar transmitter-receiver 200. In this arrangement, a pulse timing generator 286 outputs a timing signal to a pulse generator 245 and variable delay 238. The delay value of variable delay 238 is controlled by delay control 296. The output of the variable delay 238 is input to a pulse generator 246. The output of pulse generators 245, 246 can comprise, but is not limited to, a pseudo-random pulse pattern, a pulse-position modulated pattern, a PRBS pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 245. The output signal from pulse modulator 221 is then sent for transmission. The output signal from pulse generator 246 is input to range gates 289a, 289b where it gates the received signals. The output from range gate 289a is filtered by filter 244a then input to mixer 267a. After mixing, the signal is then filtered by filter 216a and the resulting signal is an intermediate frequency (IF) signal containing target information. The modulator 221 can be implemented by, but is not limited to, a pulse modulator, amplitude modulator, bi-phase shift keyed modulator, phase modulator, switch, mixer, or AND gate. Filter 244a can be implemented by, but is not limited to, a band-pass filters. Filter 216a can be implemented by, but is not limited to, a low-pass filters. Mixer 267a can be implemented by, but is not limited to, a mixer, multiplier, or switch without changing the basic functionality of the arrangement. Range gate 289a can be implemented by, but is not limited to, a switch, sampler, detector, mixer, or multiplier without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention. Furthermore, the arrangement shown in FIG. 22B can be modified by one skilled in the art such that the receiver channel down-converts in quadrature, outputting quadrature IF signals, without changing the basic form or spirit of the invention.

Using the radar arrangement illustrated in FIG. 22B, one method for determining target range, not meant in any way as a limitation, is to vary or sweep the time delay of variable delay 238, and to threshold detect the IF signal during this process. Peaks in the detected power or envelope of the IF signal that exceed a predetermined threshold represent target returns. When a target peak in the IF is detected, the corresponding value of the time delay of variable delay 238 is proportional to the target's range, and is used to calculate target range using equation (16). One way the target's relative velocity can be determined is through calculation from successive target range measurements over predetermined time intervals. The difference in range measured over a time interval can give an estimation of the target's relative velocity.

A pulsed radar transmitter-receiver arrangement is illustrated in FIG. 22C as a further embodiment of radar transmitter-receiver 200. In this arrangement, a pulse timing generator 286 outputs a timing signal to a pulse generator 245 and variable delay 238. The delay value of variable delay 238 is controlled by delay control 296. The output of the variable delay 238 is input to a pulse generator 246. The output of pulse generators 245, 246 can comprise, but is not limited to, a pseudo-random pulse pattern, a pulse-position modulated pattern, a PRBS pulse pattern, a pseudo-noise pulse pattern, a randomized pulse pattern, a channelized pulse pattern, a pattern with pulse amplitudes according to a predetermined code, a pattern with pulse positions according to a predetermined code, or a pattern with a pulse repetition frequency (PRF) according to a predetermined value. A transmit oscillator 255 outputs a continuous wave (CW) signal to a pulse modulator 221 whose pulse modulation of the CW signal is controlled by the pulsed signal from pulse generator 245. The output signal from pulse modulator 221 is then sent for transmission. The output signal from pulse generator 246 is input to pulse modulator 279 where it pulse modulates the CW signal from oscillator 255. The output signal from pulse modulator 279 is input to mixer 293a where it mixes with the received signal. The output from mixer 293a is filtered by filter 248a and the resulting signal is an intermediate frequency (IF) signal containing target information. The modulators 221, 279 can each be implemented by, but are not limited to, a pulse modulator, amplitude modulator, bi-phase shift keyed modulator, phase modulator, switch, mixer, or AND gate. Filter 248a can be implemented by, but is not limited to, a low-pass filter. Mixer 293a can be implemented by, but is not limited to, a mixer, multiplier, switch, sampler, detector, or correlator without changing the basic functionality of the arrangement. All amplifiers and gain blocks have been omitted from the arrangement for clarity, without the intention of limiting the scope of the arrangement or invention in any way. A variety of amplifiers or other system elements known to those skilled in the art, such as low-noise amplifiers, power amplifiers, drivers, buffers, gain blocks, gain equalizers, logarithmic amplifiers, equalizing amplifiers, and the like, can be added to the described arrangement without changing the basic form or spirit of the invention.

FIG. 22D illustrates a pulsed transmitter-receiver arrangement as a yet further embodiment of radar transmitter-receiver 200. The arrangement in FIG. 22D is similar to the arrangement in FIG. 22C except for the implementation of a quadrature receiver down-converter by replacing mixer 293a and filters 248a with mixers 294a, 294b and filters 249a, 249b, as well as the addition of 90 degree phase shifter 264a. The same components are-denoted by the same reference numerals, and will not be explained again. In this arrangement, the output of pulse modulator 279 feeds the 90 degree phase shifter 264a as well as mixer 294a. The receiver channel is split and feeds mixers 294a, 294b as shown. The output signals from mixers 294a, 294b are then filtered by filters 249a, 249b and the resulting signals are quadrature intermediate frequency (IF) signals containing target information.

One method for determining target range for the radar arrangements in FIGS. 22C-D, not meant in any way as a limitation, is to vary or sweep the time delay of variable delay 238, and to threshold detect the IF signal during this process. Peaks in the detected power or envelope of the IF signal that exceed a predetermined threshold represent target returns. This occurs when the correlation is high between the delayed pulse pattern output of pulse generator 246 and the reflected pulse pattern from a target. When a target peak in the IF is detected, the corresponding value of the time delay of variable delay 238 is proportional to the target's range, and is used to calculate target range using equation (16), where R is the calculated target range, c is the speed of light in a vacuum, and T_{D} is the value of the time delay of variable delay 238 at the time a target peak in the IF is detected. One way the target's relative velocity can be determined is through calculation from successive target range measurements over predetermined time intervals. The difference in range measured over a time interval can give an estimation of the target's relative velocity.

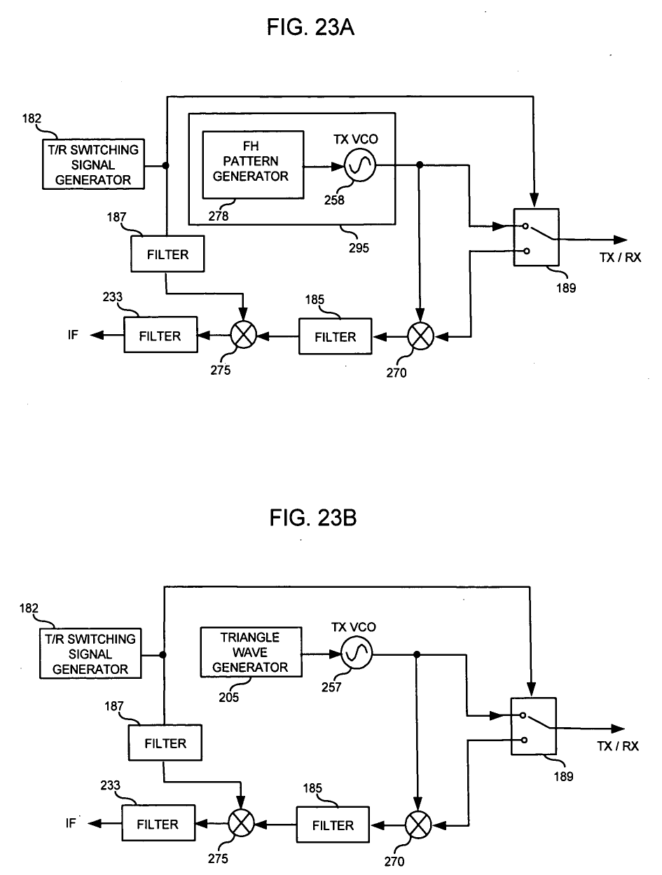

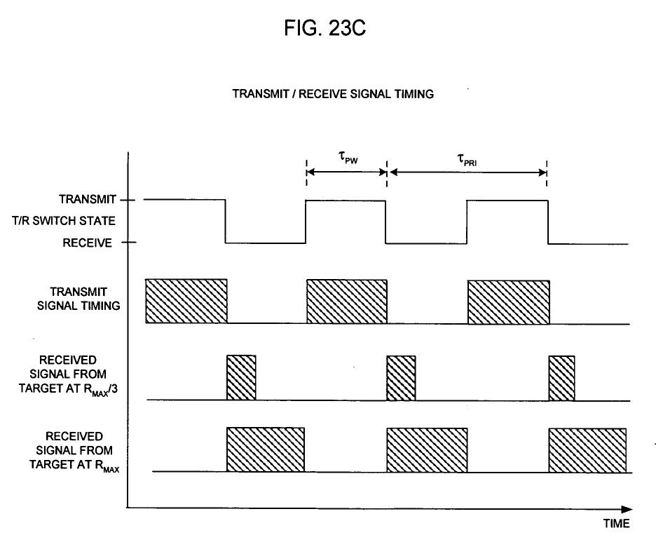

FIG. 23A shows a pulsed frequency-hopping transmitter-receiver arrangement as one embodiment of radar transmitter-receiver 200 and one embodiment of pulsed radar transmitter-receiver with pulse compression means 199. The arrangement in FIG. 23A is similar to the arrangement in FIG. 19D except that separate switches 221 and 260 have been replaced by a single T/R switch 189, the pulse modulation generator 280 has been replaced by a T/R switching signal generator 182, the inverter 281 has been removed, and a filter 187 has been added between the T/R switching signal generator 182 and the mixer 275. The same components are denoted by the same reference numerals, and will not be explained again. The filter 187 can be implemented by, but is not limited to, a band-pass or low-pass filter. Also, the filter 187 can be removed and replaced by a direct connection without departing from the spirit of the present invention. In this configuration, the transmitter and receiver do not simultaneously transmit and receive, which can help improve receiver dynamic range by blanking the transmit signal during reception periods. Also, by setting the transmit and receive periods to be equal, and equal to the two-way signal transit time of the maximum desired target detection range, the signal-to-noise ratio of a target at that maximum detection range will be optimized for this configuration. Furthermore, the use of the second down-conversion mixer stage 275, which mixes the received signal by the T/R switch timing signal, can improve the SNR of the radar system by reducing the noise impact of the first mixer 270 and oscillator 258, since the radar signal IF for processing is down-converted from a T/R switch frequency sideband rather than the fundamental homodyne signal.

FIG. 23B shows a pulsed FMCW transmitter-receiver arrangement as one embodiment of radar transmitter-receiver 200 and as one embodiment of pulsed radar transmitter-receiver with pulse compression means 199. The arrangement in FIG. 23B is similar to the arrangement in FIG. 18D except that separate switches 221 and 260 have been replaced by a single T/R switch 189, the pulse modulation generator 280 has been replaced by a T/R switching signal generator 182, the inverter 281 has been removed, and a filter 187 has been added between the T/R switching signal generator 182 and the mixer 275. The same components are denoted by the same reference numerals, and will not be explained again. The filter 187 can be implemented by, but is not limited to, a band-pass or low-pass filter. Also, the filter 187 can be removed and replaced by a direct connection without departing from the spirit of the present invention. In this configuration, the transmitter and receiver do not simultaneously transmit and receive, which can help improve receiver dynamic range by blanking the transmit signal during reception periods. Also, by setting the transmit and receive periods to be equal, and equal to the two-way signal transit time of the maximum desired target detection range, the signal-to-noise ratio (SNR) of a target at that maximum detection range will be optimized for this configuration. Furthermore, the use of the second down-conversion mixer stage 275, which mixes the received signal by the T/R switch timing signal, can improve the SNR of the radar system by reducing the noise impact of the first mixer 270 and oscillator 257, since the radar signal IF for processing is down-converted from a T/R switch frequency sideband rather than the fundamental homodyne signal. The architectural modifications illustrated here and in FIG. 23A can be used to similarly modify the arrangements in FIGS. 11B, 15B, 16B, 17B, 18E, and 19E as embodiments of the present invention.

FIG. 23C shows one example of transmit and receive signal timing associated with the radar arrangement in FIG. 23A in accordance with aspects of the present invention. Signal timing shown is for illustrative purposes only, and is not meant as a limitation. The top signal in FIG. 23C shows the output signal from T/R switching signal generator 182 where □_{PW} is the transmit pulse width, and □_{PRI} is the pulse repetition interval. For this example, the transmit and receive times are equal and equal to the two-way signal transit time of the maximum desired target detection range denoted by R_{MAX}. The second signal from the top in FIG. 23C shows the transmit signal timing. This illustrates that the transmit signal is off, or blanked, while the radar is in signal receive mode. Note, the vertical axis in FIG. 23C is only used to denote a state, such as transmit or receive, or signal present or not for the purpose of illustrating timing, and does not represent magnitude of signal energy. The third signal from the top in FIG. 23C shows the received signal timing from a target at a distance of R_{MAX}/3. Note that the signal energy from the target is only present for a fraction of the total receive time period. This is due to the fact that the timing of T/R switching is set to maximize received energy from a target at R_{MAX}, where SNR typically is most critical. The bottom signal in FIG. 23C shows received signal timing from a target at a distance of R_{MAX}. Note that the signal energy from the target is present during the entire receive time period, which maximizes received energy and SNR for a target at R_{MAX}. The reduction in the fraction of time a received signal is present in the receiver for a target closer than R_{MAX} can have a benefit. SNR is typically not a limiting factor in detecting close targets, but large energy returns from close targets can stress the dynamic range of the radar system and make it difficult to simultaneously detect targets farther away. In this arrangement, the closer a target is to the radar at distances less than RMAX, the less the fraction of time the signal will be present in the receiver, which helps to equalize and partially compensate for the difference in signal strengths for targets of equal radar cross section (RCS) at different ranges.

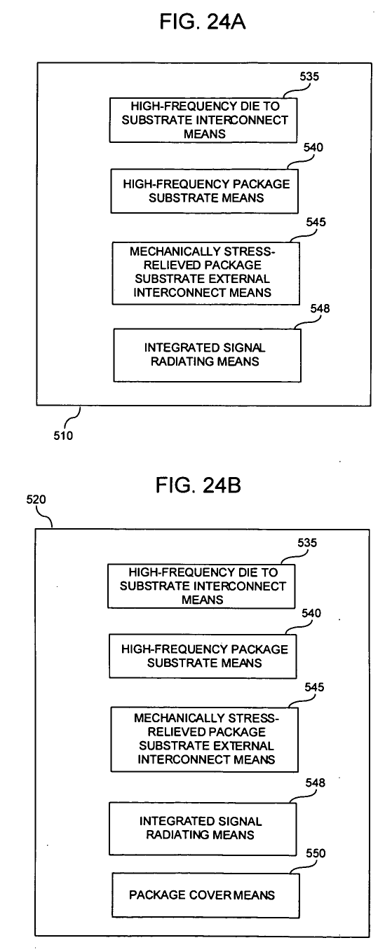

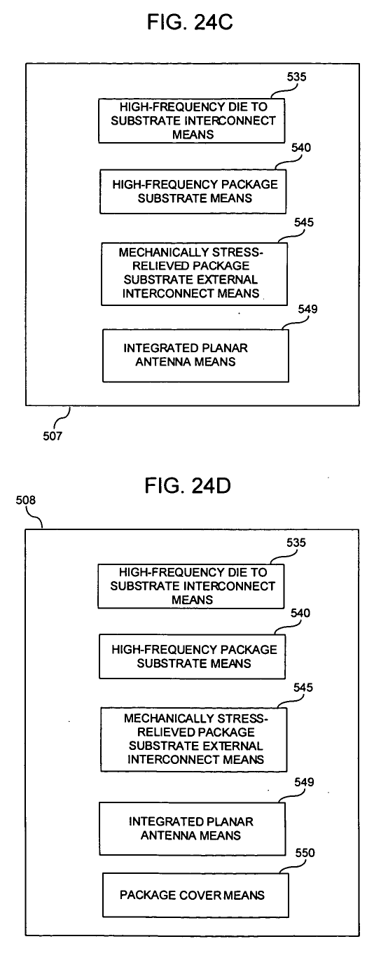

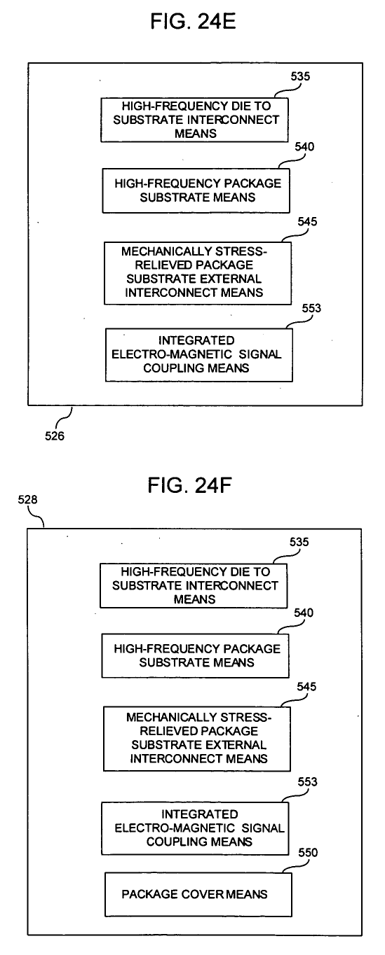

One embodiment of the generalized diagram shown in FIG. 24A illustrates the features of an integrated circuit packaging means 510 for radar applications containing an integrated signal radiating means, and capable of packaging one or a plurality of integrated circuit die containing at least one high-frequency signal port in a low-cost, mass-production capable unit, in accordance with aspects of the present invention. The aforementioned term “high-frequency” refers to a frequency greater than or equal to 5 GHz, such as, but not limited to, 76 GHz. An integrated circuit die is connected to a high-frequency package substrate means 540 using a high-frequency die to substrate interconnect means 535. An integrated circuit die can comprise, but is not limited to, a silicon circuit die containing a plurality of transistors, a silicon-germanium circuit die containing a plurality of transistors, a gallium-arsenide circuit die containing a plurality of transistors, an indium-phosphide circuit die containing a plurality of transistors, or an InGaP circuit die containing a plurality of transistors. The high-frequency die to substrate interconnect means 535 can comprise, but is not limited to, epoxy die attach, solder die attach, flip-chip, or wire-bonding. The high-frequency package substrate means 540 can comprise, but is not limited to, a ceramic single or multilayer substrate, a laminate single or multilayer substrate, a low temperature co-fired ceramic (LTCC) single or multilayer substrate, a high temperature co-fired ceramic (HTCC) single or multilayer substrate, a high thermal coefficient of expansion (HiTCE) LTCC single or multilayer substrate, or a plastic single or multilayer substrate. The substrate metallization can comprise, but is not limited to, thick-film metallization, thin-film metallization, plated metallization, electro-deposited metallization, rolled metallization, or laminated metallization. The substrate vias can comprise, but are not limited to, filled vias, plated vias, non-filled vias, through vias, partial vias, or blind vias. The high frequency package substrate means 540 is connected to an external circuit by way of a mechanically stress-relieved package substrate external interconnect means 545. The mechanically stress-relieved package substrate external interconnect means 545 can comprise, but is not limited to, metal leads which can be formed into stress-relieving forms such as gull-wing or j-lead shapes, vertical pins such as in a ceramic dual-in-line arrangement (CERDIP), brazed pin area arrays such as pin-grid-array (PGA) arrangements, or soldered flexible wires or flexible ribbons from the package substrate to the external circuit means such as a circuit board. The high-frequency package substrate means 540 contains high-frequency signal radiating means 548. The high-frequency signal radiating means 548 can comprise, but is not limited to, planar antennas, patch antennas, slot antennas, quasi-yagi antennas, electromagnetic coupling ports, waveguide coupling ports, coaxial coupling ports, or arrays or combinations of planar antennas or coupling ports.

One embodiment of the generalized diagram shown in FIG. 24B illustrates the features of an integrated circuit packaging means 520 for radar applications containing an integrated signal radiating means, and capable of packaging one or a plurality of integrated circuit die containing at least one high-frequency signal port in a low-cost, mass-production capable unit, in accordance with aspects of the present invention. The aforementioned term “high-frequency” refers to a frequency greater than or equal to 5 GHz, such as, but not limited to, 76 GHz. The arrangement illustrated in FIG. 24B is similar to the arrangement of FIG. 24A except for the addition of a package cover means 550. The same components are denoted by the same reference numerals, and will not be explained again. The package cover means 550 can be used for, but is not limited to, physical protection of the integrated circuit die, handling or marking purposes, or thermal heat extraction from the package. The package cover means 550 construction material can comprise, but is not limited to, metal or metal alloy, ceramic, laminate, thermo-plastic, or plastic.

One embodiment of the generalized diagram shown in FIG. 24C illustrates the features of an integrated circuit packaging means 507 for radar applications containing an integrated planar antenna means, and capable of packaging one or a plurality of integrated circuit die containing at least one high-frequency signal port in a low-cost, mass-production capable unit, in accordance with aspects of the present invention. The aforementioned term “high-frequency” refers to a frequency greater than or equal to 5 GHz, such as, but not limited to, 76 GHz. The arrangement illustrated in FIG. 24C is similar to the arrangement of FIG. 24A except that the integrated signal radiating means 548 has been replaced by specifically an integrated planar antenna means 549. The same components are denoted by the same reference numerals, and will not be explained again. The integrated planar antenna means 549 can comprise, but is not limited to, planar antennas, patch antennas, slot antennas, quasi-yagi antennas, or arrays or combinations of planar antennas.

One embodiment of the generalized diagram shown in FIG. 24D illustrates the features of an integrated circuit packaging means 508 for radar applications containing an integrated planar antenna means, and capable of packaging one or a plurality of integrated circuit die containing at least one high-frequency signal port in a low-cost, mass-production capable unit, in accordance with aspects of the present invention. The aforementioned term “high-frequency” refers to a frequency greater than or equal to 5 GHz, such as, but not limited to, 76 GHz. The arrangement illustrated in FIG. 24D is similar to the arrangement of FIG. 24C except for the addition of a package cover means 550. The same components are denoted by the same reference numerals, and will not be explained again. The package cover means 550 can be used for, but is not limited to, physical protection of the integrated circuit die, handling or marking purposes, or thermal heat extraction from the package. The package cover means 550 construction material can comprise, but is not limited to, metal or metal alloy, ceramic, laminate, thermo-plastic, or plastic.

One embodiment of the generalized diagram shown in FIG. 24E illustrates the features of an integrated circuit packaging means 526 for radar applications containing an integrated electro-magnetic signal coupling means, and capable of packaging one or a plurality of integrated circuit die containing at least one high-frequency signal port in a low-cost, mass-production capable unit, in accordance with aspects of the present invention. The aforementioned term “high-frequency” refers to a frequency greater than or equal to 5 GHz, such as, but not limited to, 76 GHz. The arrangement illustrated in FIG. 24E is similar to the arrangement of FIG. 24A except that the integrated signal radiating means 548 has been replaced by specifically an integrated electromagnetic signal coupling means 553. The same components are denoted by the same reference numerals, and will not be explained again. The integrated electro-magnetic signal coupling means 553 can comprise, but is not limited to, electromagnetic coupling ports, waveguide coupling ports, coaxial coupling ports, planar coupling ports, or arrays or combinations of coupling ports.

One embodiment of the generalized diagram shown in FIG. 24F illustrates the features of an integrated circuit packaging means 528 for radar applications containing an integrated electro-magnetic signal coupling means, and capable of packaging one or a plurality of integrated circuit die containing at least one high-frequency signal port in a low-cost, mass-production capable unit, in accordance with aspects of the present invention. The aforementioned term “high-frequency” refers to a frequency greater than or equal to 5 GHz, such as, but not limited to, 76 GHz. The arrangement illustrated in FIG. 24F is similar to the arrangement of FIG. 24E except for the addition of a package cover means 550. The same components are denoted by the same reference numerals, and will not be explained again. The package cover means 550 can be used for, but is not limited to, physical protection of the integrated circuit die, handling or marking purposes, or thermal heat extraction from the package. The package cover means 550 construction material can comprise, but is not limited to, metal or metal alloy, ceramic, laminate, thermo-plastic, or plastic.

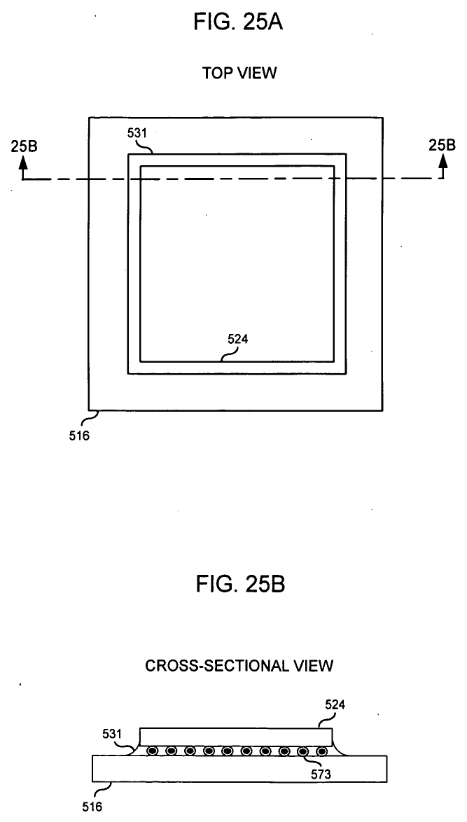

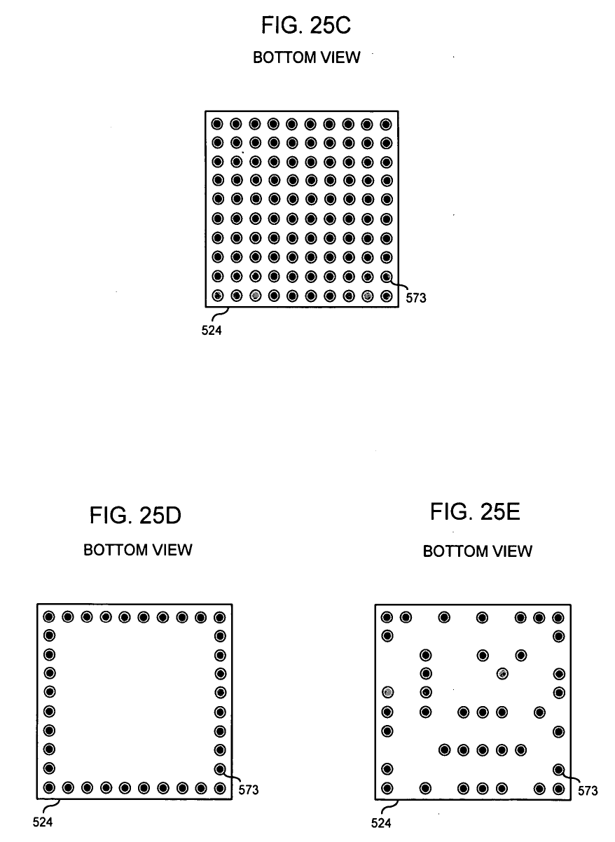

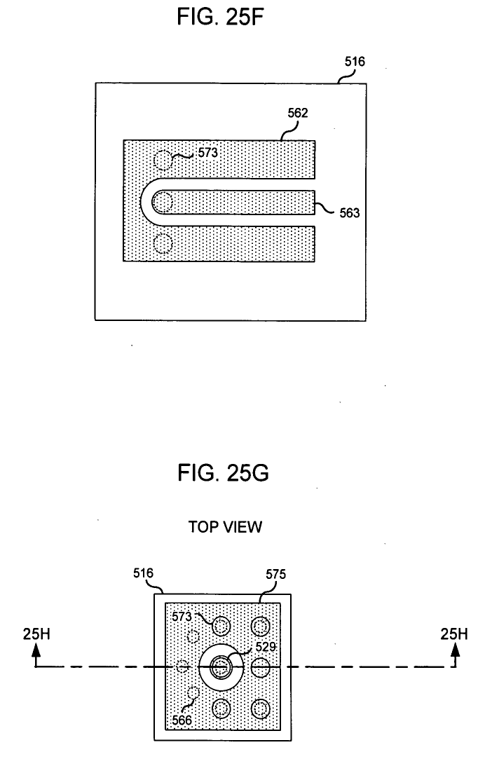

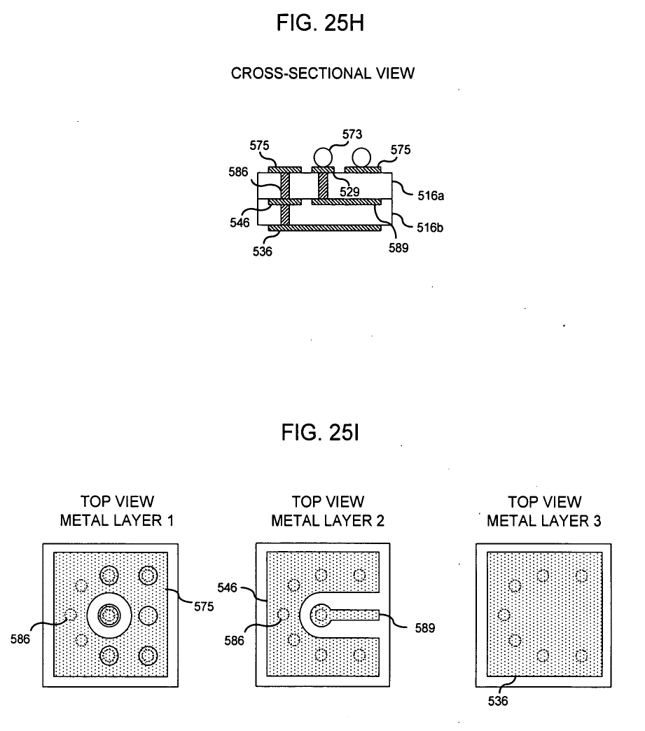

An integrated circuit die to substrate interconnection arrangement is illustrated in FIGS. 25A-B as one embodiment of the high-frequency die to substrate interconnect means 535. In this arrangement, an integrated circuit die 524 is flip-chip mounted to a high-frequency substrate 516. The input and output ports of the die 524 make circuit connections to the substrate through the flip-chip connection means 573. An integrated circuit die can comprise, but is not limited to, a silicon circuit die containing a plurality of transistors, a silicon-germanium circuit die containing a plurality of transistors, a gallium-arsenide circuit die containing a plurality of transistors, an indium-phosphide circuit die containing a plurality of transistors, or an InGaP circuit die containing a plurality of transistors. The flip-chip connection means 573 can comprise, but are not limited to, solder or gold balls. The flip-chip mounting method can comprise, but is not limited to, soldering techniques, reflow techniques, or thermo-compression techniques. An underfill material 531 is dispensed after the flip-chip mounting procedure, between the die and substrate, and cured. One benefit of the underfill material is the reduction of stress on the flip-chip connection means 573 through a distribution of the die to substrate connection stresses over die surface area. The flip-chip die to substrate interconnection method can support high frequency signals between the die and the substrate due to the low inductance and short length of the flip-chip connection means. As an alternate embodiment of the high-frequency die to substrate interconnect means 535, the step of dispensing the underfill material 531 can be eliminated.

FIGS. 25C-E illustrate three distribution patterns for the flip-chip connection means 573 on the integrated circuit die 524 according to aspects of the present invention. An evenly distributed area array pattern in shown in FIG. 25C, a perimeter area array pattern in shown in FIG. 25D, and a sparse array is shown in FIG. 25E. The patterns described are for illustration purposes only, and are not meant as a limitation. The patterns described can be modified by one skilled in the art without departing from the spirit of the present invention. For example, not in any way meant as a restriction, the pattern illustrated in FIG. 25C may contain areas where the flip-chip connection means 573 are removed, rows may be unevenly distributed or offset from each other, or the pattern shown in FIG. 25D may have a plurality of rows on the perimeter or have rows within the plurality offset from each other, or be distributed in a non-equally spaced pattern. Conditions that may influence the distribution patterns of the flip-chip connection means 573 can comprise, but are not limited to, space or location limitation on the integrated circuit die 524, underfill dispense flow considerations, or flip-chip process requirements.

FIG. 25F illustrates a high-frequency, controlled-impedance transition from the high frequency substrate 516 to the flip-chip connection means 573 on the integrated circuit die 524 according to aspects of the present invention. The flip-chip connection means 573 are mounted to an RF ground metal pattern 562 on the substrate 516 and to an RF signal metal transmission line 563. The RF signal and ground metal patterns on the substrate surface create a controlled impedance coplanar microwave transmission line, and can be designed to support high frequency signal operation. The patterns described are for illustration purposes only, and are not meant as a limitation. The patterns described can be modified by one skilled in the art without departing from the spirit of the present invention.

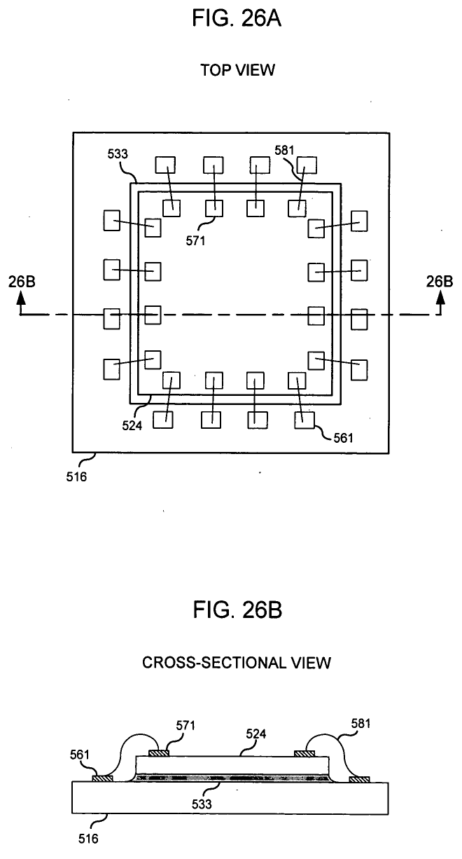

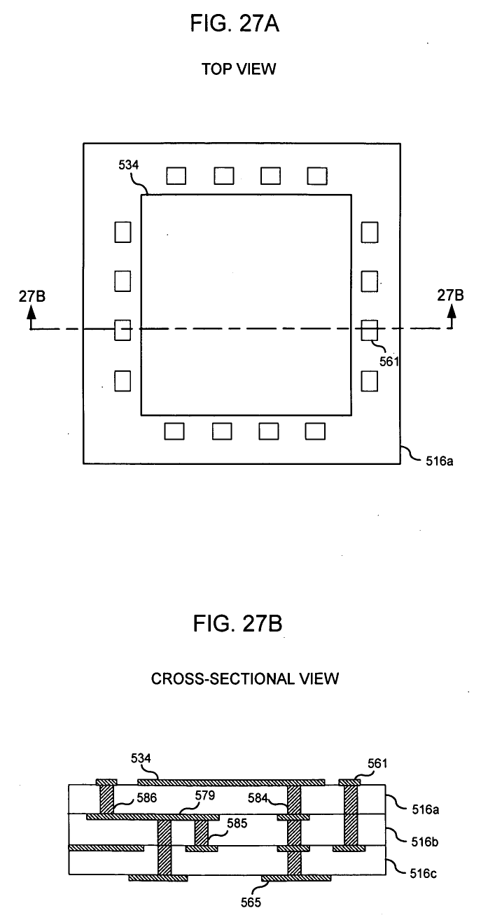

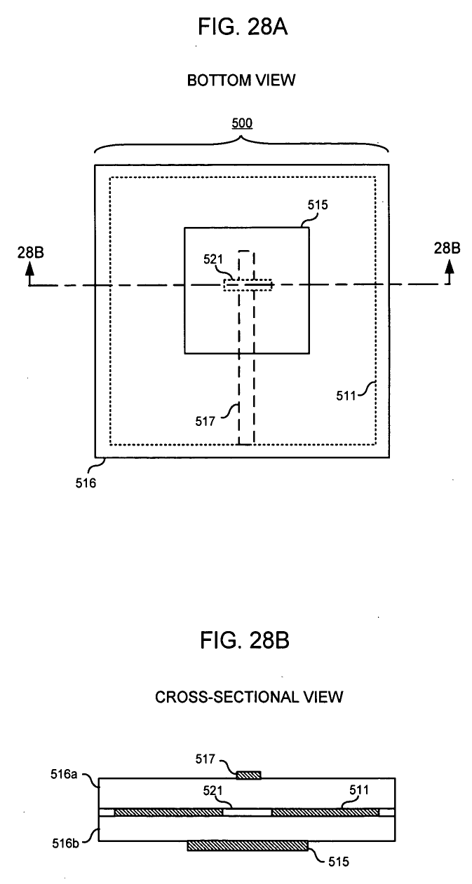

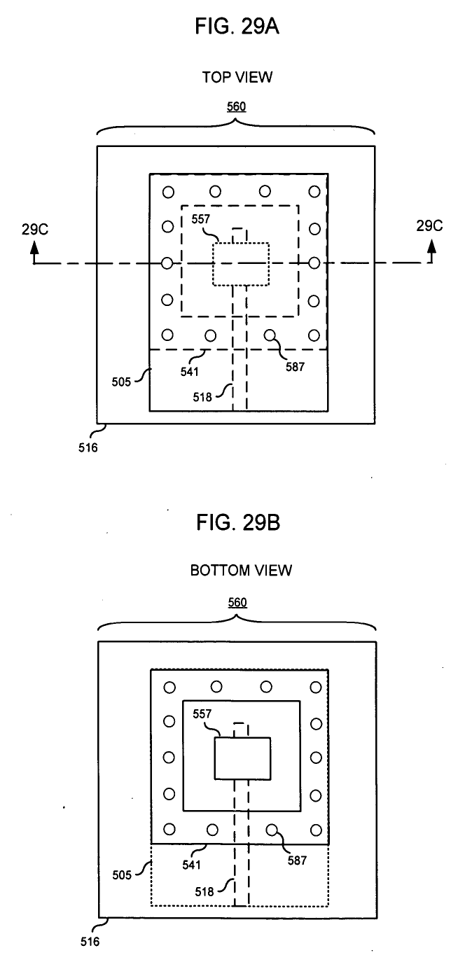

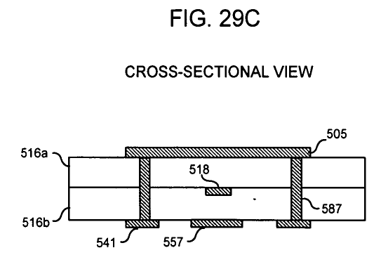

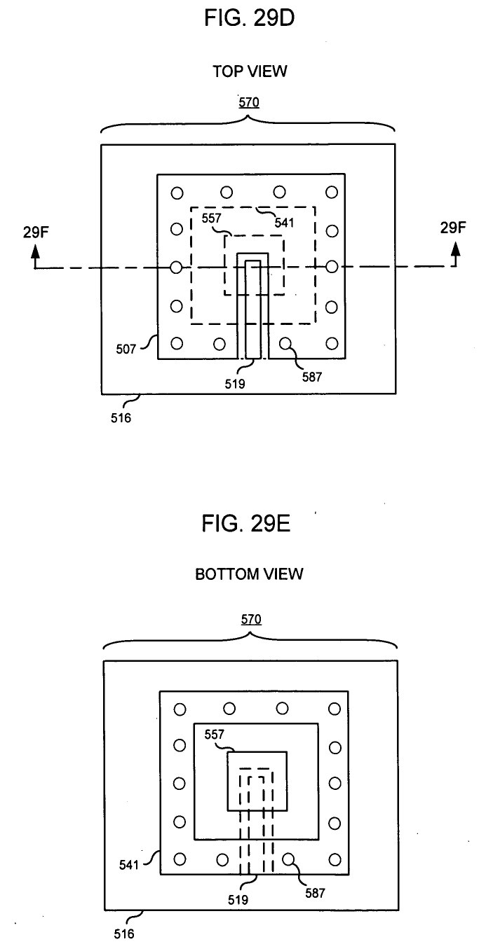

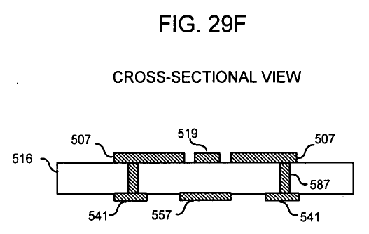

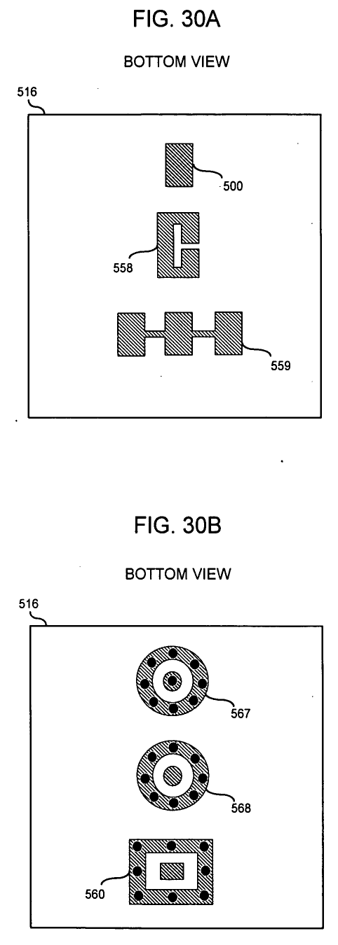

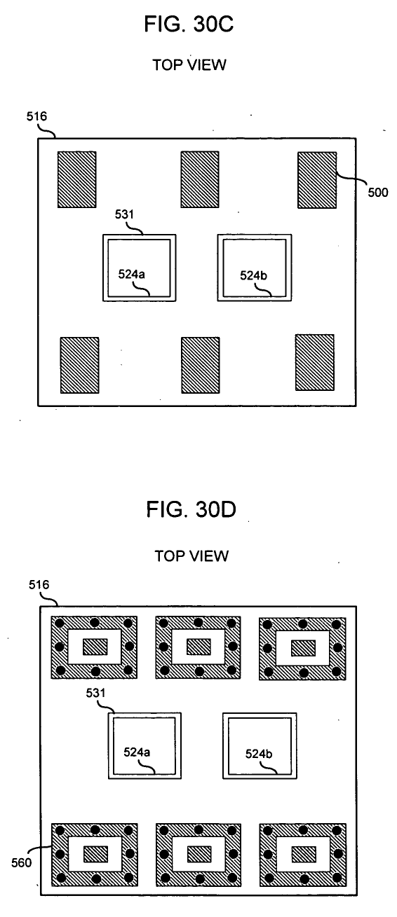

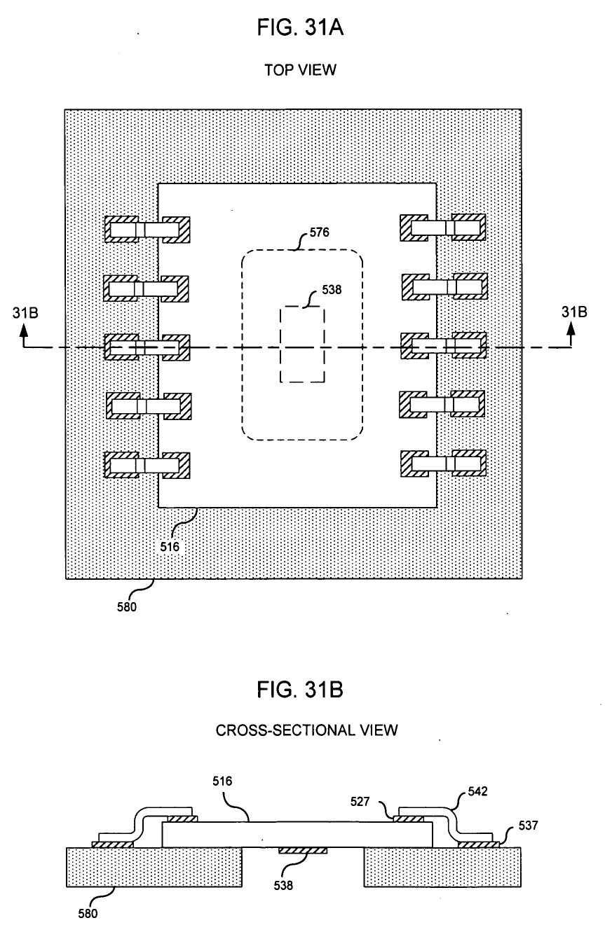

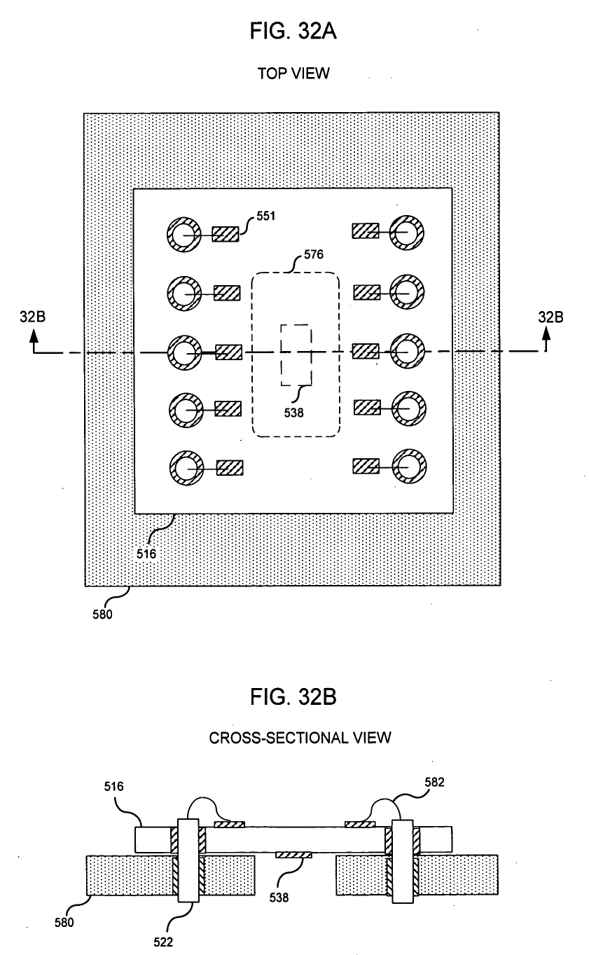

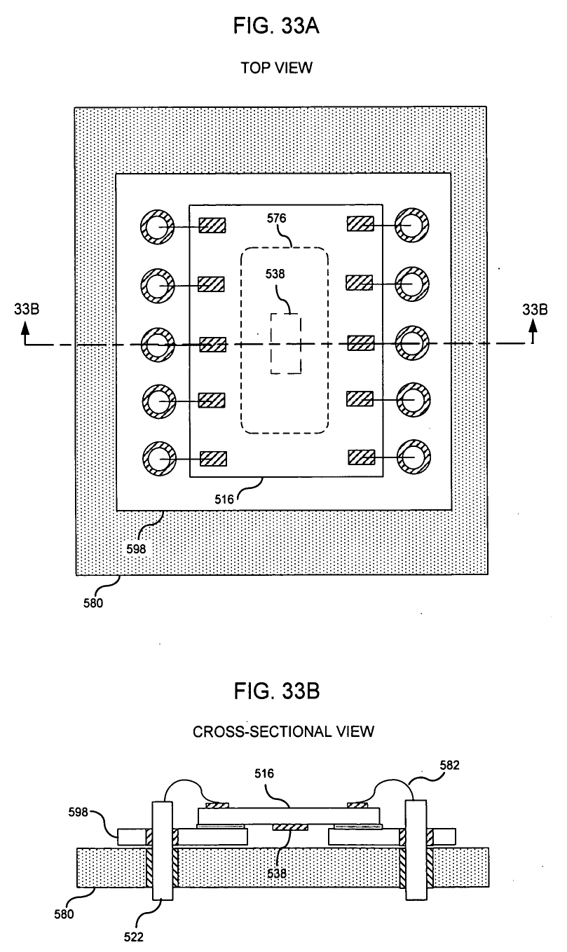

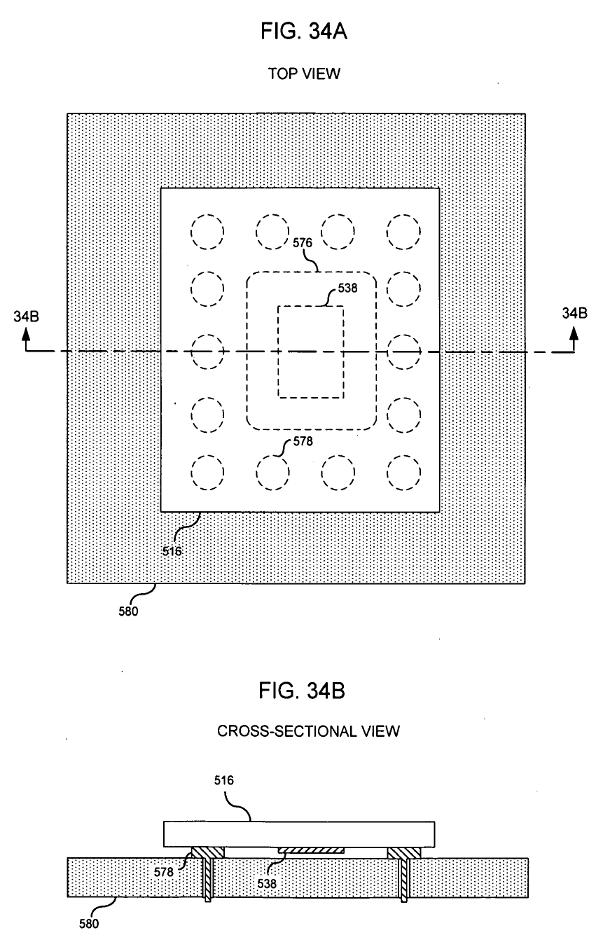

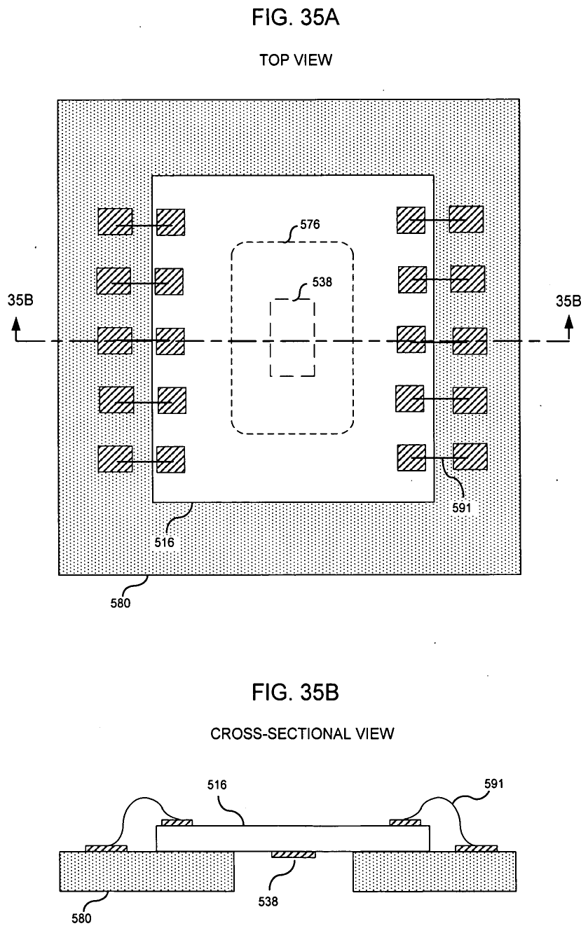

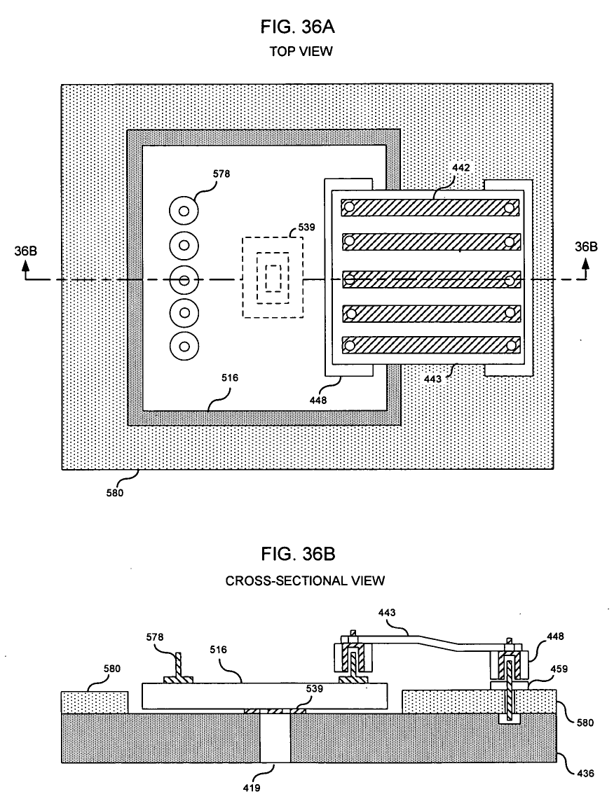

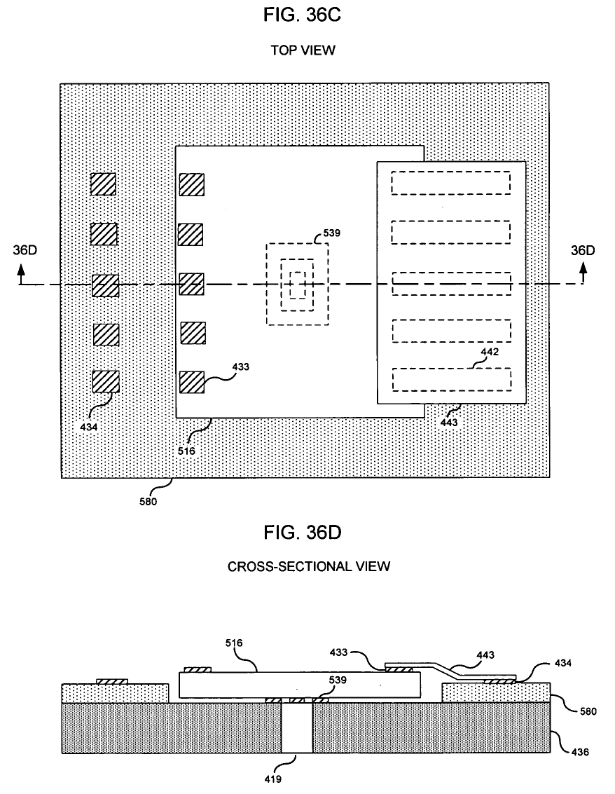

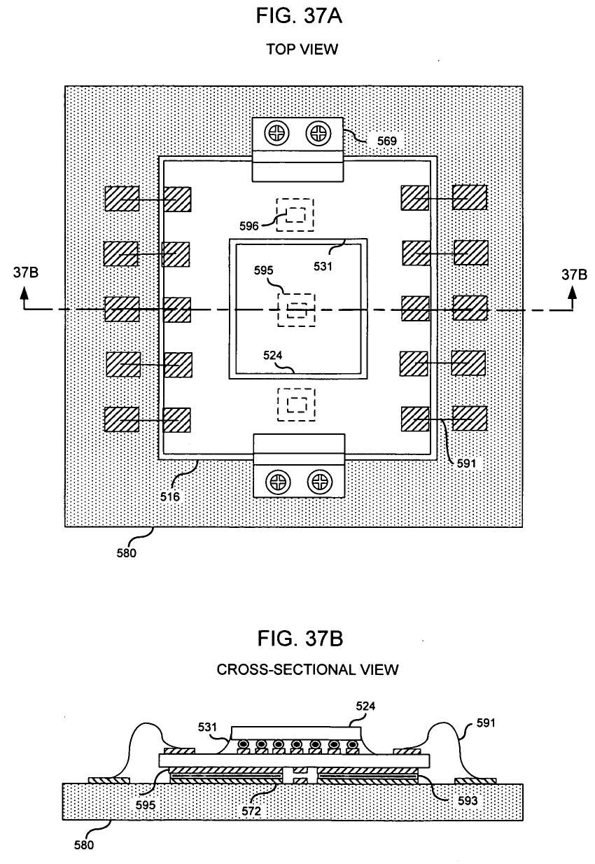

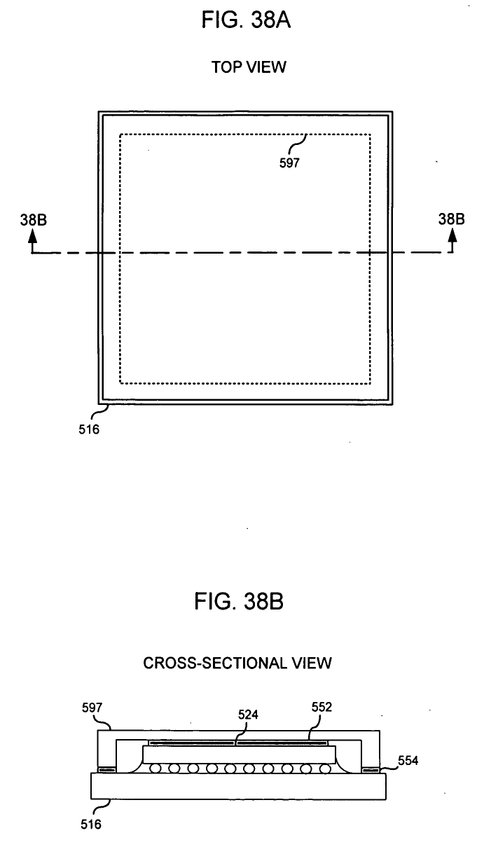

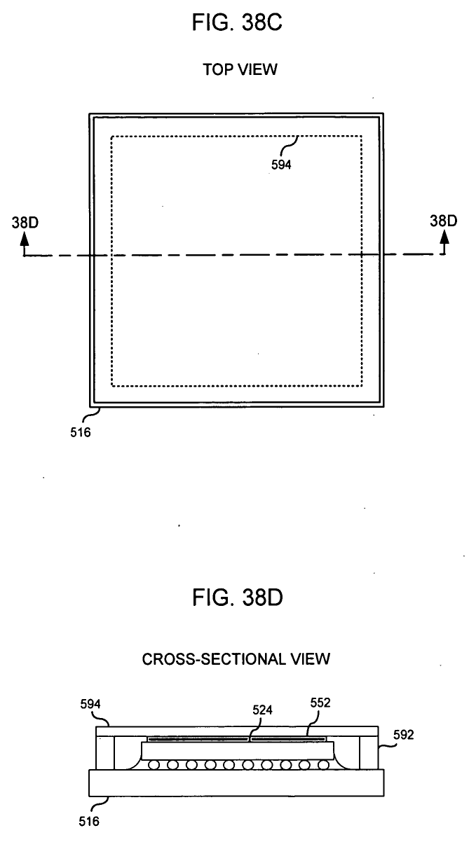

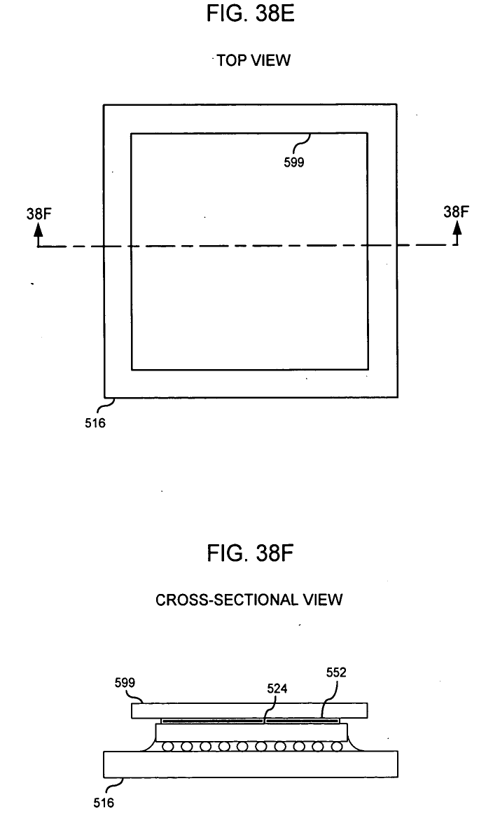

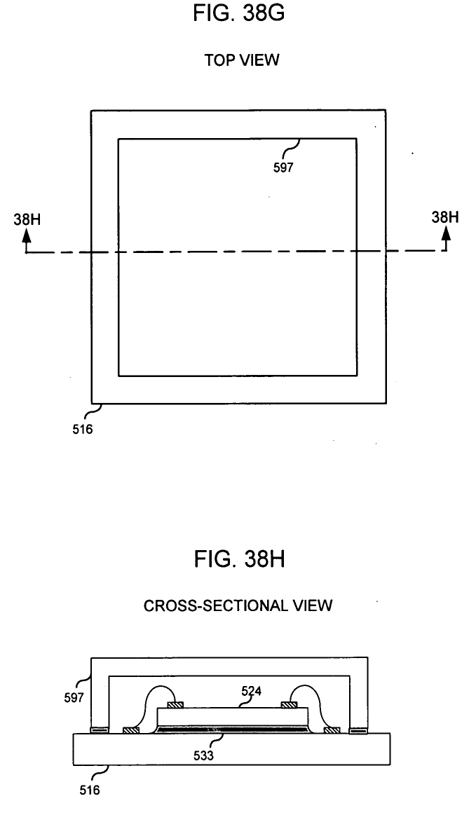

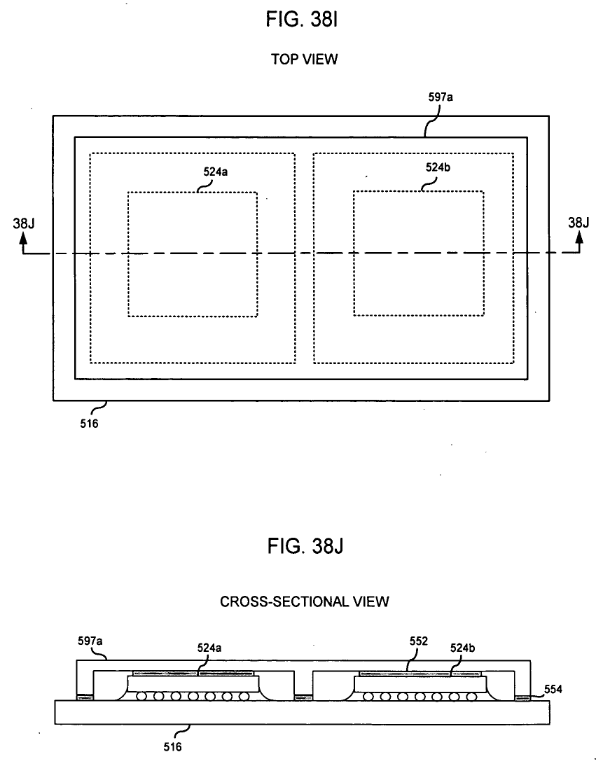

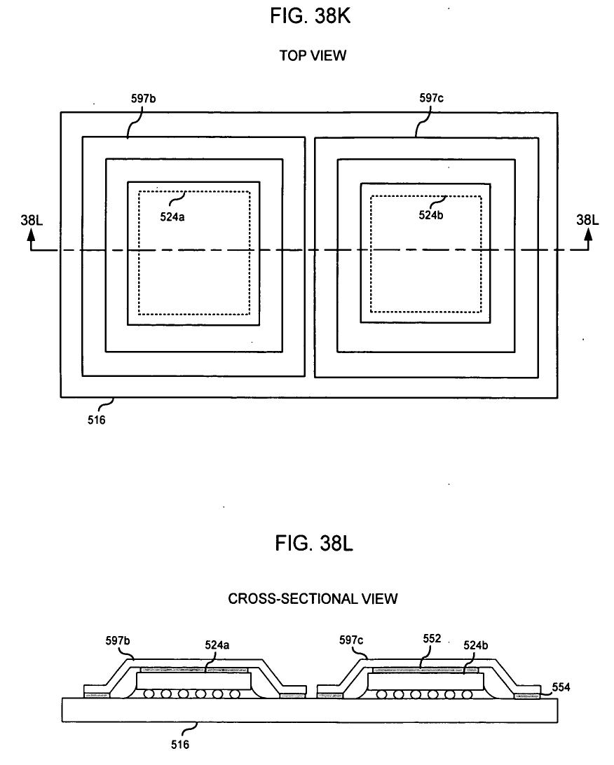

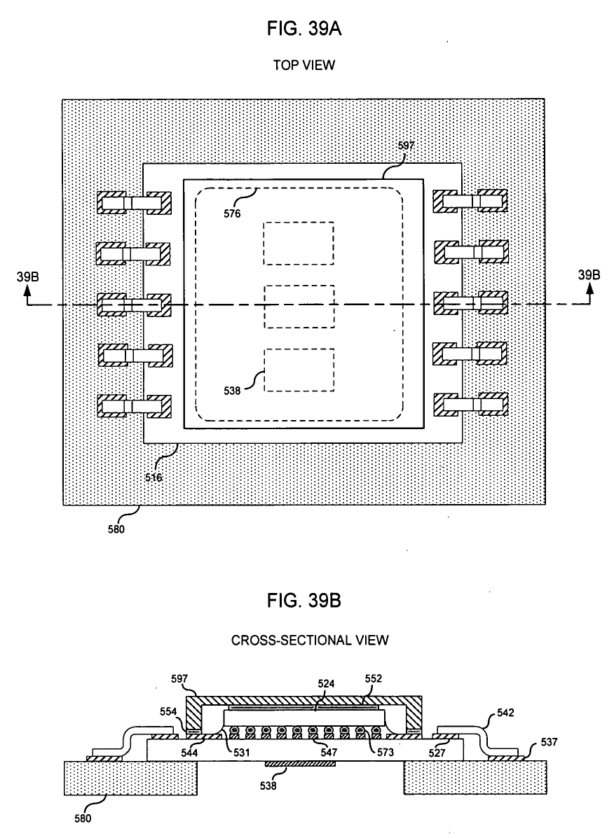

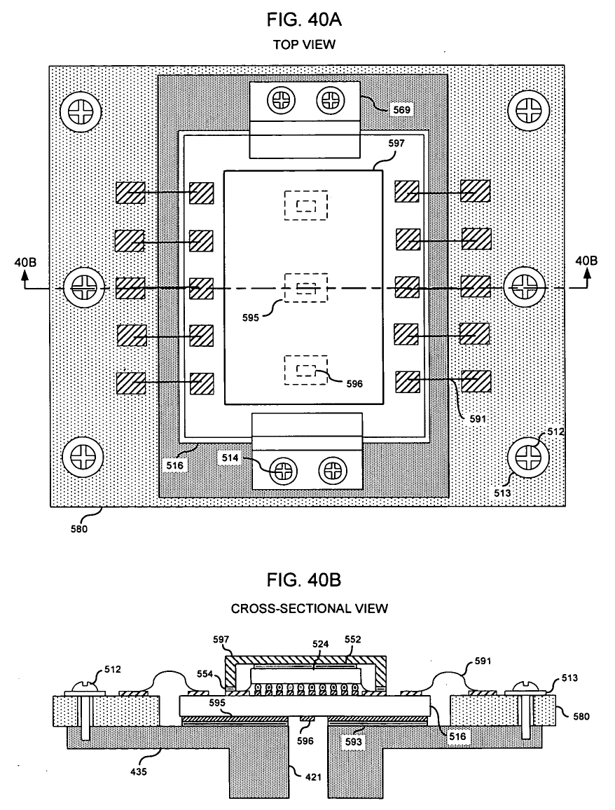

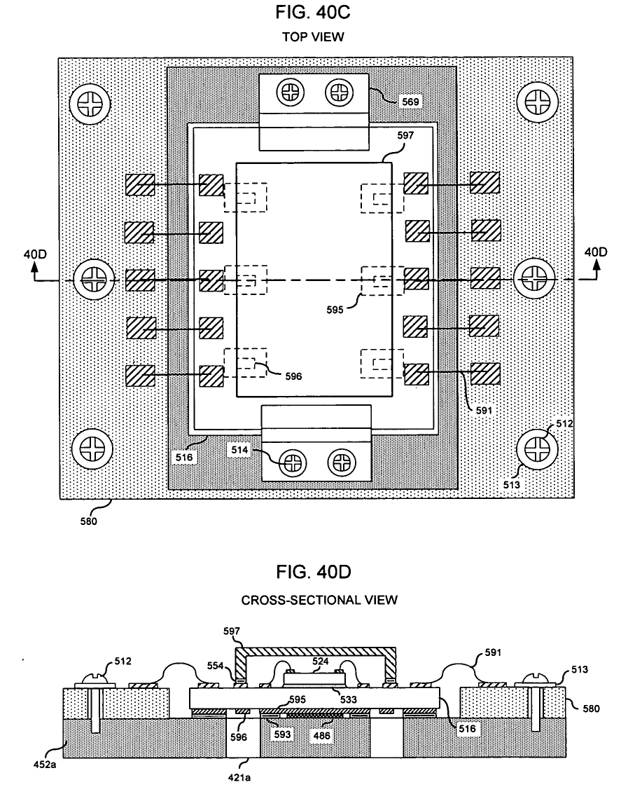

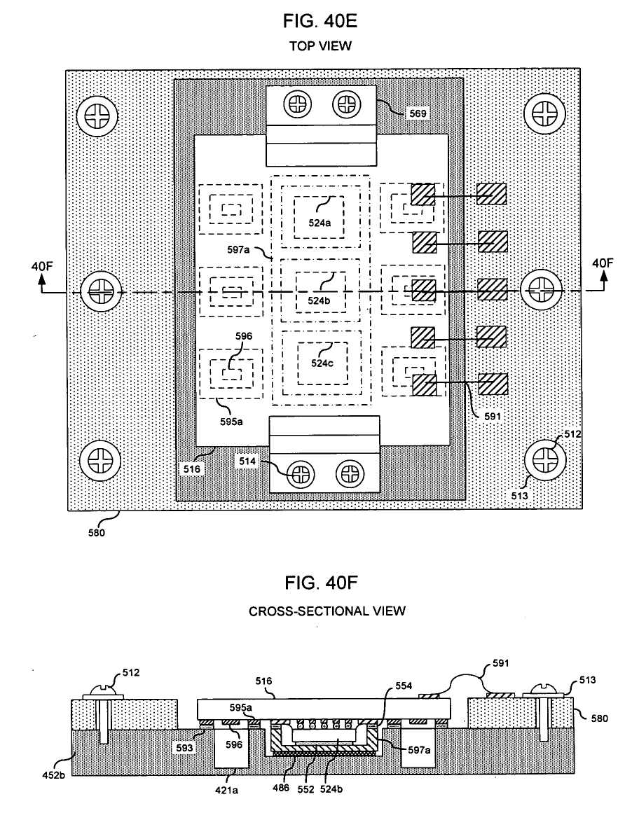

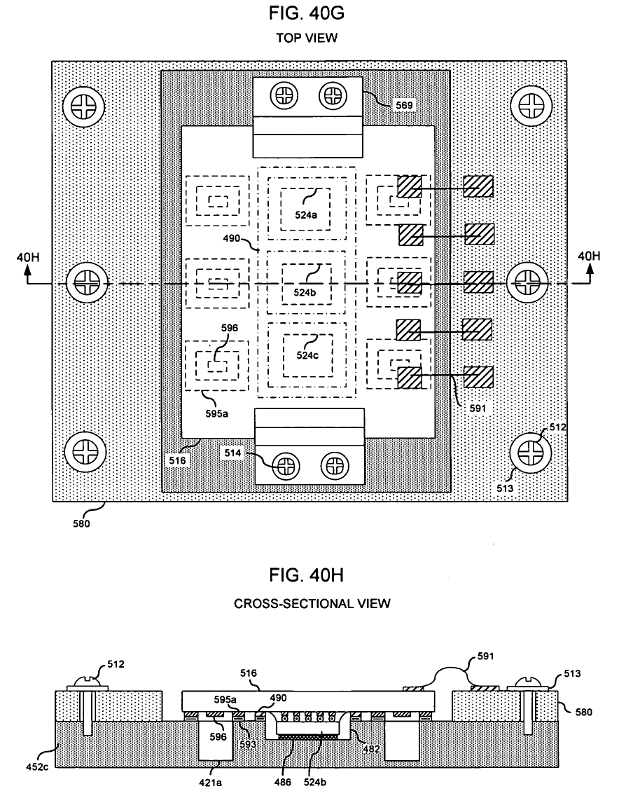

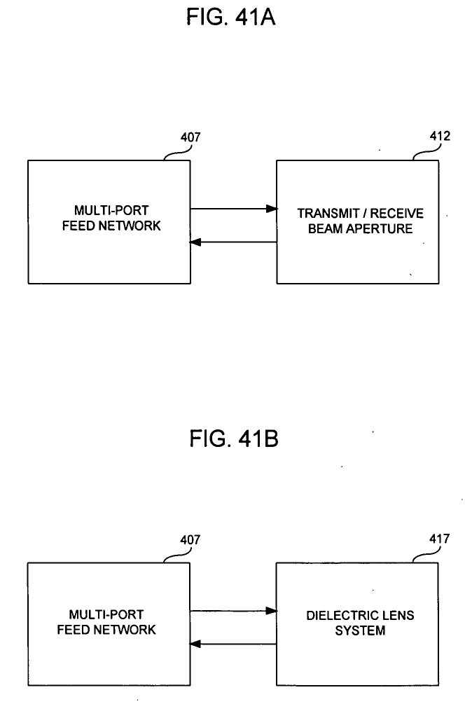

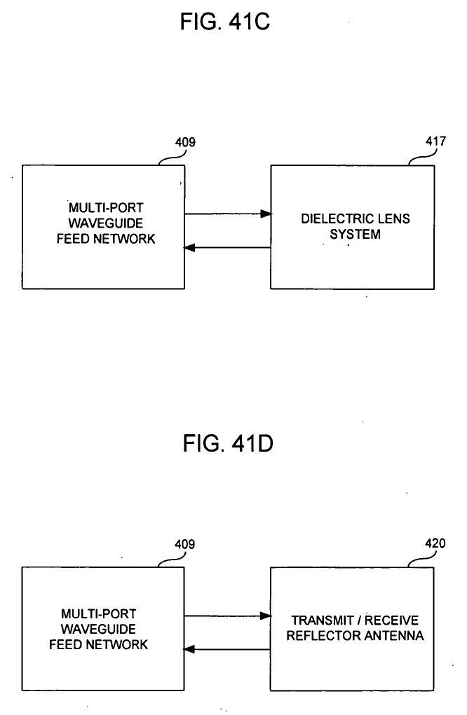

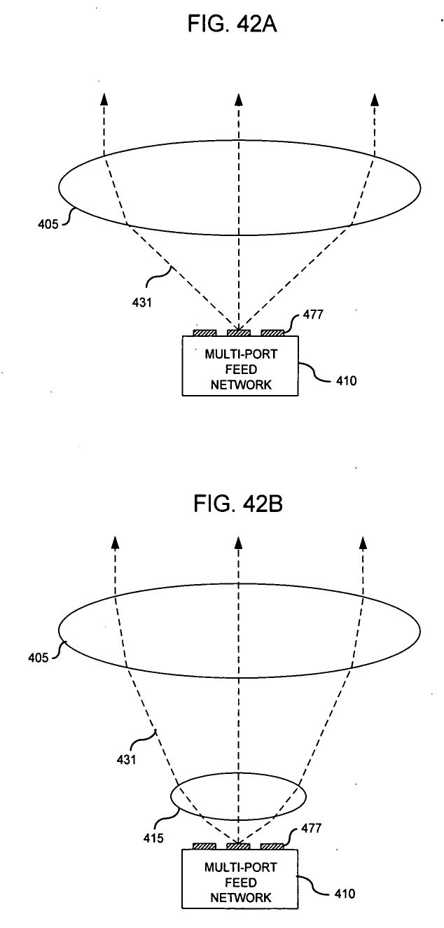

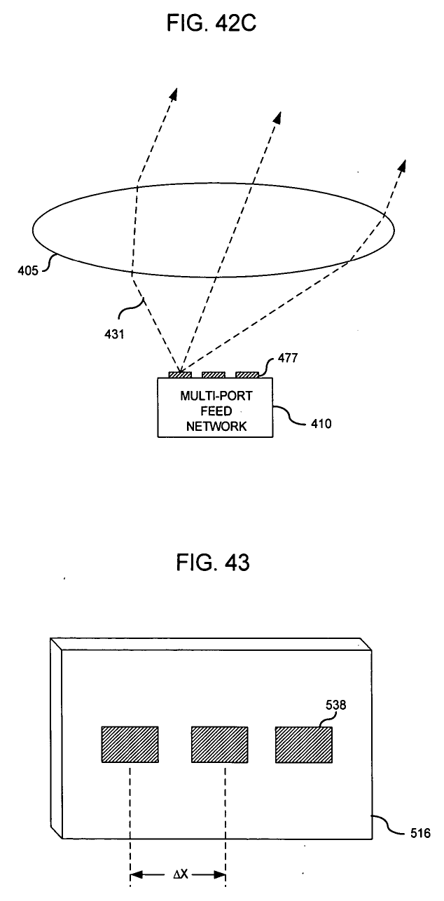

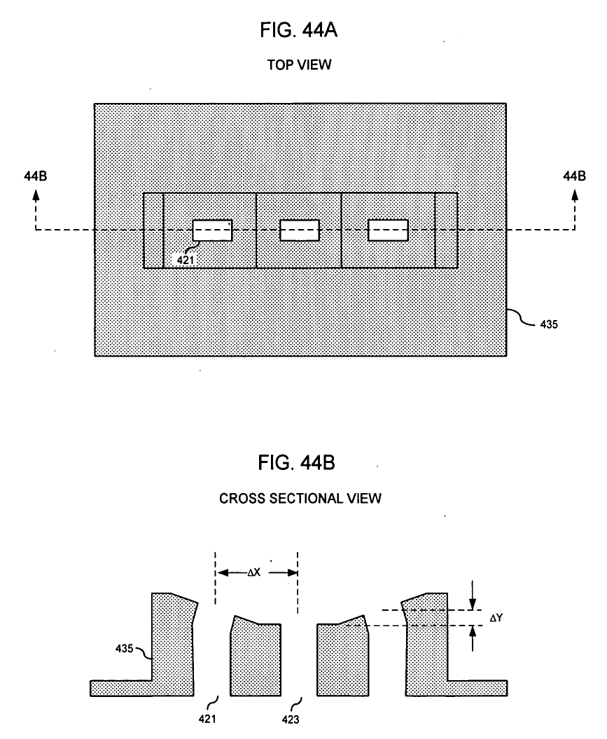

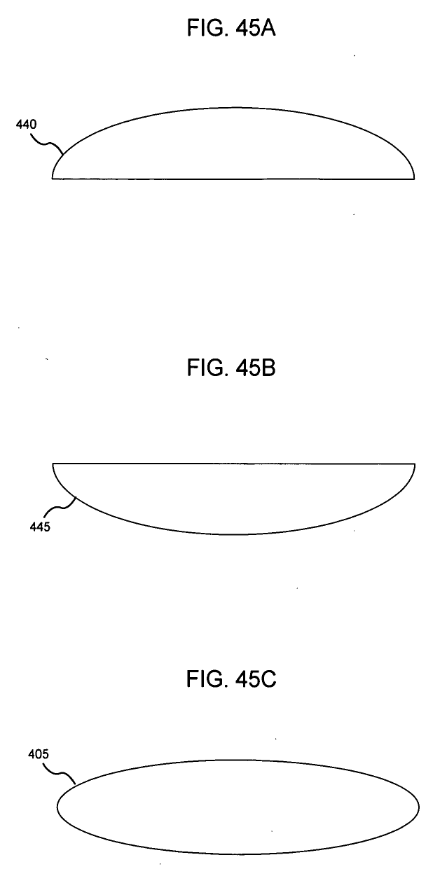

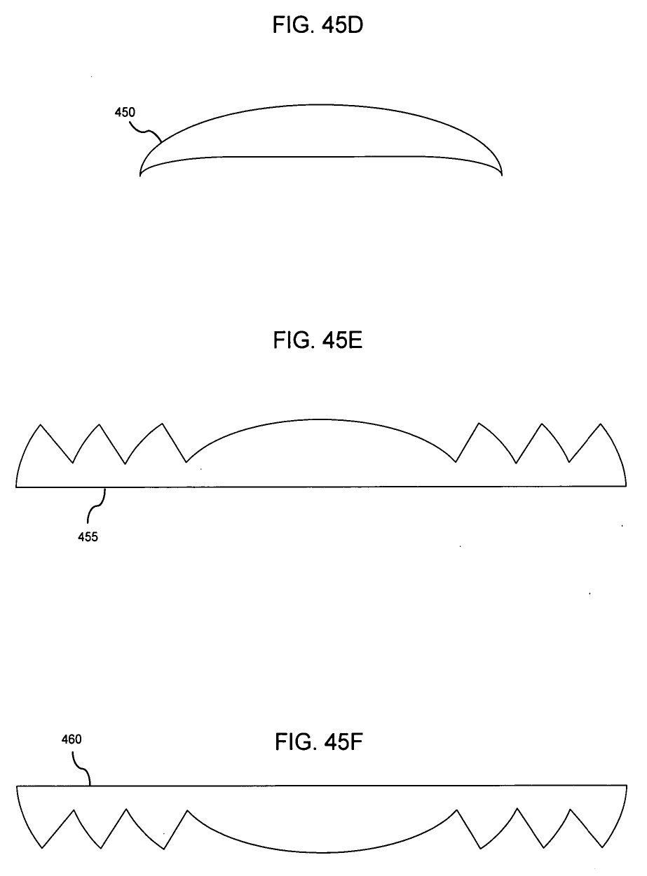

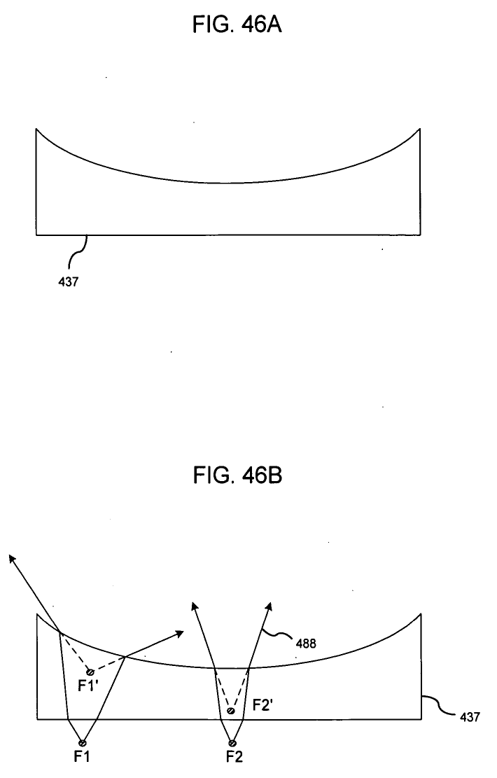

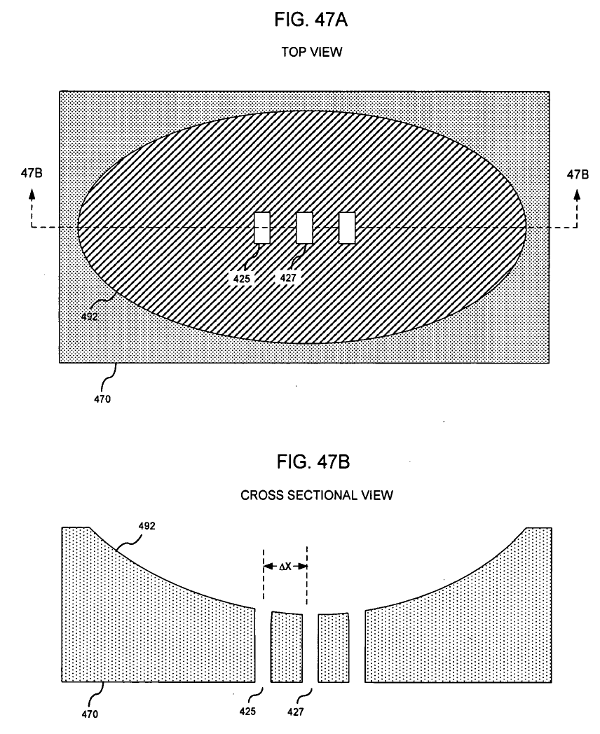

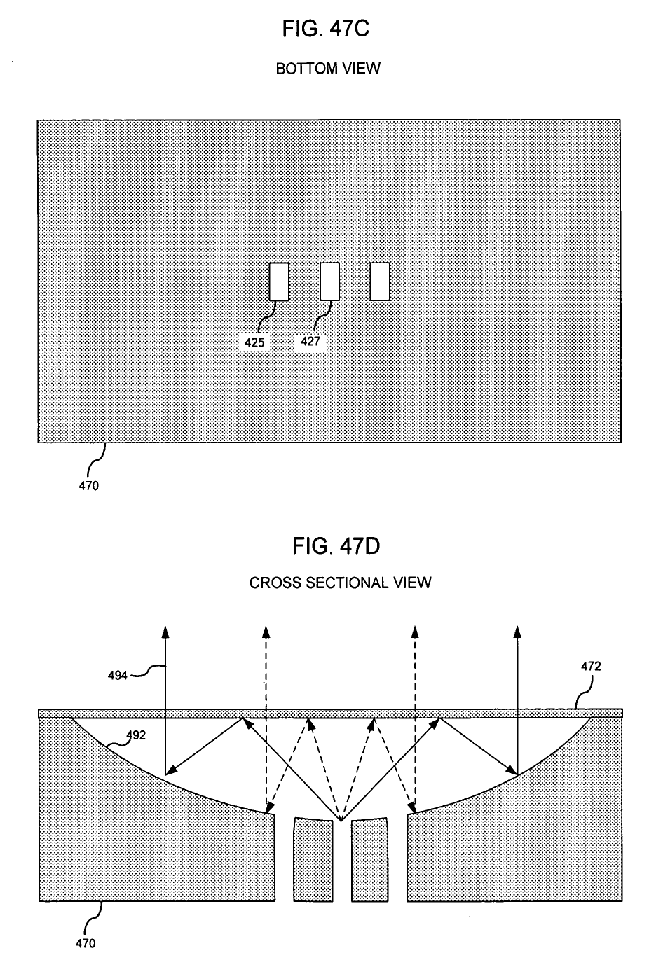

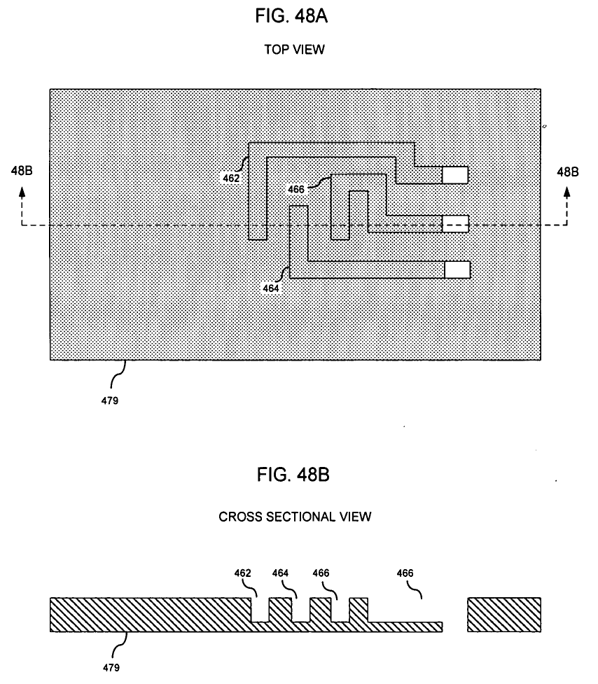

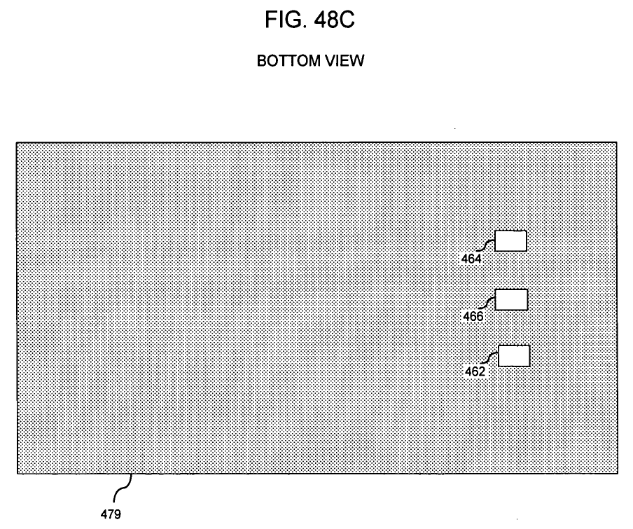

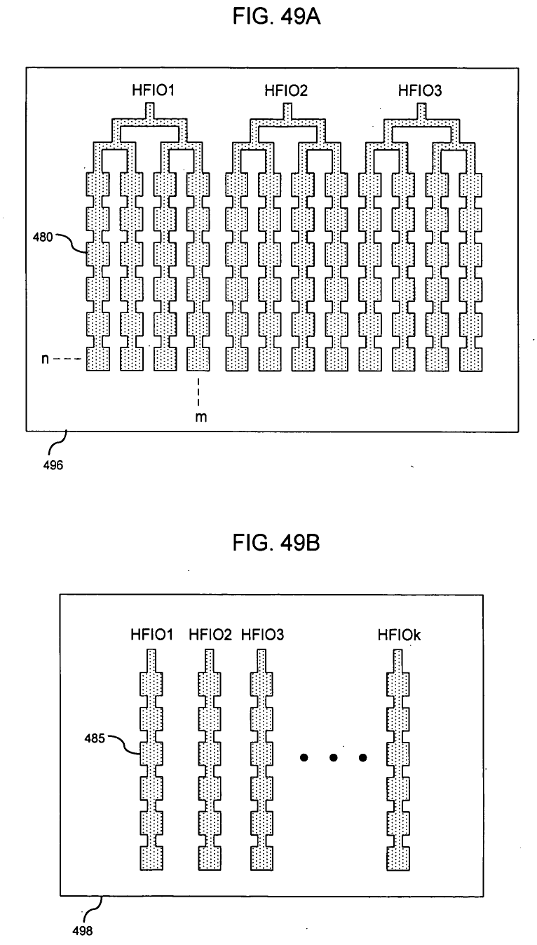

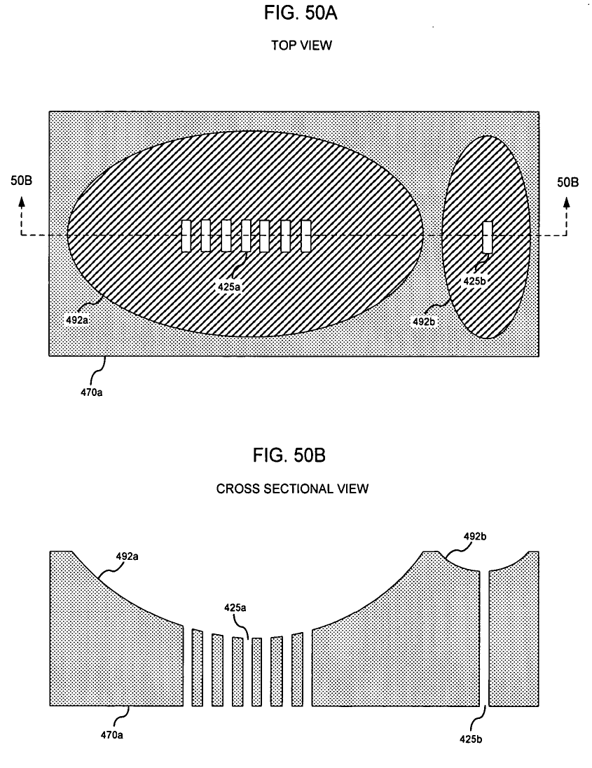

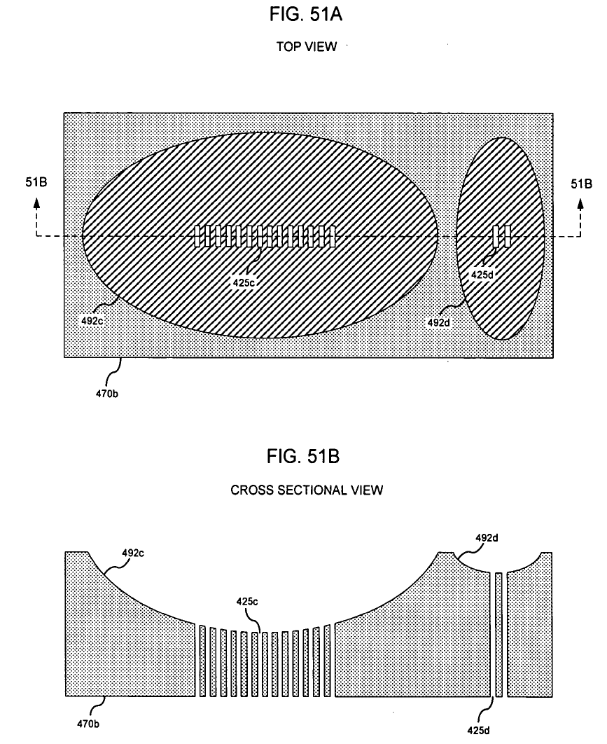

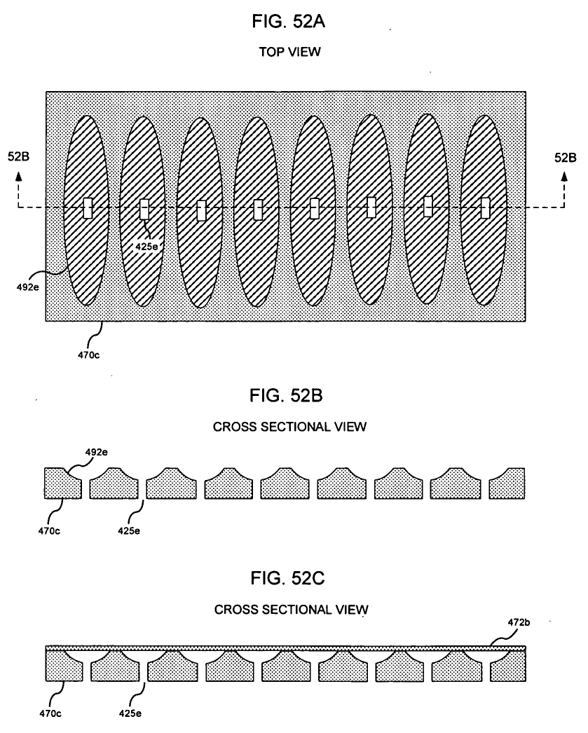

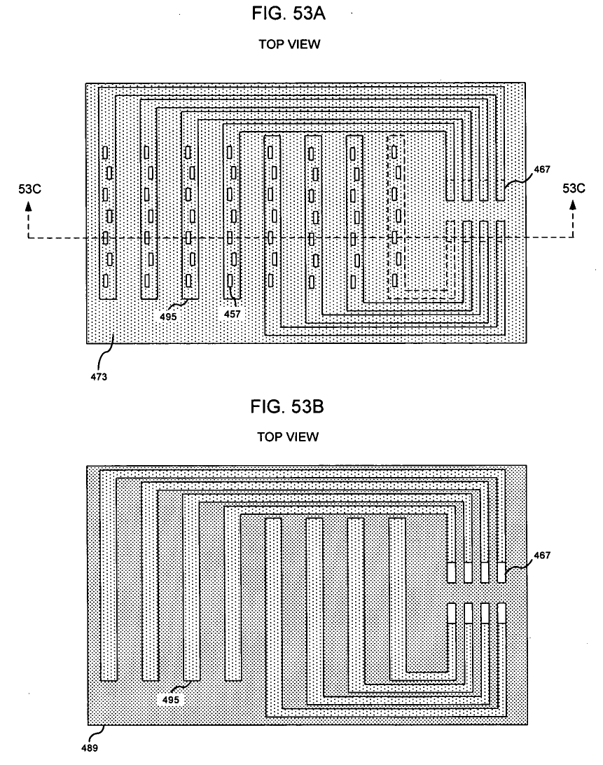

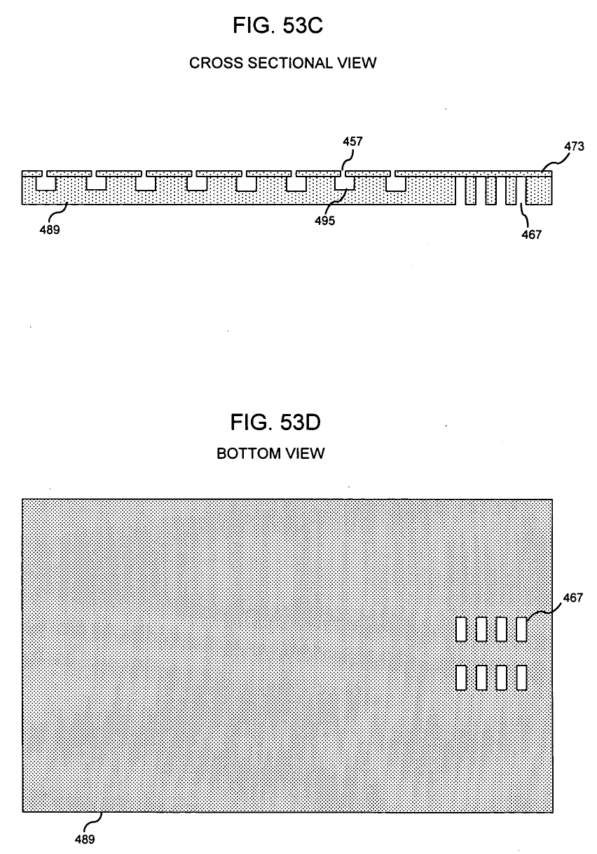

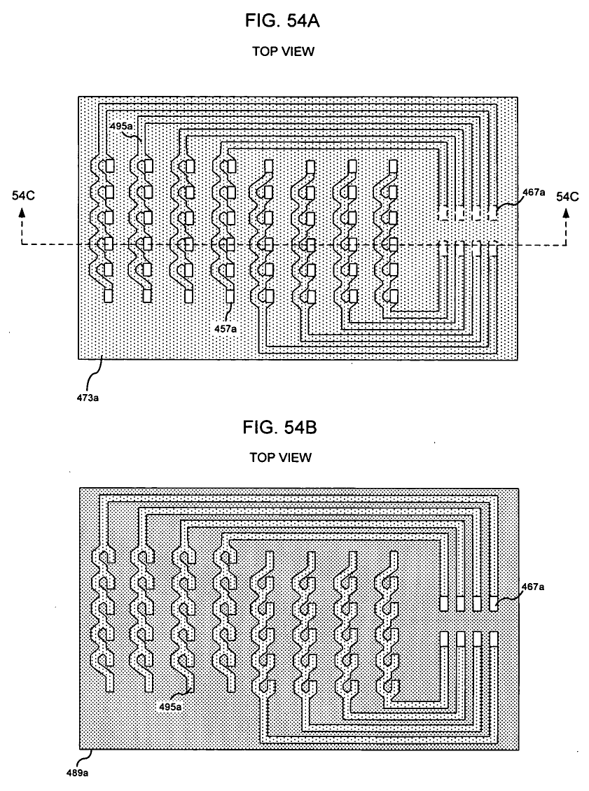

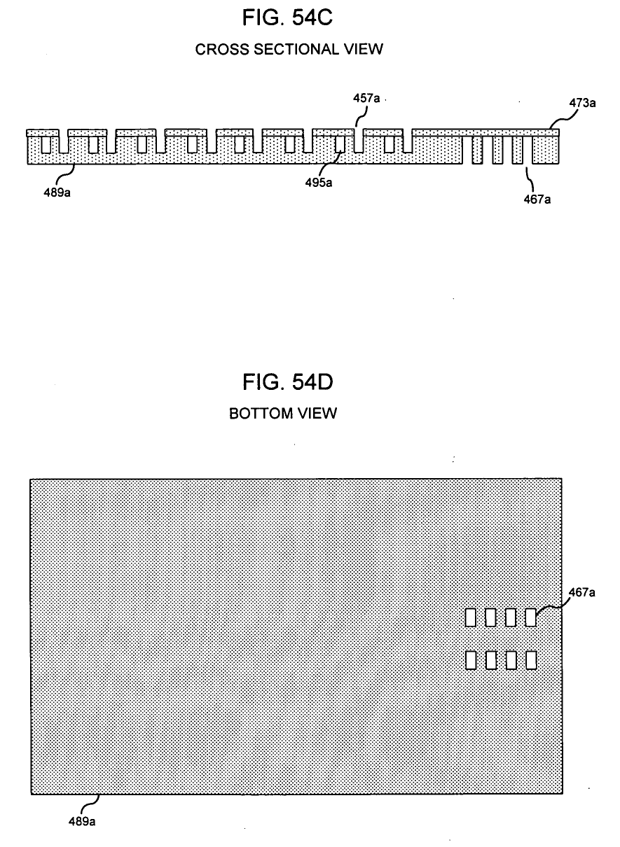

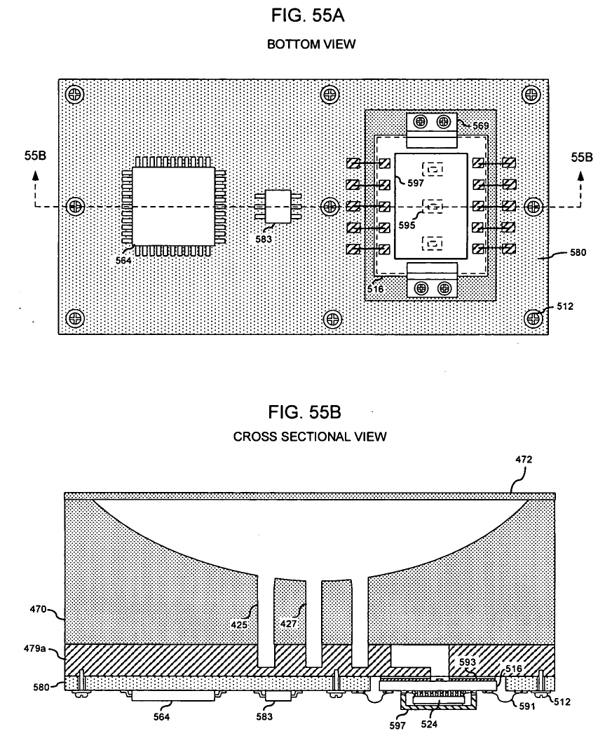

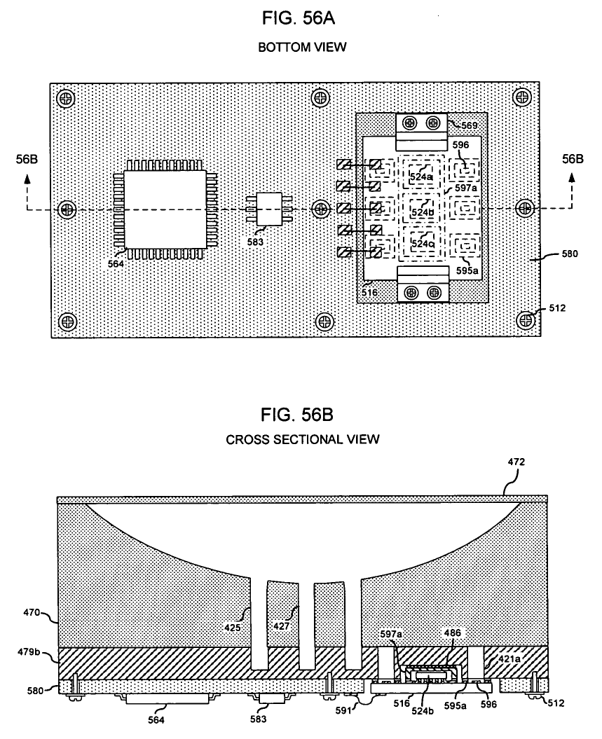

FIGS. 25G-I illustrate a high-frequency, controlled-impedance transition from the high frequency substrate 516 to the flip-chip connection means 573 on the integrated circuit die 524 according to aspects of the present invention. The flip-chip connection means 573 are mounted to an RF ground metal pattern 575 on the substrate 516 and to an RF signal metal pad 529. In this configuration, the RF signal from the integrated circuit die 524 transitions to an inner layer of the substrate 516 using a quasi-coaxial signal 529 and via arrangement 586 in the substrate 516. The top surface of the substrate is RF ground metal 575 providing shielding from the inner layer RF signal 589. This can help to suppress or avoid cavity resonances and oscillations when the package has a metal cover or is enclosed in a metal housing. The RF signal transitions vertically using a metallized via from the signal pad 529 on the surface of substrate 516 into an inner layer RF stripline/coplanar microwave transmission line 589, shown in FIG. 251. A bottom RF ground metal layer 536 completes the transmission line structure. The vertical ground vias 586 connect the bottom RF ground 536 to the inner layer RF ground 546 and to the top layer RF ground 575. The RF signal and ground structure described creates a shielded, controlled-impedance microwave transition, and can be designed to support high-frequency signal operation. The patterns described are for illustration purposes only, and are not meant as a limitation. The patterns described can be modified by one skilled in the art without departing from the spirit of the present invention.

An integrated circuit die to substrate interconnection arrangement is illustrated in FIGS. 26A-B as one embodiment of the high-frequency die to substrate interconnect means 535. In this arrangement, an integrated circuit die 524 is mounted to a high-frequency substrate 516 using a die attach material 533. The input and output bond pads 571 of the die 524 make circuit connections to the substrate circuit connection ports 561 through wire-bond connection means 581. The die attach material 533 can comprise, but is not limited to, electrically conductive epoxy, electrically non-conductive epoxy, or solder. The wire-bond connection means 581 can comprise, but is not limited to, gold round wire, gold ribbon wire, aluminum round wire, aluminum ribbon wire, or alloy round or ribbon wire. The wire-bond die to substrate interconnection method can support high frequency signals between the die and the substrate provided that the wire lengths are designed to be short enough not to adversely affect the die performance over the frequency range required by the application, or that the wire-bond parameters are taken into account in the design of the integrated circuit die.

FIGS. 27A-B illustrate the top and cross-sectional views of one embodiment of the high-frequency package substrate means 540, according to aspects of the present invention. In this arrangement, a substrate contains one or a plurality of dielectric layers 516a, 516b, 516c. Metallization patterns can be placed on the top surface such as illustrated by 534, 561, on the bottom surface such as illustrated by 565, or on the inner layers of the substrate between dielectric layers such as illustrated by 579. The metallization layers can be connected through the use of through via vertical interconnects such as illustrated by 584, partial via interconnects such as illustrated by 586, or blind via interconnects such as illustrated by 585. The via interconnects can be, but are not limited to, filled or plugged to be essentially solid metal, partially filled such that the via still maintains connectivity but is not completely filled with metal, or peripherally filled such that the via passage is not filled with metal but the walls of the via passage contain metal and maintain connectivity such as with a metal plating process. The substrate dielectric layers 516a, 516b, 516c can comprise, but are not limited to, a ceramic material, a laminate or PC board material, alumina, aluminum nitride, mullite, a low temperature co-fired ceramic (LTCC) material, a high temperature co-fired ceramic (HTCC) material, a high thermal coefficient of expansion (HiTCE) LTCC material, or a plastic material. The substrate metallization can comprise, but is not limited to, thick-film metallization, thin-film metallization, plated metallization, electro-deposited metallization, rolled metallization, or laminated metallization. The abovementioned substrate arrangement provides the necessary elements for a design to support high-frequency signals and interconnections.

One embodiment of the present invention is the planar integrated antenna means arrangement 500 shown in FIGS. 28A-B. The planar antenna means arrangement 500 can be used as one embodiment of the integrated signal radiating means 548, or as one embodiment of integrated planar antenna means 549. The antenna means arrangement 500 is composed of a microstrip transmission line 517, RF ground plane 511, aperture cutout 521 in RF ground plane 511, dielectric layer 516a, dielectric layer 516b, and metal patch element 515. The RF input signal is input to the microstrip line 517 where it couples through the aperture cutout 521 in the RF ground plane 511 to the metal patch element 515 from which it is radiated. This configuration of antenna means can achieve a wide useable fractional bandwidth, typically on the order of 10% or more, which can allow for high antenna performance yield even with practical metal dimensional manufacturing tolerances for medium to long range automotive radar applications, where typical fractional bandwidth requirements are less than 2%. One benefit of this radiating structure, not meant as a limitation, is that it can be utilized within a multi-layer package substrate structure, and a single or plurality of these radiating structures, for example, can be integrated on the backside of the package multi-layer substrate directly underneath the area where one or a plurality of integrated circuit die are attached on the top side of the substrate, resulting in an efficient use of package space which can reduce package cost.

FIGS. 29A-C illustrate the top, bottom, and cross-sectional views of one embodiment of the integrated electromagnetic signal coupling means 553, according to aspects of the present invention. The electromagnetic signal coupling means arrangement 560 is composed of a microwave transmission line 518, top RF ground plate 505, bottom RF ground plate 541 with aperture cutout, metallized vias 587 connecting top ground plate 505 with bottom ground plate 541, and impedance matching patch element 557. The RF input signal is input to the microwave transmission line 518 where it couples to impedance matching patch element 557 and launches into a waveguide mode to metal structure 541 which couples to an external waveguide from the bottom side of the substrate. One way of coupling to an external waveguide using this structure, not meant in any way as a limitation, is to provide electrical contact between the metal structure 541 and the external waveguide walls. Another way is to use an electrically conductive, solderless interface material such as an elastomer or gasket material, to contact the metal structure 541 and the external waveguide walls. One advantage of this coupling structure, not meant as a limitation, is that it can be utilized within a multi-layer package substrate structure without requiring an external back-short or grounding cap to be attached on the top-side of the substrate, which can be required for other waveguide coupling structures known to those skilled in the art. This allows the integration of a single or plurality of these coupling structures, for example, on the backside of the package multi-layer substrate directly underneath the area where one or a plurality of integrated circuit die are attached on the top side of the substrate, saving considerable package size and cost versus using a coupling structure requiring an external back-short or grounding cap.

FIGS. 29D-F illustrate the top, bottom, and cross-sectional views of another embodiment of the integrated electromagnetic signal coupling means 553, according to aspects of the present invention. The electro-magnetic signal coupling means arrangement 570 is composed of a microwave transmission line 519, top RF ground plate 507, bottom RF ground plate 541 with aperture cutout, metallized vias 587 connecting top ground plate 507 with bottom ground plate 541, and impedance matching patch element 557. The RF input signal is input to the microwave line 519 where it couples to impedance matching patch element 557 and launches into a waveguide mode to metal structure 541 which couples to an external waveguide from the bottom side of the substrate. One way of coupling to an external waveguide using this structure, not meant in any way as a limitation, is to provide electrical contact between the metal structure 541 and the external waveguide walls. Another way is to use an electrically conductive, solderless interface material such as an elastomer or gasket material, to contact the metal structure 541 and the external waveguide walls. One advantage of this coupling structure, not meant as a limitation, is that it can be utilized within a multi-layer package substrate structure without requiring an external back-short or grounding cap to be attached on the top-side of the substrate, which can be required for other waveguide coupling structures known to those skilled in the art. This allows the integration of a single or plurality of these coupling structures, for example, on the backside of the package multi-layer substrate directly underneath the area where one or a plurality of integrated circuit die are attached on the top side of the substrate, saving considerable package size and cost versus using a coupling structure requiring an external back-short or grounding cap.

FIG. 30A shows examples of integrated planar antenna elements on the bottom side of a planar IC package substrate 516 as embodiments of integrated planar antenna means 549 in accordance with aspects of the present invention. The planar antenna elements and configurations shown are for illustrative purposes only, and are not meant as a limitation. Examples of antenna elements shown are the planar patch antenna 500, planar slot antenna 508, and series planar patch antenna array 559. Although the antennas shown here will radiate in a direction normal to the substrate surface, end-fire antenna configurations or antennas with other general radiation patterns can be used without departing from the spirit of the present invention. Furthermore, antenna metallization can be on the surface of the package as shown, or can be covered by a dielectric layer.

FIG. 30B shows examples of integrated planar electromagnetic (EM) coupling elements on the bottom side of a planar IC package substrate 516 as embodiments of integrated electro-magnetic signal coupling means 553 in accordance with aspects of the present invention. The planar electromagnetic signal coupling elements and configurations shown are for illustrative purposes only, and are not meant as a limitation. Examples of EM coupling elements shown are the planar coaxial coupling structure 567, planar circular waveguide coupling structure 568, and planar rectangular waveguide coupling structure 560. The coaxial coupling structure 567 uses a center conductor via to transmit the signal surrounded by a concentric ground vias pattern as shown. The rectangular waveguide coupling structure 560 is illustrated in detail in FIGS. 29A-C or FIGS. 29D-F. The circular waveguide coupling structure 568 is constructed in a manner similar to the rectangular waveguide coupling structure 560 except that the ground metallization and via pattern are circular in shape rather than rectangular.

FIG. 30C shows an example of integrated planar antenna elements 500 on the top side of a planar IC package substrate 516 as an embodiment of integrated planar antenna means 549 in accordance with aspects of the present invention. The planar antenna elements and configuration shown is for illustrative purposes only, and are not meant as a limitation. In this arrangement, the planar antenna elements 500 shown are on the top side of the package substrate, and are on the same side of the package substrate as the integrated circuit die are attached. In the example shown, a plurality of integrated circuit die 524a and 524b are attached using the flip-chip attachment means and use underfill 531. Other variations in the number of die attached, and the method of attachment and interconnection, such as epoxy die attachment and wire-bonding, can be utilized without departing from the spirit of the present invention. One benefit of integrating the antenna elements on the same side of the package as flip-chip attached die, not meant as a limitation, is the ability to have the same thermal direction for heat extraction from the die as the signal radiation direction. Examples of planar antenna elements are the planar patch antenna, planar slot antenna, and series planar patch antenna array. Although the antennas shown here will radiate in a direction normal to the substrate surface, end-fire antenna configurations or antennas with other general radiation patterns can be used without departing from the spirit of the present invention. Furthermore, antenna metallization can be on the surface of the package as shown, or can be covered by a dielectric layer without departing from the present invention.

FIG. 30D shows an example of integrated planar electromagnetic (EM) coupling elements 560 on the top side of a planar IC package substrate 516 as an embodiment of integrated electromagnetic signal coupling means 553 in accordance with aspects of the present invention. The planar electromagnetic signal coupling elements and configurations shown are for illustrative purposes only, and are not meant as a limitation. In this arrangement, the planar electromagnetic signal coupling elements 560 shown are on the top side of the package substrate, and are on the same side of the package substrate as the integrated circuit die are attached. In the example shown, a plurality of integrated circuit die 524a and 524b are attached using the flip-chip attachment means and use underfill 531. Other variations in the number of die attached, and the method of attachment and interconnection, such as epoxy die attachment and wire-bonding, can be utilized without departing from the spirit of the present invention. One benefit of integrating the antenna elements on the same side of the package as flip-chip attached die, not meant as a limitation, is the ability to have the same thermal direction for heat extraction from the die as the electromagnetic (EM) signal coupling direction. Examples of EM coupling elements are the planar coaxial coupling structure, planar circular waveguide coupling structure, and planar rectangular waveguide coupling structure. The coaxial coupling structure uses a center conductor via to transmit the signal surrounded by a concentric ground vias pattern as shown as illustrated in FIG. 30B. The rectangular waveguide coupling structure 560 is illustrated in detail in FIGS. 29A-C or FIGS. 29D-F. The circular waveguide coupling structure is constructed in a manner similar to the rectangular waveguide coupling structure 560 except that the ground metallization and via pattern are circular in shape rather than rectangular, and is illustrated in FIG. 30B.

A lead-formed interconnect means is illustrated in FIGS. 31A-B as one embodiment of the mechanically stress-relieved package substrate external interconnect means 545. In this arrangement, a metal interconnect means 542 is attached to substrate metallization 527 on substrate 516 forming a package lead. The attachment method can comprise, but is not limited to, a brazing process. The leads 542 are formed into a mechanically stress-relieving shape as shown in FIG. 31B, then attached to an external printed circuit (PC) board 580 using, for example, solder. The shape of the leads allow mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. An example of a radiating patch antenna 538 is included in this illustration for the purpose of showing that attachment of the package to a PC board using this method can be compatible with the high-frequency signal radiating or coupling feature, even when that feature is on the bottom side of the package. In this example, the antenna patch 538 can radiate through a cutout 576 in the PC board material 580 creating a transmission window. The features shown are for illustration purposes only, and are not meant as a limitation. Variations of the ideas presented can be implemented by one skilled in the art without departing from the spirit of the present invention.

A vertical pin-lead interconnect means is illustrated in FIGS. 32A-B as another embodiment of the mechanically stress-relieved package substrate external interconnect means 545. In this arrangement, a vertical metal pin interconnect means 522 is attached to substrate 516 forming a package lead. The attachment method can comprise, but is not limited to, a glass-in firing process or a brazing process. The leads 522 are through-hole attached to an external printed circuit (PC) board 580 using, for example, solder. The vertical configuration of the pin leads allow mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. An example of a radiating patch antenna 538 is included in this illustration for the purpose of showing that attachment of the package to a PC board using this method can be compatible with the high-frequency signal radiating or coupling feature, even when that feature is on the bottom side of the package. In this example, the antenna patch 538 can radiate through a cutout 576 in the PC board material 580 creating a transmission window. The features shown are for illustration purposes only, and are not meant as a limitation. Variations of the ideas presented can be implemented by one skilled in the art without departing from the spirit of the present invention.

A vertical pin-lead interconnect means is illustrated in FIGS. 33A-B as a further embodiment of the mechanically stress-relieved package substrate external interconnect means 545. In this arrangement, a vertical metal pin interconnect means 522 is attached to a package carrier 598 forming a package lead. The attachment method can comprise, but is not limited to, a glass-in firing process or a brazing process. A substrate 516 is attached to the package carrier 598. The attachment method can comprise, but is not limited to, epoxy attach. The leads 522 are through-hole attached to an external printed circuit (PC) board 580 using, for example, solder. The vertical configuration of the pin leads allow mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. An example of a radiating patch antenna 538 is included in this illustration for the purpose of showing that attachment of the package to a PC board using this method can be compatible with the high-frequency signal radiating or coupling feature, even when that feature is on the bottom side of the package. In this example, metal circuitry patterns in the PC board 580 are kept out of an area shown by 576 so that the antenna-patch 538 can radiate through the PC board dielectric material 580 creating a dielectric transmission window. The features shown are for illustration purposes only, and are not meant as a limitation. Variations of the ideas presented can be implemented by one skilled in the art without departing from the spirit of the present invention.

A vertical pin grid-array interconnect means is illustrated in FIGS. 34A-B as a further embodiment of the mechanically stress-relieved package substrate external interconnect means 545. In this arrangement, an array of vertical metal pin interconnect means 578 is attached to the bottom side of substrate 516. The attachment method can comprise, but is not limited to, a brazing process. The leads 578 are through-hole attached to an external printed circuit (PC) board 580 using, for example, solder. The vertical configuration of the pin leads allow mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. An example of a radiating patch antenna 538 is included in this illustration for the purpose of showing that attachment of the package to a PC board using this method can be compatible with the high-frequency signal radiating or coupling feature, even when that feature is on the bottom side of the package. In this example, metal circuitry patterns in the PC board 580 are kept out of an area shown by 576 so that the antenna patch 538 can radiate through the PC board dielectric material 580 creating a dielectric transmission window. The features shown are for illustration purposes only, and are not meant as a limitation. Variations of the ideas presented can be implemented by one skilled in the art without departing from the spirit of the present invention.

A wire interconnect means is illustrated in FIGS. 35A-B as another embodiment of the mechanically stress-relieved package substrate external interconnect means 545. In this arrangement, a wire interconnect means 591 is attached to substrate 516 forming a package interconnect lead. The attachment method can comprise, but is not limited to, soldering or gap-welding. The wires 591 are attached to metal pads on an external printed circuit (PC) board 580 using, for example, solder. The shape of the wire leads allows mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. An example of a radiating patch antenna 538 is included in this illustration for the purpose of showing that attachment of the package to a PC board using this method can be compatible with the high-frequency signal radiating or coupling feature, even when that feature is on the bottom side of the package. In this example, the antenna patch 538 can radiate through a cutout 576 in the PC board material 580 creating a transmission window. The features shown are for illustration purposes only, and are not meant as a limitation. Variations of the ideas presented can be implemented by one skilled in the art without departing from the spirit of the present invention.

An interconnect means is illustrated in FIGS. 36A-B as a further embodiment of the mechanically stress-relieved package substrate external interconnect means 545. In this arrangement, a flexible circuit 443 containing a pattern of conductive elements 442 is attached to connectors 448 each containing a plurality of electrical contacts. The flexible circuit 443 can comprise, but is not limited to, polyimide or Kapton materials in a single or multi-layer structure, and may comprise electrically conductive vias. The conductive elements 442 can comprise, but are not limited to, copper, plated copper, copper tungsten, or gold. Substrate 516 contains a plurality of brazed pins 578 which provide electrical contacts for external connections. On the external circuit board 580 are a plurality of electrical contact pins 459. The electrical contact pins 459 may be separate contacts or may be contained in a connector. The attachment method of the contact pins 459 to the external circuit board 580 can comprise, but is not limited to, soldering. The flexible nature of the flex circuit 443 allows mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. An example of an EM coupling structure 539 is included in this illustration for the purpose of showing that attachment of the package to a PC board using this method can be compatible with the high-frequency signal radiating or coupling feature, even when that feature is on the bottom side of the package. In this example, the EM coupling structure 539 is coupled to a waveguide 419 in a waveguide feed network structure 436. The features shown are for illustration purposes only, and are not meant as a limitation. One variation of the configuration shown is to use a multiple conductor ribbon cable instead of a flex circuit arrangement. Another variation of the configuration shown is to use individual wires to connect the connector electrical contacts instead of a multi-conductor flex circuit, or to use individual wires to individual electrical contacts instead of electrical contacts within a connector. Other variations of the ideas presented can be implemented by one skilled in the art without departing from the spirit of the present invention.

An interconnect means is illustrated in FIGS. 36C-D as a yet further embodiment of the mechanically stress-relieved package substrate external interconnect means 545. In this arrangement, a flexible circuit 443 containing a pattern of conductive elements 442 is attached to metal contacts 433 on the substrate 516 and metal contacts 434 the external circuit board 580. The flexible circuit 443 can comprise, but is not limited to, polyimide or Kapton materials in a single or multi-layer structure, and may comprise electrically conductive vias. The conductive elements 442 can comprise, but are not limited to, copper, plated copper, copper tungsten, or gold. The attachment method of the flexible circuit 443 to the metal contacts 433, 434 can comprise, but is not limited to, soldering, eutectic bonding, or thermal-compression bonding. The flexible nature of the flex circuit 443 allows mechanical flexibility when this configuration is subjected to thermal excursions, which helps to relieve mechanical stresses due to differences in the coefficient of thermal expansion (CTE) between the substrate 516 material and the PC board 580 material, resulting in high reliability of the attachment method. One benefit of the arrangement shown, not meant as a limitation, is that the flexible circuit can support high-frequency signal transmission if microwave signal transmission line arrangements, such as, but not limited to, coplanar waveguide or strip-line arrangements, are utilized. An example of an EM coupling structure 539 is included in this illustration for the purpose of showing that attachment of the package to a PC board using this method can be compatible with the high-frequency signal radiating or coupling feature, even when that feature is on the bottom side of the package. In this example, the EM coupling structure 539 is coupled to a waveguide 419 in a waveguide feed network structure 436. The features shown are for illustration purposes only, and are not meant as a limitation. One variation of the configuration shown is to use a multiple conductor ribbon cable instead of a flex circuit arrangement. Other variations of the ideas presented can be implemented by one skilled in the art without departing from the spirit of the present invention.

FIGS. 37A-B illustrate one example of an IC package method and attachment means to an external circuit board in accordance with aspects of the present invention. An integrated circuit package contains a substrate 516 onto which an integrated circuit die 524 is attached using, for example, flip-chip mounting and underfill 531, and utilizes a mechanically stress-relieved external interconnect method comprised of, for example, soldered wires 591. The integrated circuit package also contains an integrated EM signal coupling port 595 with a structure similar to that illustrated in FIGS. 29A-C or 29D-F, which couples to a similar structure 572 on the external circuit board 580 with electrical contact provided by an electrically conductive interface material 593. The electrically conductive interface material can be eliminated if good electrical contact can be ensured between the signal coupling structures. The integrated circuit package is mechanically attached to the external circuit board 580 using, for example, pressure clip attachment means 569. The features shown are for illustration purposes only, and are not meant as a limitation. Other variations of the ideas presented can be implemented by one skilled in the art without departing from the spirit of the present invention.

A package cover arrangement and method is illustrated in FIGS. 38A-B as one embodiment of the package cover means 550. In this arrangement, a one-piece package cover 597 is attached to the substrate 516. The cover 597 is attached to the substrate using an attachment material 554. The attachment material can comprise, but is not limited to, conductive or non-conductive epoxy, conductive or non-conductive film, or solder. The method of attaching the cover to the substrate can include, but is not limited to, dispense of epoxy and cure, attachment of film and cure, attachment of film and cure with pressure applied to cover during cure, or solder reflow. The cover material can comprise, but is not limited to, metal, metal alloy, ceramic, laminate, LTCC, HTCC, HiTCE LTCC, graphite, thermoplastic, or plastic. The cover shape may be modified by one skilled in the art without departing from the spirit of the present invention. The cover can optionally be attached to the integrated circuit die 524 in addition, using an attachment material 552. The attachment of the cover to the integrated circuit die is optional, and is not required. One benefit to the attachment of the cover to the integrated circuit die 524 is the ability to use the cover as an electrical connection and/or package heat extraction means, under the conditions that the cover is constructed of the proper material to realize these benefits. The mounting method shown of the integrated circuit die to the substrate using a flip-chip means is only for illustration purposes only, and is not meant as a restriction. The integrated circuit die 524 may also be attached using, but not limited to, epoxy die attach 533 and a wire-bond method as illustrated in FIGS. 38G-H.

A package cover arrangement and method is illustrated in FIGS. 38C-D as one embodiment of the package cover means 550. In this arrangement, a two-piece package cover method comprising a lid 594 and seal ring 592 are utilized to cover the substrate 516. The seal ring feature 592 may be an integral part of the substrate 516 and be composed of the same material as the substrate 516, or may be a separate piece attached to the substrate 516. The seal ring material can comprise, but is not limited to, metal, metal alloy, ceramic, laminate, LTCC, HTCC, HiTCE LTCC, graphite, thermo-plastic, or plastic. The seal ring 592 can be attached to substrate 516 using a material comprising, but not limited to, conductive or non-conductive epoxy, conductive or non-conductive film, solder, eutectic alloy, or metal or alloy brazing material. The lid 594 may contain a feature such as, but not limited to, a thinned periphery or raised rim for the purpose of, but not limited to, aiding in lid centering, improvement in the seam or laser welding sealing process, or weight reduction without departing from the spirit of the present invention. The lid 594 can be attached to the seal ring 592 using, but not limited to, conductive or non-conductive epoxy, conductive or non-conductive film, solder, eutectic alloy, metal or alloy brazing material, seam welding process, or laser welding process. The lid material can comprise, but is not limited to, metal, metal alloy, ceramic, laminate, LTCC, HTCC, HiTCE LTCC, graphite, thermo-plastic, or plastic. The shape of the lid and seal ring may be modified by one skilled in the art without departing from the spirit of the present invention. The lid 594 can optionally be attached to the integrated circuit die 524 in addition, using an attachment material 552. The attachment of the lid to the integrated circuit die is optional, and is not required. One benefit to the attachment of the lid to the integrated circuit die 524 is the ability to use the lid as an electrical connection and/or package heat extraction means, under the conditions that the lid is constructed of the proper material to realize these benefits. Furthermore, a plurality of seal-rings, or a seal ring with a plurality of cavities can be used to create a plurality of isolated cavities in which die or circuitry can be mounted. The mounting method shown of the integrated circuit die to the substrate using a flip-chip means is only for illustration purposes only, and is not meant as a restriction. The integrated circuit die may also be attached using, but not limited to, a wire-bond method.

A package cover arrangement and method is illustrated in FIGS. 38E-F as one embodiment of the package cover means 550. In this arrangement, the cover method comprises a lid 599 that is attached to the surface of a single or plurality of integrated circuit die 524 using a lid attachment means 552. The lid material can comprise, but is not limited to, metal, metal alloy, ceramic, laminate, LTCC, HTCC, HiTCE LTCC, graphite, thermo-plastic, plastic, or eutectic alloy. The lid 599 can be attached to the surface of the die 524 using a material comprising, but not limited to, conductive or non-conductive epoxy, conductive or non-conductive film, solder, or eutectic alloy. The lid 594 may contain a feature such as, but not limited to, a raised rim for the purpose of, but not limited to, aiding in lid centering without departing from the spirit of the present invention. The mounting method shown of the integrated circuit die to the substrate using a flip-chip means is only for illustration purposes only, and is not meant as a restriction.

A package cover arrangement and method is illustrated in FIGS. 38I-J as one embodiment of the package cover means 550. In this arrangement, a package cover 597a is attached to the substrate 516 such that it creates a plurality of cavities. The cover 597a is attached to the substrate using an attachment material 554. The attachment material can comprise, but is not limited to, conductive or non-conductive epoxy, conductive or non-conductive film, or solder. The method of attaching the cover to the substrate can include, but is not limited to, dispense of epoxy and cure, attachment of film and cure, attachment of film and cure with pressure applied to cover during cure, or solder reflow. The cover material can comprise, but is not limited to, metal, metal alloy, ceramic, laminate, LTCC, HTCC, HiTCE LTCC, graphite, thermo-plastic, or plastic. The cover shape may be modified by one skilled in the art without departing from the spirit of the present invention. One benefit of the creation of a plurality of cavities is to provide isolation between integrated circuit die 524a, 524b. The cover can also optionally be attached to one or a plurality of integrated circuit die 524a, 524b using an attachment material 552. The attachment of the cover to the integrated circuit die is optional, and is not required. One benefit to the attachment of the cover to the integrated circuit die is the ability to use the cover as an electrical connection and/or package heat extraction means, under the conditions that the cover is constructed of the proper material to realize these benefits. The mounting method shown of the integrated circuit die to the substrate using a flip-chip means is only for illustration purposes only, and is not meant as a restriction. The integrated circuit die may also be attached using, but not limited to, epoxy die attach and a wire-bond method.

A package cover arrangement and method is illustrated in FIGS. 38K-L as one embodiment of the package cover means 550. In this arrangement, a plurality of package covers 597b, 597c are attached to the substrate 516 such that a plurality of cavities are created. The covers 597b, 597c are attached to the substrate using an attachment material 554. The attachment material can comprise, but is not limited to, conductive or non-conductive epoxy, conductive or non-conductive film, or solder. The method of attaching the cover to the substrate can include, but is not limited to, dispense of epoxy and cure, attachment of film and cure, attachment of film and cure with pressure applied to cover during cure, or solder reflow. The cover material can comprise, but is not limited to, metal, metal alloy, ceramic, laminate, LTCC, HTCC, HiTCE LTCC, graphite, thermo-plastic, or plastic. The shape of the covers may be modified by one skilled in the art without departing from the spirit of the present invention. One benefit of the creation of a plurality of cavities is to provide isolation between integrated circuit die 524a, 524b. The covers can also optionally be attached to one or a plurality of integrated circuit die 524a, 524b using an attachment material 552. The attachment of the cover to the integrated circuit die is optional, and is not required. One benefit to the attachment of the cover to the integrated circuit die is the ability to use the cover as an electrical connection and/or package heat extraction means, under the conditions that the cover is constructed of the proper material to realize these benefits. The mounting method shown of the integrated circuit die to the substrate using a flip-chip means is only for illustration purposes only, and is not meant as a restriction. The integrated circuit die may also be attached using, but not limited to, epoxy die attach and a wire-bond method.

An example of an integrated circuit packaging means and external interconnection method using some of the aforementioned aspects of the present invention is illustrated in FIGS. 39A-B. The arrangement and method described is for illustration purposes and is not meant as a restriction. In this arrangement, an integrated circuit die 524 is mounted to a substrate 516 using a flip-chip mounting method with solder bumps 573. On the top surface of the substrate are patterned metal pads 547 onto which the flip-chip solder bumps are attached. An underfill material 531 is dispensed between the die 524 and the substrate 516. A package cover 597 is attached to metal pads 544 on the surface of substrate 516 using a dispensed electrically conductive epoxy attachment means 554 and is also attached to the surface of the integrated circuit die 524 using a dispensed thermally conductive epoxy attachment means 552. The lid is constructed of an electrically and thermally conductive metal or metal alloy. The substrate 516 is constructed of a plurality of dielectric and metal layers using a thick-film alumina process with filled, metallized vias. The bottom-side of the substrate 516 is patterned with an array of metal antenna patches 538 for electro-magnetic signal coupling to an external beam-sharpening means. Metal leads 542 are brazed onto substrate metal pads 527. The top surface of circuit board 580 is patterned with metal pads 537 onto which the lead-formed metal leads 542 from substrate 516 will be attached using solder. The gull-wing shape of the leads will relieve stress related to the difference in coefficient of thermal expansion (CTE) between the alumina package and circuit board, leading to high reliability. The features shown are for illustration purposes only, and are not meant as a limitation. Variations of the ideas presented can be implemented by one skilled in the art without departing from the spirit of the present invention.

Another example of an integrated circuit packaging means and external interconnection method using some of the aforementioned aspects of the present invention is illustrated in FIGS. 40A-B. The arrangement and method described is for illustration purposes and is not meant as a restriction. In this arrangement, an integrated circuit die 524 is mounted to a substrate 516 using a flip-chip mounting method with solder bumps. On the top surface of the substrate are patterned metal pads onto which the flip-chip solder bumps are attached. An underfill material is dispensed between the die 524 and the substrate 516. A package cover 597 is attached to metal pads on the surface of substrate 516 using a dispensed electrically conductive epoxy attachment means 554 and is also attached to the surface of the integrated circuit die 524 using a dispensed thermally conductive epoxy attachment means 552. The lid is constructed of an electrically and thermally conductive metal or metal alloy. The substrate 516 is constructed of a plurality of dielectric and patterned metal layers using a thick or thin-film alumina process with filled, metallized vias. The bottom-side of the substrate 516 is patterned with a plurality of waveguide signal coupling ports 596 for electromagnetic signal coupling to an external waveguide feed network 435. The external waveguide feed network 435 can be an individual component or part of an antenna assembly. The substrate 516 is mechanically attached to the waveguide feed network 435 using metal attachment clips 569 and screws 514, or any other suitable mechanical attachment means, which compress an electrically conductive interface material 593 between the bottom side of substrate 516 and the waveguide feed network 435, for the purpose of aiding with the coupling of signals to waveguides 421. The interface material 593 can be eliminated if good electrical contact can be ensured between the substrate 516 and waveguide feed network 435. The external circuit board 580 is mechanically attached to the waveguide feed network 435 using screws 512 and washers 513, or any other suitable mechanical attachment method. Metal wires or leads 591 connect metal pads on substrate 516 to metal pads on external circuit board 580 and can be attached using, for example, solder. The shape of the wires or leads will relieve stress related to the difference in coefficient of thermal expansion (CTE) between the alumina package and circuit board, leading to high reliability. The features shown are for illustration purposes only, and are not meant as a limitation. Variations of the ideas presented can be implemented by one skilled in the art without departing from the spirit of the present invention. Variations such as, but not limited to, the number of die, number and type of coupling structures, number and method of external package interconnection means, number of cover cavities, cover electrical and thermal properties, package mechanical attachment method, waveguide feed network shape, and package shape can be implemented without departing from the spirit of the present invention.

A further example of an integrated circuit packaging means and external interconnection method using some of the aforementioned aspects of the present invention is illustrated in FIGS. 40C-D. The arrangement and method described is for illustration purposes and is not meant as a restriction. This arrangement is similar to the arrangement shown in FIGS. 40A-B except for the implementation of an epoxy die attach and wire-bond IC connection method, as well as the use of a thermal interface material 486 to facilitate heat extraction from the package to a waveguide feed network plate 452a. The same components are denoted by the same reference numerals, and will not be explained again. In this arrangement, the heat generated from the die 524 is conducted through the package substrate underneath the die, and a thermal interface material 486 is used to conduct the heat to a thermally and electrically conductive, waveguide feed network plate 452a. The waveguide feed network plate contains signal waveguides 421 a which are used to couple to high frequency signal EM coupling ports 595 on the package substrate 516. In this configuration, the waveguide feed network plate 452a can be utilized as a heat-sink for the IC package as well as a high-frequency signal coupling and distribution means. Variations such as, but not limited to,.the number of die, number and type of coupling structures, number and method of external package interconnection means, number of cover cavities, cover electrical and thermal properties, package mechanical attachment method, waveguide feed network plate shape, and package shape can be implemented without departing from the spirit of the present invention.

A yet further example of an integrated circuit packaging means and external interconnection method using some of the aforementioned aspects of the present invention is illustrated in FIGS. 40E-F. The arrangement and method described is for illustration purposes and is not meant as a restriction. This arrangement is similar to the arrangements shown in FIGS. 40A-D except that a plurality of integrated circuit die 524a-c are flip-chip attached to the same side of the package substrate as the EM signal coupling ports 595a, and that a package cover means 597a is contacted by a thermal interface material 486 to facilitate heat extraction from the package to a waveguide feed network plate 452b. The same components are denoted by the same reference numerals, and will not be explained again. In this arrangement, the heat generated from the integrated circuit die 524a-c is conducted to a thermally and electrically conductive cover 597a through an epoxy attachment material 552. A thermal interface material 486 is used to conduct the heat from the cover 597a to a thermally and electrically conductive waveguide feed network plate 452b. The waveguide feed network plate contains signal waveguides 421 a which are used to couple to high-frequency signal EM coupling ports 595a on the package substrate 516. In this configuration, the waveguide feed network plate 452b can be utilized as a heat-sink for the IC package as well as a high frequency signal coupling and distribution means. Variations such as, but not limited to, the number of die, number and type of coupling structures, number and method of external package interconnection means, number of cover cavities, cover electrical and thermal properties, package mechanical attachment method, waveguide feed network plate shape, and package shape can be implemented without departing from the spirit of the present invention.

Another example of an integrated circuit packaging means and external interconnection method using some of the aforementioned aspects of the present invention is illustrated in FIGS. 40G-H. The arrangement and method described is for illustration purposes and is not meant as a restriction. This arrangement is similar to the arrangement shown in FIGS. 40E-F except for the elimination of the cover means 597a. The same components are denoted by the same reference numerals, and will not be explained again. In this arrangement, the heat generated from the integrated circuit die 524a-c is conducted through a thermal interface material 486 to the waveguide feed network plate 452c. The waveguide feed network plate 452c contains recessed features 482 into which the die protrude when the package is mechanically attached. The recessed features can be used in conjunction with a metallization pattern 490 on the substrate 516 to provide isolation around one or a plurality of the integrated circuit die. The waveguide feed network plate contains signal waveguides 421a which are used to couple to high-frequency signal EM coupling ports 595a on the package substrate 516. In this configuration, the waveguide feed network plate 452c can be utilized as a heat-sink for the IC package as well as a high frequency signal coupling and distribution means. Variations such as, but not limited to, the number of die, number and type of coupling structures, number and method of external package interconnection means, number of recessed die cavities in the waveguide feed network plate, elimination of electrically conductive interface material 593, shape or use of metallization pattern 490, package mechanical attachment method, waveguide feed network plate shape, and package shape can be implemented without departing from the spirit of the present invention.

FIG. 41A illustrates one embodiment of the beam sharpening means 301. A multi-port feed network 407 is connected to a transmit/receive beam aperture 412 such that a plurality of transmit/receive beam positions, or antenna gain patterns, are created over an angular radar imaging region. The multi-port feed network 407 may comprise, but is not limited to, a waveguide feed network containing a plurality of waveguides, or a planar arrangement of a plurality of signal radiating means. The transmit/receive beam aperture 412 may comprise, but is not limited to, a dielectric lens, a metal lens, a reflector antenna, a twist-reflector antenna, a plurality of dielectric lenses, a plurality of metal lenses, a plurality of reflector antennas, a plurality of twist-reflector antennas, or a combination of any of these elements.

FIG. 41B illustrates one embodiment of a quasi-optical beam sharpening means 302. A multi-port feed network 407 is connected to a dielectric lens system 417 such that a plurality of transmit/receive beam positions, or antenna gain patterns, are created over an angular radar imaging region. The multi-port feed network 407 may comprise, but is not limited to, a waveguide feed network containing a plurality of waveguides, or a planar arrangement of a plurality of signal radiating means. The dielectric lens system 417 may comprise, but is not limited to, a dielectric lens or a plurality of dielectric lenses.

FIG. 41C illustrates one embodiment of a quasi-optical beam sharpening means with waveguide feeds 303. A multi-port waveguide feed network 409 is connected to a dielectric lens system 417 such that a plurality of transmit/receive beam positions, or antenna gain patterns, are created over an angular radar imaging region. The multi-port waveguide feed network 409 may comprise, but is not limited to, a waveguide feed network containing a plurality of waveguides. The dielectric lens system 417 may comprise, but is not limited to, a dielectric lens or a plurality of dielectric lenses.

FIG. 41D illustrates one embodiment of a reflector antenna with waveguide feeds 304. A multi-port waveguide feed network 409 is connected to a transmit/receive reflector antenna 420 such that a plurality of transmit/receive beam positions, or antenna gain patterns, are created over an angular radar imaging region. The multi-port waveguide feed network 409 may comprise, but is not limited to, a waveguide feed network containing a plurality of waveguides. The transmit/receive reflector antenna 420 may comprise, but is not limited to, a reflector antenna, a twist-reflector antenna, a plurality of reflector antennas, a plurality of twist-reflector antennas, or a combination of any of these elements. Although the multi-port waveguide feed network 409 is shown as a separate block, it may be integrated as a part of the transmit/receive reflector antenna without departing from the present invention. Furthermore, part of the waveguide feed network may be integrated into the transmit/receive reflector antenna and part of the waveguide feed network may be in one or a plurality of separate units that get assembled to create the overall antenna and feed network system without departing from the present invention.

FIG. 42A illustrates one embodiment of a beam-sharpening means 301 according to aspects of the present invention. A multi-port feed network 410 with feed apertures 477 illuminate a dielectric lens 405 creating a plurality of transmit/receive beam positions. Geometric optics rays 431 are shown to illustrate that the dielectric lens 405 will sharpen the incoming signal radiation into a beam for transmit or receive application. The ultimate performance of the lens system and resulting beam-width depends on many factors including, but not limited to, lens surface shape, illumination radiation pattern and edge taper, diameter of dielectric lens, material of dielectric lens, and spatial offset positions of feed apertures 477. The multi-port feed network 410 can be, but is not limited to, a multi-port waveguide feed network or multi-element arrangement of signal radiation elements. The feed apertures 477 can be, but are not limited to, waveguide feed apertures or openings, or signal radiation elements such as patch antennas.

FIG. 42B illustrates another embodiment of a beam-sharpening means 301 according to aspects of the present invention. A multi-port feed network 410 with feed apertures 477 illuminate a pre-focusing dielectric lens 415 which in turn illuminates a dielectric lens 405, creating a plurality of transmit/receive beam positions. Geometric optics rays 431 are shown to illustrate that the dielectric lens 405 will sharpen the incoming signal radiation into a beam for transmit or receive application. One use of a pre-focusing lens 415 is to shape the signal radiation illumination pattern seen at the output dielectric lens 405 for attaining specific output beam performance. The pre-focusing element does not have to be restricted to a single lens, but rather it function can be implemented by, but not limited to, multiple dielectric elements such as dielectric lenses, dielectric rods, dielectric cones, or individual elements for each feed aperture 477. The ultimate performance of the lens system and resulting beam-width depends on many factors including, but not limited to, lens surface shape, illumination radiation pattern and edge taper, diameter of dielectric lens, material of dielectric lens, and spatial offset positions of feed apertures 477. The multi-port feed network 410 can be, but is not limited to, a multi-port waveguide feed network or multi-element arrangement of signal radiation elements. The feed apertures 477 can be, but are not limited to, waveguide feed apertures or openings, or signal radiation elements such as patch antennas.

FIG. 42C illustrates a method of transmit/receive beam angular position steering according to aspects of the present invention. A multi-port feed network 410 with feed apertures 477 illuminate a dielectric lens 405 creating a plurality of transmit/receive beam positions. The positions of the feed apertures 477 are laterally spatially separated in a direction perpendicular to principle axis of the dielectric lens as shown. Geometric optics rays 431 are shown to illustrate that the dielectric lens 405 will sharpen the incoming signal radiation from a spatially offset feed aperture location and direct it into a steered output beam f6r transmit or receive application. This method can be used to create different angular transmit/receive beam positions corresponding to each feed aperture position, and beam scanning can be achieved by selectively switching between feed ports. This method can be applied to both configurations shown in FIGS. 42A-B. The ultimate performance of the lens system and resulting beam-width depends on many factors including, but not limited to, lens surface shape, illumination radiation pattern and edge taper, diameter of dielectric lens, material of dielectric lens, and spatial offset positions of feed apertures 477. The multi-port feed network 410 can be, but is not limited to, a multi-port waveguide feed network or multi-element arrangement of signal radiation elements. The feed apertures 477 can be, but are not limited to, waveguide feed apertures or openings, or signal radiation elements such as patch antennas.

FIG. 43 illustrates one embodiment of a multi-port feed network 407 according to aspects of the present invention. This arrangement can also be used as one embodiment of multi-port feed network 410 and feed elements 477. A planar arrangement of antenna radiating elements or coupling ports 538 are integrated on a substrate 516, in which the antenna elements or coupling ports are spatially separated from one another in one or more planar axes, is used as an arrangement of a multi-port feed network. In this arrangement, each antenna radiating means or coupling port 538 can be used as a feed element 477, or feed port. The antenna feed ports 538 are spatially separated from one another by some distance □X, which can vary between different antenna feed port pairs. The arrangement of the feed ports 538 is not restricted to one axis and is not restricted to be co-linear, only that spatial separation exists between antenna feed ports 538 for the purpose of beam-steering the transmit/receive beam from the transmit/receive beam aperture the feed network is used in conjunction with. The aforementioned transmit/receive beam aperture can be, but is not restricted to, a single or plurality of dielectric lenses, a single reflector antenna with multiple feeds, a single twist reflector antenna with multiple feeds, or a plurality of reflector or twist-reflector antennas. This arrangement can be part of an integrated IC package substrate, either integrated on the same side of the substrate 516 as the die are attached, or on the opposite side of the substrate 516 as the die are attached. The feed ports 538 can be electrically fed signals through, but not limited to, aperture coupling, microstrip or coplanar feeds, signal vias, quasi-coaxial feed arrangement using vias, microstrip or coplanar fed waveguide ports. The feed ports 538 can also be arranged in array groups each containing a plurality of individual antenna elements, where each array group can be considered a single feed element or port, according to aspects of the present invention. Furthermore, the feed port means 538 can be, but are not limited to, patch antennas, slot antennas, quasi-yagi antennas, microstrip antennas, planar antennas, or waveguide coupling ports.

FIGS. 44A-B illustrate another embodiment of a multi-port feed network 407 according to aspects of the present invention. This arrangement can also be used as one embodiment of multi-port feed network 410 and feed elements 477, or as one embodiment of multi-port waveguide feed network 409. In this arrangement, an electrically conductive multi-port waveguide feed network 435 contains a plurality of individual waveguide feeds 421, 423. The waveguide feeds 421, 423 are spatially separated from one another by some distance □X, which can vary between different waveguide feed pairs. The arrangement of the waveguide feeds 421, 423 is not restricted to one axis and is not restricted to be co-linear, only that spatial separation exists between waveguide openings for the purpose of beam-steering the transmit/receive beam from the transmit/receive beam aperture the feed network is used in conjunction with. The waveguide open ends can also be arranged such that there exists a vertical spatial separation □Y that can assist in positioning the feed ends at optimal locations for beam-sharpening, such as at the off-axis focal points of a dielectric lens beam-sharpener. Also, the individual waveguide feeds 421, 423 can each be generally straight or shaped to direct the feed radiation for advantage. The aforementioned transmit/receive beam aperture can be, but is not restricted to, a single or plurality of dielectric lenses, a single reflector antenna with multiple feeds, a single twist reflector antenna with multiple feeds, or a plurality of reflector or twist-reflector antennas. One way signals can be interface from the IC package substrate to-the waveguide feed network 435, not meant in any way as a limitation, is illustrated in FIGS. 40A-B where multiple waveguide coupling ports are integrated into the package substrate 516 and interfaced with the waveguide feed network 435.

FIGS. 45A-D illustrate various dielectric lens configurations as embodiments of a transmit/receive beam aperture 412 according to aspects of the present invention. These dielectric lens arrangements can also be used as embodiments of the dielectric lens system 417, and embodiments of lens elements 405 or 415. FIG. 45A illustrates a plano-convex dielectric lens 440, with a material dielectric constant greater than 1, in which a generally flat lens surface is directed towards a feed network, and a generally convex lens surface is directed towards the radar imaging area. One arrangement utilizing this configuration of lens, not meant in any way as a limitation, shapes the convex surface with a hyperbolic contour, and places the radiating elements of the feed network at the on-axis and off-axis focal points of the lens. In that arrangement, the spherical waves from the feed elements are transformed to generally planar waves and can achieve narrow beam-widths inversely proportional to the lens aperture diameter. FIG. 45B illustrates a piano-convex dielectric lens 445, with a material dielectric constant greater than 1, in which a generally convex lens surface is directed towards a feed network, and a generally flat lens surface is directed towards the radar imaging area. One arrangement utilizing this configuration of lens, not meant in any way as a limitation, places the radiating elements of the feed network at the on-axis and off-axis focal points of the lens. In that arrangement, the spherical waves from the feed elements are transformed to generally planar waves and can achieve narrow beam-widths inversely proportional to the lens aperture diameter. FIG. 45C illustrates a convex-convex dielectric lens 405, with a material dielectric constant greater than 1, in which a generally convex lens surface is directed towards a feed network, and a generally convex lens surface is directed towards the radar imaging area. One arrangement utilizing this configuration of lens, not meant in any way as a limitation, places the radiating elements of the feed network at the on-axis and off-axis focal points of the lens. In that arrangement, the spherical waves from the feed elements are transformed to generally planar waves and can achieve narrow beam-widths inversely proportional to the lens aperture diameter. FIG. 45D illustrates a concave-convex dielectric lens 450, with a material dielectric constant greater than 1, in which a generally concave lens surface is directed towards a feed network, and a generally convex lens surface is directed towards the radar imaging area. One advantage of this arrangement allows improvement of the output beam characteristics, such as beam-width or sidelobe levels, corresponding to off-axis feed element positions for the purpose of improving the beam-scanning performance of the lens for switched feed architectures.

FIGS. 45E-F illustrate dielectric lens zoning techniques in accordance with aspects of the present invention. FIG. 45E shows a zoning technique applied to the plano-convex dielectric lens 455 illustrated in FIG. 45A, for the purpose of lens weight and/or volume reduction. The surfaces of the lens step in thickness such that phase paths of the electromagnetic signals through the lens cause the output generally planar wavefronts exiting the lens to be in-phase with each other. FIG. 45F shows a zoning technique applied to the plano-convex dielectric lens 460 illustrated in FIG. 45B, for the purpose of lens weight and/or volume reduction. The surfaces of the lens step in thickness such that phase paths of the electromagnetic signals through the lens cause the output generally planar wavefronts exiting the lens to be in-phase with each other.

FIG. 46A illustrates a dielectric lens configuration as one embodiment of a pre-focus lens 415 according to aspects of the present invention. This dielectric lens can also be used as one element in the dielectric lens system 417. FIG. 46A illustrates a plano-concave dielectric lens 437, with a material dielectric constant greater than 1, in which a generally flat lens surface is directed towards a feed network, and a generally concave lens surface is directed towards a second dielectric lens transmit/receive beam aperture. One purpose of this lens, not meant as a limitation, can be to improve the radiation illumination characteristics of the feed elements onto the transmit/receive beam aperture lens. Another purpose of this lens, not meant as a limitation, can be to modify the apparent distance of the feed element radiation source to the transmit/receive beam aperture lens, in order to optimize transmit beam performance. This concept is illustrated in FIG. 46B, where feed elements radiate from positions F1 and F2. Due to the diverging nature of lens 437, as evidenced by geometric optics ray paths 488, the emerging radiation wavefronts from lens 437 appear to have been generated by feed elements originating at locations F1′ and F2′. Using this concept, lens 437 can help transform the positions of planar feed elements, such as shown in FIG. 43, to apparent positions which may be used for advantage by one skilled in the art in optimizing output beam scanning performance.

FIGS. 47A-D illustrate a waveguide fed twist-reflector antenna arrangement as one embodiment of transmit/receive beam aperture 412, as one embodiment of transmit/receive reflector antenna 420, as one embodiment of beam sharpening means 301, and as one embodiment of reflector antenna with waveguide feeds 304 according to aspects of the present invention. FIG. 47A illustrates the top view of a twist-reflector antenna with waveguide feeds arrangement known to those skilled in the art. The arrangement consists of an antenna body 470 containing an electrically conductive antenna surface 492 fed by electrically conductive waveguides 425, 427 that can each be generally straight or shaped to direct the feed radiation for advantage. The waveguide feeds 425, 427 are spatially separated from one another by some distance □X, which can vary between different waveguide feed pairs. The arrangement of the waveguide feeds 425, 427 is not restricted to one axis and is not restricted to be co-linear, only that spatial separation exists between waveguide openings for the purpose of beam-steering the transmit/receive beam from the antenna arrangement. The basic operation of this twist-reflector antenna arrangement is illustrated in FIG. 47D. Polarized signal radiation is emitted from the open end of waveguide feed 427 with path directions as indicated by the rays 494. A cover 472 with a polarization orthogonal to the emitted radiation polarization from the waveguide feeds reflects the signal radiation back towards the antenna surface 492. The antenna surface 492 is electrically conductive and reflects the signal radiation back towards the cover 472. However, the antenna surface contains features such as, but not limited to, grooves, which change the polarization of the reflected signal radiation such that it is transmitted through the cover 472 towards the radar imaging region. Due to the transmitting and reflecting properties of the cover 472 depending on signal polarization, a flat plate or cover having these properties will be termed a “trans-reflecting cover” for clarity. The antenna body 470 with waveguide feeds and antenna surface can be manufactured using low cost techniques. One technique, not meant in any way as a limitation, is to use injection molding for fabrication, using, for example, metallized injection molded plastics or injection molded metals or metal compounds. The integrated waveguide feeds can represent the entire feed network for this antenna, or they can be fed by a separate feed network or feed distribution means.

FIGS. 48A-C illustrate a waveguide feed distribution means 479 as one embodiment of a multi-port waveguide feed network 409, or as one embodiment of a multi-port feed network 407. Waveguide feed distribution means 479 uses a plurality of electrically conductive waveguide routing slots 462, 464, 466 in order to connect signal source and destination physical locations that are different from one another. One example of the functionality of feed distribution means 479, not meant in any way as a limitation, uses waveguide routing slots 462, 464, 466 to connect to waveguide feed openings 425, 427 in the back of antenna body 470, and route them to new locations where they can be interfaced to signal coupling means on the bottom side of feed distribution means 479 as illustrated in FIG. 48C. One advantage of using waveguide feed distribution means 479 is that the antenna waveguide feed locations can be optimized separately from the signal coupling port locations of, for example, a package substrate. The waveguide distribution means 479 can be manufactured using low cost techniques. One technique, not meant in any way as a limitation, is to use injection molding for fabrication, using, for example, metallized injection molded plastics or injection molded metals or metal compounds.

FIG. 49A illustrates one embodiment of beam sharpening means 301. In this arrangement, a plurality of high-frequency input/output (HFIO) signal ports are fed to arrays of planar antenna elements 480 on a high-frequency substrate or printed circuit board 496 which are used to sharpen or narrow the transmit/receive beam-width. One way the HFIO signals can be coupled to the substrate or printed circuit board 496 from the high frequency integrated circuit package is through the EM signal coupling method illustrated in FIGS. 37A-B. The antenna arrays are shown with n elements by m columns, where n and m are integers greater than or equal to 2. The integers n and m do not need to be equal, and each antenna array can have independent values for n and m. Each antenna array can be designed such that they are directed at different angles towards the radar imaging region. By switching between the different HFIO ports, electrical scanning across an angular region can be achieved. The planar antenna elements 480 can be, but are not limited to, patch antennas, microstrip antennas, slot antennas, aperture fed patch antennas, or quasi-yagi antennas.

FIG. 49B illustrates another embodiment of beam sharpening means 301, and one embodiment of an array of planar radiating elements 306. In this arrangement, a plurality of high-frequency input/output (HFIO) signal ports are fed to arrays of planar antenna elements 485 on a high-frequency substrate or printed circuit board 498. One way the HFIO signals can be coupled to the substrate or printed circuit board 498 from the high frequency integrated circuit package is through the EM signal coupling method illustrated in FIGS. 37A-B. The antenna arrays are shown with a fixed number of antenna elements each for illustration purposes only, but can have different numbers of elements than what is illustrated, and each array can have an independent number of elements. As an example, not meant as a limitation, let the series elements in each array be arranged in the elevation axis of the transmit/receive beam and be used to create a narrow, fixed elevation beam width. Let the k antenna arrays, where k is an integer greater than 2, be arranged with spatial separation in the azimuth axis of the transmit/receive beam. By feeding the k arrays simultaneously with HFIO signals, and through control of the amplitude and/or phase of each HFIO signal independently, the transmit/receive azimuth beam-width can be controlled as well as the azimuth beam direction. By electrically controlling the amplitude and phase of each HFIO signal, electrical scanning in azimuth of a narrow transmit/receive beam can be achieved. The planar antenna elements 485 can be, but are not limited to, patch antennas, microstrip antennas, slot antennas, aperture fed patch antennas, or quasi-yagi antennas. Furthermore, the planar antenna elements of each array can be fed the corresponding HFIO signal through series or parallel signal distribution means. The transmission line structure of the feed network to the planar antenna elements in each array can comprise, but is not limited to, microstrip, coplanar waveguide, conductor-backed coplanar waveguide, stripline, waveguide, or any combination of these.

FIGS. 50A-B illustrate a waveguide fed twist-reflector antenna arrangement as one embodiment of transmit/receive beam aperture 412, as one embodiment of transmit/receive reflector antenna 420, as one embodiment of beam sharpening means 301, and as one embodiment of reflector antenna with waveguide feeds 304 according to aspects of the present invention. FIG. 50A illustrates the top view of a twist-reflector antenna with waveguide feeds arrangement. The arrangement consists of an antenna body 470a containing two electrically conductive antenna surfaces 492a, 492b fed by electrically conductive waveguides 425a, 425b that can each be generally straight or shaped to direct or taper the feed radiation for advantage. The waveguide feeds 425a are spatially separated from one another by some distance, which can vary between different waveguide feed pairs. The arrangement of the waveguide feeds 425a is not restricted to one axis and is not restricted to be co-linear, only that spatial separation exists between waveguide openings for the purpose of beam-steering the transmit/receive beam from the antenna arrangement. The basic operation of this twist-reflector antenna arrangement is similar to that illustrated in FIG. 47D, and won't be repeated again. A trans-reflecting cover means is part of this arrangement, but omitted for clarity in FIGS. 50A-B. This arrangement illustrates the use of 7 waveguide feeds 425a into the antenna surface 492a, which can be beam-switched to provide radar scanning and imaging capability. The use of 7 waveguide feeds is for illustration purposes only and is not meant as a limitation. The number of waveguide feeds 425a can be, for example, 14, 15, 16, 31, 32, etc. Also illustrated is the use of a second antenna surface 492b with a smaller aperture in the scanning axis, which is fed by a waveguide feed 425b. In this example, the antenna surface 492a has a larger aperture in the scanning axis, which is clearly illustrated in FIG. 51B, which can achieve a narrower beam width and higher gain than the smaller aperture 492b, and is fed by a number of waveguide feeds, allowing beam-switched long range scanning and imaging capability. One application of this arrangement can be for the larger multi-beam aperture to provide long range scanning or imaging radar, while the smaller aperture can provide short or medium range, wider angle threat radar capability. The use of one waveguide feed 425b for aperture 492b is for illustration purposes only, and is not meant as a limitation. Two waveguide feeds 425b could be used, for example, which could provide target angle calculation capability through amplitude monopulse and/or phase monopulse direction finding techniques, in addition to target range and/or velocity determination. The antenna body 470a with waveguide feeds and antenna surfaces can be manufactured using similar low cost techniques as previously described for antenna body 470. The features shown are for illustration purposes only, and are not meant as a limitation. Variations of the ideas presented can be implemented by one skilled in the art without departing from the spirit of the present invention.

FIGS. 51A-B illustrate a waveguide fed twist-reflector antenna arrangement as another embodiment of transmit/receive beam aperture 412, as another embodiment of transmit/receive reflector antenna 420, as another embodiment of beam sharpening means 301, and as another embodiment of reflector antenna with waveguide feeds 304 according to aspects of the present invention. FIG. 51A illustrates the top view of a twist-reflector antenna with waveguide feeds arrangement. The arrangement consists of an antenna body 470b containing two electrically conductive antenna surfaces 492c, 492d fed by electrically conductive waveguides 425c, 425d that can each be generally straight or shaped to direct or taper the feed radiation for advantage. The waveguide feeds 425c, 425d are spatially separated from one another by some distance, which can vary between different waveguide feed pairs. The arrangement of the waveguide feeds 425c, 425d is not restricted to one axis and is not restricted to be co-linear, only that spatial separation exists between waveguide openings for the purpose of beam-steering the transmit/receive beam from the antenna arrangement, or to provide antenna feed separation for amplitude or phase monopulse operation. The basic operation of this twist-reflector antenna arrangement is similar to that illustrated in FIG. 47D, and won't be repeated again. A trans-reflecting cover means is part of this arrangement, but omitted for clarity in FIGS. 51A-B. This arrangement illustrates the use of 14 waveguide feeds 425c into the antenna surface 492c, which can be beam-switched to provide radar scanning and imaging capability. The use of 14 waveguide feeds is for illustration purposes only and is not meant as a limitation. The number of waveguide feeds 425c can be, for example, 7, 15, 16, 31, 32, etc. Also illustrated is the use of a second antenna surface 492d with a smaller aperture in the scanning axis, which is fed by two waveguide feeds 425d. In this example, the antenna surface 492c has a larger aperture in the scanning axis, which is clearly illustrated in FIG. 51B, which can achieve a narrower beam width and higher gain than the smaller aperture 492d, and is fed by a number of waveguide feeds, allowing beam-switched long range scanning and imaging capability. One application of this arrangement can be for the larger multi-beam aperture to provide long range scanning or imaging radar, while the smaller aperture can provide short or medium range, wider angle threat radar capability. The use of two waveguide feeds 425d for aperture 492d is for illustration purposes only, and is not meant as a limitation. Three or more waveguide feeds 425d could be used, for example, or three or more antenna surfaces, without departing from the spirit of the present invention. The use of two waveguide feeds 425d in antenna aperture 492d can provide wide angle, short to medium range target angle calculation capability through the use of amplitude monopulse and/or phase monopulse direction finding techniques, in addition to target range and/or or velocity determination. The antenna body 470b with waveguide feeds and antenna surfaces can be manufactured using similar low cost techniques as previously described for antenna body 470. The features shown are for illustration purposes only, and are not meant as a limitation. Variations of the ideas presented can be implemented by one skilled in the art without departing from the spirit of the present invention.

FIGS. 52A-C illustrate a waveguide fed twist-reflector antenna arrangement as a further embodiment of transmit/receive beam aperture 412, as a further embodiment of transmit/receive reflector antenna 420, as a further embodiment of beam sharpening means 301, as a further embodiment of reflector antenna with waveguide feeds 304, and as an embodiment of an array of radiating elements with waveguide feeds 305 according to aspects of the present invention. The arrangement and method described is for illustration purposes and is not meant as a restriction. This arrangement is similar to the arrangement shown in FIGS. 50A-B except that a plurality antenna apertures 492e are used, each being fed by a single waveguide feed 425e. The arrangement consists of an antenna body 470c containing a plurality of electrically conductive antenna surfaces 492e fed by electrically conductive waveguides 425e that can each be generally straight or shaped to direct or taper the feed radiation for advantage, and a trans-reflecting cover 472b which serves a similar function to the cover 472 of FIG. 47D. The basic operation of this twist-reflector antenna arrangement is similar to that illustrated in FIG. 47D, and won't be repeated again. This arrangement illustrates the use of 8 antenna apertures 492e with waveguide feeds 425e which can be used as phased-array to provide radar scanning and imaging capability. The use of 8 antenna apertures 492e is for illustration purposes only and is not meant as a limitation. The number of antenna apertures 492e can be, for example, 7, 15, 16, 31, 32, etc. As an example, not meant as a limitation, let the antenna arrangement shown be used for a phased-array application, and let the axis in which the antenna apertures 492e are arrayed be the azimuth axis of the transmit/receive beam, and the axis of the wider dimension of the aperture 492e be the elevation axis of the transmit/receive beam. The apertures 492e are illustrated as having a relatively narrow aperture dimension in the azimuth axis resulting in a relatively wide beam width of each element in the azimuth axis, and a relatively wide aperture dimension in the elevation axis resulting in a relatively narrow elevation beam width. By feeding the waveguide feeds 425e of each antenna element 492e simultaneously with HFIO signals, and through control of the amplitude and/or phase of each HFIO signal independently, the transmit/receive azimuth beam-width can be controlled as well as the azimuth beam direction. By electrically controlling the amplitude and phase of each HFIO signal, electrical scanning in azimuth of a narrow transmit/receive beam can be achieved.

FIGS. 53A-D illustrate a waveguide fed antenna arrangement as another embodiment of transmit/receive beam aperture 412, as another embodiment of beam sharpening means 301, and as another embodiment of an array of radiating elements with waveguide feeds 305 according to aspects of the present invention. FIG. 53A illustrates the top view of a waveguide fed antenna arrangement. The arrangement consists of a waveguide feed and distribution plate 489 containing a plurality of electrically conductive waveguide routing slots 495 and waveguide openings 467 to the backside of plate 489. The waveguide openings 467 on the backside of plate 489 can be coupled to for example, but not limited to, a package substrate. A top cover plate 473 is electrically attached to the top side of plate 489 completing the top side of the waveguides 495, and contains apertures 457 along the wall of waveguides 495. The apertures 457 will radiate signal energy in a direction generally normal to the surface of cover plate 473, creating an antenna array arrangement. The electrical attachment method of the top cover plate 473 may comprise, but is not limited to, metal to metal electrically conductive contact, the use of an electrically conductive adhesive film or epoxy, the use of an electrically conductive gasket, or the use of a brazing process. The location of the apertures 457 can be placed such that the relative phase of the signal radiation from each aperture can be controlled, which can be used for advantage. Also, the dimensions of each aperture 457 can be independently designed which allows the amount of energy radiated by each aperture to be controlled, which can be used for advantage. As an example, not meant as a limitation, let the antenna arrangement shown be used for a phased-array application. Let the axis in which the apertures 457 are arrayed along a single waveguide 495 dimension be the elevation axis of the transmit/receive beam, and let the axis orthogonal to the elevation axis, but still in the plane of the cover 473, be the azimuth axis of the transmit/receive beam. The array of apertures along each waveguide 495 can be used as an array of elements to produce a fixed, relatively narrow elevation beam width of the transmit/receive beam. By feeding the waveguide feed ports 467 simultaneously with HFIO signals, and through control of the amplitude and/or phase of each HFIO signal independently, the transmit/receive azimuth beam-width can be controlled as well as the azimuth beam direction. By electrically controlling the amplitude and phase of each HFIO signal, electrical scanning in azimuth of a narrow transmit/receive beam can be achieved. The waveguide distribution plate 489 and top cover 473 can be manufactured using low cost techniques. One technique, not meant in any way as a limitation, is to use injection molding for fabrication, using, for example, metallized injection molded plastics or injection molded metals or metal compounds.

FIGS. 54A-D illustrate a waveguide fed antenna arrangement as a further embodiment of transmit/receive beam aperture 412, as a further embodiment of beam sharpening means 301, and as a further embodiment of an array of radiating elements with waveguide feeds 305 according to aspects of the present invention. FIG. 54A illustrates the top view of a waveguide fed antenna arrangement. The arrangement consists of a waveguide feed and distribution plate 489a containing a plurality of electrically conductive waveguide routing slots 495a and waveguide openings 467a to the backside of plate 489a. The waveguide openings 467a on the backside of plate 489a can be coupled to for example, but not limited to, a package substrate. A top cover plate 473a is electrically attached to the top side of plate 489a completing the top side of the waveguides 495a, and contains apertures 457a along the wall of waveguides 495a. The waveguides 495a contain waveguide power splitting structures which feed the apertures 457a. The apertures 457a will radiate signal energy in a direction generally normal to the surface of cover plate 473a, creating an antenna array arrangement. The electrical attachment method of the top cover plate 473a may comprise, but is not limited to, metal to metal electrically conductive contact, the use of an electrically conductive adhesive film or epoxy, the use of an electrically conductive gasket, or the use of a brazing process. The location of the apertures 457a can be placed such that the signal radiation relative phase from each aperture can be controlled, which can be used for advantage. Also, the dimensions of each aperture 457a can be independently designed which allows the amount of energy radiated by each aperture to be controlled, which can be used for advantage. As an example, not meant as a limitation, let the antenna arrangement shown be used for a phased-array application. Let the axis in which the apertures 457a are arrayed along a single waveguide 495a dimension be the elevation axis of the transmit / receive beam, and let the axis orthogonal to the elevation axis, but still in the plane of the cover 473a, be the azimuth axis of the transmit/receive beam. The array of apertures along each waveguide 495a can be used as an array of elements to produce a fixed, relatively narrow elevation beam width of the transmit/receive beam. By feeding the waveguide feed ports 467a simultaneously with HFIO signals, and through control of the amplitude and/or phase of each HFIO signal independently, the transmit/receive azimuth beam-width can be controlled as well as the azimuth beam direction. By electrically controlling the amplitude and phase of each HFIO signal, electrical scanning in azimuth of a narrow transmit/receive beam can be achieved. The waveguide distribution plate 489a and top cover 473a can be manufactured using low cost techniques. One technique, not meant in any way as a limitation, is to use injection molding for fabrication, using, for example, metallized injection molded plastics or injection molded metals or metal compounds.

FIGS. 55A-B illustrate one embodiment of an integrated circuit packaging means, external circuit board means, high-frequency signal coupling means, feed network means, and transmit/receive antenna means according to aspects of the present invention. The arrangement and method described are for illustration purposes and are not meant as a restriction. In this arrangement, an integrated circuit package containing one or a plurality of die 524, a cover 597, and waveguide signal coupling ports 595 is mounted to a waveguide feed distribution network 479a using, for example, metal clip attachment means 569, or any other suitable mechanical attachment method. An electrically conductive interface material 593 is applied between the bottom side of substrate 516 and the waveguide feed distribution network 479a, for the purpose of aiding with the coupling of signals. The interface material 593 can be eliminated if good electrical contact can be ensured between the substrate 516 and waveguide feed network 479a. The external circuit board 580 is mechanically attached to the waveguide feed network 479a using screws 512 and washers, or any other suitable mechanical attachment method. Metal wires or leads 591 connect metal pads on substrate 516 to metal pads on external circuit board 580 and can be attached using, for example, solder. The shape of the wires or leads will relieve stress related to the difference in coefficient of thermal expansion (CTE) between the package and circuit board, leading to high reliability. Although metal wires or leads 591 are shown, other external substrate interconnect means may be utilized instead or in combination, such as, but not limited to, flex circuits, ribbon cables, flex circuits with integrated connectors, or pin arrays. The external circuit board 580 can accommodate other components used in the radar sensor such as, but not limited to, an analog to digital converter means 583 and a digital signal processor means 564. The analog to digital converter means 583 and digital signal processor means 564 may be separate components as illustrated, or may be part of an integrated component. The transmit/receive signals from the waveguide feed distribution network 479a are coupled to the waveguide feeds 425, 427 in the transmit/receive antenna 470 using either an electrically conductive interface material or through good electrical contact. Although only 3 waveguide feeds are shown in this example, the techniques described here can apply to a radar arrangement using more beams such as 8 beams, 16 beams, 32 beams, etc., enabling substantial radar imaging capability in a low cost arrangement. Also, although only one reflector antenna aperture is shown in this example, the techniques described here can apply to a radar apparatus using an antenna arrangement containing a plurality of antenna apertures, such as illustrated in FIGS. 51A-B, 52A-C. Furthermore, the antenna arrangements shown in FIGS. 53A-D, 54A-D can be utilized in this arrangement by replacing the waveguide feed distribution network 479a, transmit/receive antenna 470, and cover 472. The features shown are for illustration purposes only, and are not meant as a limitation. Variations of the ideas presented can be implemented by one skilled in the art without departing from the spirit of the present invention.

FIGS. 56A-B illustrate another embodiment of an integrated circuit packaging means, external circuit board means, high-frequency signal coupling means, feed network means, and transmit/receive antenna means according to aspects of the present invention. The arrangement and method described are for illustration purposes and are not meant as a restriction. This arrangement is similar to the arrangement shown in FIGS. 55A-B except that a plurality of integrated circuit die 524a-c are flip-chip attached to the same side of the package substrate 516 as the EM signal coupling ports 595a, and that a package cover means 597a is contacted by a thermal interface material 486 to facilitate heat extraction from the package to a waveguide feed network distribution plate 479b. The same components are denoted by the same reference numerals, and will not be explained again. In this arrangement, the heat generated from the integrated circuit die 524a-c is conducted to a thermally and electrically conductive cover 597a through an epoxy attachment material. A thermal interface material 486 is used to conduct the heat from the cover 597a to a thermally and electrically conductive waveguide feed network distribution plate 479b. The waveguide feed network plate contains signal waveguides 421a which are used to couple to high frequency signal EM coupling ports 595a on the package substrate 516. In this configuration, the waveguide feed network distribution plate 479b can be utilized as a heat-sink for the IC package as well as a high-frequency signal coupling and distribution means. Although only 3 waveguide feeds are shown in this example, the techniques described here can apply to a radar arrangement using more beams such as 8 beams, 16 beams, 32 beams, etc., enabling substantial radar imaging capability in a low cost arrangement. Also, although only one reflector antenna aperture is shown in this example, the techniques described here can apply to a radar apparatus using an antenna arrangement containing a plurality of antenna apertures, such as illustrated in FIGS. 51A-B, 52A-C. Furthermore, the antenna arrangements shown in FIGS. 53A-D, 54A-D can be utilized in this arrangement by replacing the waveguide feed distribution network 479b, transmit/receive antenna 470, and cover 472. The features shown are for illustration purposes only, and are not meant as a limitation. Variations of the ideas presented can be implemented by one skilled in the art without departing from the spirit of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A packaging apparatus for integrated circuits comprising:
a dielectric substrate comprising a single or plurality of dielectric layers;
a single or plurality of electrically conductive layers deposed on one or more surfaces of said single or plurality of dielectric layers;
a single or plurality of integrated circuits attached to a surface of said dielectric substrate;
a single or plurality of electromagnetic signal radiating ports on a surface of said dielectric substrate; and
a single or plurality of stress-relieved external interconnect means.

2. The apparatus of claim 1, wherein said single or plurality of integrated circuits is attached to the same side of said dielectric substrate as said electromagnetic signal radiating ports.

3. The apparatus of claim 1, wherein said single or plurality of integrated circuits is attached to the opposite side of said dielectric substrate as said electromagnetic signal radiating ports.

4. The apparatus of claim 1, wherein said electromagnetic signal radiating ports are comprised of electromagnetic signal coupling ports to external waveguide structures.

5. The apparatus of claim 4, wherein said electromagnetic signal coupling ports contain a microstrip patch radiating structure.

6. The apparatus of claim 4, wherein said external waveguide structures are metallic rectangular waveguide structures.

7. The apparatus of claim 1, wherein said electromagnetic signal radiating ports are comprised of antenna structures.

8. The apparatus of claim 7, wherein said antenna structures are comprised of microstrip patch radiating structures.

9. The apparatus of claim 1, additionally comprising one or a plurality of electrically conductive covers surrounding said single or plurality of integrated circuits attached to a surface of said dielectric substrate.

10. The apparatus of claim 9, wherein said electrically conductive covers are additionally thermally conductive.

11. The apparatus of claim 10, wherein said covers are bonded to the surface of an integrated circuit.

12. The apparatus of claim 1, additionally comprising one or a plurality of brazed or soldered pins on a surface of said substrate.

13. The apparatus of claim 1, additionally comprising one or a plurality of brazed or soldered leads on a surface of said substrate.

14. The apparatus of claim 1, additionally comprising one or a plurality of wire-bondable pads on a surface of said substrate.

15. The apparatus of claim 1, additionally comprising one or a plurality of solderable pads on a surface of said substrate.

16. The apparatus of claim 1, wherein one or more of said dielectric layers are comprised of alumina.

17. The apparatus of claim 1, wherein one or more of said dielectric layers are comprised of LTCC.

18. The apparatus of claim 1, wherein one or more of said dielectric layers are comprised of HTCC.

19. The apparatus of claim 1, wherein said single or plurality of integrated circuits are attached to the substrate utilizing flip-chip attachment.

20. The apparatus of claim 19, wherein said flip-chip attachment utilizes gold thermo-compression bump bonding.

21. The apparatus of claim 1, wherein said single or plurality of integrated circuits are attached to the substrate utilizing wire-bonding attachment.

22. The apparatus of claim 1, additionally comprising one or a plurality of vias for the connection of signals through one or a plurality if said dielectric layers.

23. The apparatus of claim 19, wherein one or more signals from said single or plurality of integrated circuits are connected directly to a controlled impedance inner layer structure with ground shielding metallization deposed on the same surface of the substrate as said single or plurality of integrated circuits are attached.

24. A method for the packaging of integrated circuits, comprising:
attaching one or a plurality of integrated circuits to a substrate;
electromagnetically radiating one or a plurality of signals from said substrate in a direction normal to a surface of said substrate; and
connecting one or a plurality of signals from said substrate to an external circuit using a stress-relieved external interconnect means.

25. The method of claim 24, additionally comprising attaching of one or a plurality of electrically conducting covers surrounding one or a plurality of said integrated circuits.

26. A packaging apparatus for integrated circuits comprising:
a high-frequency die to substrate interconnect means;
a high-frequency package substrate means;
a mechanically stress-relieved package substrate external interconnect means; and
an integrated signal radiating means.

27. The apparatus of claim 26, additionally comprising a package cover means.

28. The apparatus of claim 26, wherein said integrated signal radiating means is comprised of one or a plurality of planar antennas.

29. A packaging apparatus for integrated circuits comprising:
a high-frequency die to substrate interconnect means;
a high-frequency package substrate means;
a mechanically stress-relieved package substrate external interconnect means; and
an integrated electro-magnetic signal coupling means.

30. The apparatus of claim 29, additionally comprising a package cover means.
